(19) United States
(12) Patent Application Publication
(10) Pub. No.: US 2022/0015384 A1
(43) Pub. Date: Jan. 20, 2022

(54) TEA BEVERAGE IN WHICH QUALITY OF TASTE RESULTING FROM SUGARS AND SWEETENERS IS IMPROVED

(71) Applicant: SUNTORY HOLDINGS LIMITED, Osaka (JP)

(72) Inventors: Yoji ASAMI, Kanagawa (JP); Tadahiro OHKURI, Kanagawa (JP); Akiko FUJIE, Kanagawa (JP); Koji NAGAO, Kanagawa (JP); Yoshiaki YOKOO, Kanagawa (JP)

(73) Assignee: SUNTORY HOLDINGS LIMITED, Osaka (JP)

(21) Appl. No.: 17/299,965

(22) PCT Filed: Dec. 6, 2019
(86) PCT No.: PCT/JP2019/047868

§ 371 Date: Jun. 4, 2021

(30) Foreign Application Priority Data
Dec. 7, 2018 (JP) 2018-230340

(51) Int. Cl. A23F 3/16; A23F 3/40; A23L 2/60; A23L 2/56; A23L 27/30; A23L 27/20; A23L 27/40

(52) U.S. Cl. CPC A23F 3/163; A23F 3/405; A23L 2/60; A23V 2002/00; A23L 27/36; A23L 27/2028; A23L 27/45; A23L 2/56

(57) ABSTRACT

The present invention relates to a tea beverage that contains (a) an amount of a natural sugar corresponding to a sweetness intensity X1, (b) an amount of a high-sweetness sweetener corresponding to a sweetness intensity X2, (c) less than 50 mg of sodium per 100 ml of said tea beverage, and (d) 0.1-32 mg of potassium per 100 ml and/or 0.1-32 mg of calcium per 100 ml of said tea beverage. The high-sweetness sweetener includes at least one high-sweetness sweetener b1 selected from the group consisting of rebaudioside M, rebaudioside D, rebaudioside N, rebaudioside O, rebaudioside E, a Siraitia grosvenorii extract, mogroside V, and thaumatin. The tea beverage satisfies 0.1<(X1+X2)≤20.

### TECHNICAL FIELD

The present invention relates to a tea beverage having improved quality of taste exhibited by a sugar and a sweetener and a method for producing the tea beverage.

### BACKGROUND ART

Humans have five sensory systems, and the sense of taste is one of the sensory systems of humans. The taste receptor organ to receive tastes is called taste buds, which exist on the fungiform papillae existing over a wide area, mainly on the tip of the tongue, on the vallate papillae existing on a limited area of the back of the tongue, and on the foliate papillae. The taste buds are a cell assembly composed of elongate cells, called taste cells, and basal cells. The taste cells protrude microvilli toward the tongue surface, and form synapses at bottom of the cells with taste nerve fibers entering the taste buds. Tastes we usually sense are transmitted as taste information via the taste nerves to the brain, where the tastes are perceived. Known taste receptors of sweetness include T1R2 and T1R3. T1R2 and T1R3 are reported to form hetero-dimers (Non-patent Literatures 1 to 3).

Although various studies have been made on the sense of taste, little has been revealed yet in this field. We usually experience various tastes of foods. Foods that seem to be tasty have appropriately mixed and well-harmonized tastes. The taste of foods may be tasted as a single taste in some cases, but is often tasted as a mixed taste of various tastes, which are associated with one another.

Meanwhile, foods have been required to have lower calories in addition to a good taste in recent years. This relates to a fact that lifestyle-related diseases such as obesity and diabetes are regarded as a problem.

However, to produce lower-calorie foods, their natural sugar concentration has to be maintained low. This is an obstruction in the case of providing foods that exhibit low calories and a good taste.

As an example of a contrast effect, which is an interaction of tastes, there has been long known a phenomenon in which addition of salt to sweet red-bean soup enhances sweetness. There is an example that reports the interaction between saltiness and sweetness by focusing on this phenomenon, and it is concluded that the interaction between sweetness and saltiness requires sweetness that is strong to a certain degree (a 15% solution) and a salt concentration that is high to a certain degree (0.1 to 0.2%) (Non Patent Literature 4).

In addition, foods and drinks that exhibit sweetness by using a high-intensity sweetener of low calorie, such as Rebaudioside A, as a substitute for a natural sugar have also been developed, but the sweetness exhibited by a high-intensity sweetener has distinctive aftertaste, which hinders the provision of good taste.

### CITATION LIST

### Non Patent Literature

[Non Patent Literature 1] Zhao G. Q., Zhang Y., Hoon M. A., Chandrashekar J., Erlenbach I., Ryba N. J. P., and Zukerl C. S., Cell, 2003, Vol. 115, 255-266
[Non Patent Literature 2] Li X, Staszewski L, Xu H, Durick K, Zoller M, Adler E., Proc Natl Acad Sci USA. 2002, 99(7), 4692-4696.
[Non Patent Literature 3] Fernstrom J. D., Munger S. D., Sclafani A., de Araujo I. E., Roberts A., and Molinary S., J. Nutr. 2012. Vol. 142: 1134S-1141S
[Non Patent Literature 4] Ayumi Uchida, Nao Takagi, Rieko Horikiri, Miho Matsue, Yumiko Uchiyama and Masashi Omori, Research Bulletin of Otsuma Women's University for Home Economics-No. 49 (2013. 3)

### SUMMARY OF INVENTION

### Problem to be Solved by the Invention

The development of a method for well improving the taste quality exhibited by a sugar and a sweetener while having an adequate sweetness intensity and maintaining the amount of the natural sugar used in a tea beverage low has been much awaited.

### Means for Solving the Problems

The present inventors succeeded for the first time in increasing the sweetness based on the use of a natural sugar and a specific high-intensity sweetener in combination and improving the taste quality by containing not only a natural sugar but also a specific high-intensity sweetener and adding sodium in a low concentration and potassium and/or calcium in a low concentration. It was unexpected that the effect of improving taste quality would be synergistically raised by adding a specific amount of potassium and/or calcium in addition to a specific amount of sodium.

That is, the present invention is as follows.

[1] A tea beverage comprising:
(a) a natural sugar in an amount corresponding to a sweetness intensity X1;
(b) a high-intensity sweetener in an amount corresponding to a sweetness intensity X2;
(c) less than 50 mg/100 ml of sodium; and
(d) 0.1 to 52 mg/100 ml of potassium and/or 0.1 to 52 mg/100 ml of calcium,

wherein the high-intensity sweetener comprises at least one high-intensity sweetener b1 selected from the group consisting of rebaudioside M, rebaudioside D, rebaudioside N, rebaudioside O, rebaudioside E, a Luo han guo extract, mogroside V, and thaumatin; and

0.1<(X1+X2)≤20 is satisfied.

[2] The tea beverage according to [1], wherein a sodium content is 7 mg/100 ml or more and less than 40 mg/100 ml.
[3] The tea beverage according to [1] or [2], comprising 0.1 to 32 mg/100 ml of potassium and/or 0.1 to 32 mg/100 ml of calcium.
[4] The tea beverage according to any one of [1] to [3], wherein energy is 50 Kcal/100 ml or less.
[5] The tea beverage according to any one of [1] to [4], wherein X1 is 0.1 to 5.9.
[6] The tea beverage according to any one of [1] to [5], comprising 200 to 600 ppm of polyphenol.
[7] The tea beverage according to [6], comprising 200 to 600 ppm of catechin.
[8] The tea beverage according to any one of [1] to [7], wherein the natural sugar is at least one selected from the group consisting of glucose, sucrose, fructose, maltose, oligosaccharide, high-fructose corn syrup, lactose, psicose, allose, tagatose, and a combination thereof.
[9] The tea beverage according to any one of [1] to [8], wherein the high-intensity sweetener b1 is at least one selected from the group consisting of rebaudioside M, rebaudioside D, a Luo han guo extract, mogroside V, and a combination thereof.
[10] The tea beverage according to any one of [1] to [9], wherein the sodium is at least one selected from the group consisting of sodium chloride, sodium hydroxide, sodium malate, sodium sulfate, sodium citrate, sodium phosphate, sodium carbonate, sodium disulfide, sodium bicarbonate, sodium alginate, sodium argininate, sodium glucoheptanoate, sodium gluconate, sodium glutamate, sodium tartrate, sodium aspartate, sodium lactate, sodium caseinate, sodium ascorbate, and a mixture thereof.
[11] The tea beverage according to any one of [1] to [10], wherein the potassium is at least one selected from the group consisting of potassium alginate, potassium chloride, potassium citrate, potassium gluconate, potassium L-glutamate, potassium bromate, potassium hydrogen DL-tartrate, potassium hydrogen L-tartrate, potassium nitrate, potassium hydroxide, potassium sorbate, potassium carbonate, potassium lactate, potassium norbixin, potassium pyrosulfite, tetrapotassium pyrophosphate, potassium ferrocyanide, potassium polyphosphate, potassium metaphosphate, potassium aluminum sulfate, potassium sulfate, tripotassium phosphate, dipotassium hydrogen phosphate, potassium dihydrogen phosphate, and a mixture thereof.
[12] The tea beverage according to any one of [1] to [11], wherein the calcium is at least one selected from the group consisting of calcium L-ascorbate, calcium alginate, calcium disodium ethylenediaminetetraacetate, calcium chloride, carboxymethylcellulose calcium, calcium citrate, calcium glycerophosphate, calcium gluconate, calcium Di-L-glutamate, calcium silicate, calcium acetate, calcium oxide, calcium hydroxide, calcium stearate, calcium stearoyl lactate, calcium sorbate, calcium carbonate, calcium lactate, calcium pantothenate, calcium dihydrogen pyrophosphate, calcium ferrocyanide, calcium propionate, calcium 5′-ribonucleotide, calcium sulfate, tricalcium phosphate, calcium monohydrogen phosphate, calcium dihydrogen phosphate, and mixtures thereof.
[13] The tea beverage according to any one of [1] to [12], wherein the tea beverage comprises 17 mg/100 ml or more and less than 40 mg/100 ml of sodium, comprises 10 to 21 mg/100 ml of potassium and/or 10 to 22 mg/100 ml of calcium, and energy is 50 Kcal/100 ml or less, and X1+X2 is 6 or more.
[14] The tea beverage according to any one of [1] to [13], which is packed in a container.
[15] A method for producing a tea beverage, comprising to a raw material:

(i) adding (a) a natural sugar in an amount of a sweetness intensity X1 and (b) a high-intensity sweetener in an amount of a sweetness intensity X2;

(ii) adding (c) sodium such that a sodium content in the tea beverage is less than 50 mg/100 ml; and

(iii) adding (d) potassium such that a potassium content in the beverage is 0.1 to 52 mg/100 ml and/or calcium such that a calcium content in the beverage is 0.1 to 52 mg/100 ml,

wherein the high-intensity sweetener comprises at least one high-intensity sweetener b1 selected from the group consisting of rebaudioside M, rebaudioside D, rebaudioside N, rebaudioside O, rebaudioside E, a Luo han guo extract, mogroside V, and thaumatin; and

0.1<(X1+X2)≤20 is satisfied.

[16] The method according to [15], wherein in the tea beverage, the sodium content is 7 mg/100 ml or more and less than 40 mg/100 ml.
[17] The method according to [15] or [16], wherein the tea beverage comprises 0.1 to 32 mg/100 ml of potassium and/or 0.1 to 32 mg/100 ml of calcium.
[18]. The method according to any one of [15] to [17], wherein energy of the tea beverage is 50 Kcal/100 ml or less.
[19] The method according to any one of [15] to [18], wherein X1 is 0.1 to 5.9.
[20] The method according to any one of [15] to [19], wherein the tea beverage comprises 200 to 600 ppm of polyphenol.
[21] The method according to [20], wherein the tea beverage comprises 200 to 600 ppm of catechin.
[22] The method according to any one of [15] to [21], wherein the natural sugar is at least one selected from the group consisting of glucose, sucrose, fructose, maltose, oligosaccharide, high-fructose corn syrup, lactose, psicose, allose, tagatose, and a combination thereof.
[23] The method according to any one of [15] to [22], wherein the high-intensity sweetener b1 is at least one selected from the group consisting of rebaudioside M, rebaudioside D, a Luo han guo extract, mogroside V, and a combination thereof.
[24] The method according to any one of [15] to [23], wherein the sodium is at least one selected from the group consisting of sodium chloride, sodium hydroxide, sodium malate, sodium sulfate, sodium citrate, sodium phosphate, sodium carbonate, sodium disulfide, sodium bicarbonate, sodium alginate, sodium argininate, sodium glucoheptanoate, sodium gluconate, sodium glutamate, sodium tartrate, sodium aspartate, sodium lactate, sodium caseinate, sodium ascorbate, and a mixture thereof.
[25] The method according to any one of [15] to [24], wherein the potassium is at least one selected from the group consisting of potassium alginate, potassium chloride, potassium citrate, potassium gluconate, potassium L-glutamate, potassium bromate, potassium hydrogen DL-tartrate, potassium hydrogen L-tartrate, potassium nitrate, potassium hydroxide, potassium sorbate, potassium carbonate, potassium lactate, potassium norbixin, potassium pyrosulfite, tetrapotassium pyrophosphate, potassium ferrocyanide, potassium polyphosphate, potassium metaphosphate, potassium aluminum sulfate, potassium sulfate, tripotassium phosphate, dipotassium hydrogen phosphate, potassium dihydrogen phosphate, and a mixture thereof.
[26] The method according to any one of [15] to [25], wherein the calcium is at least one selected from the group consisting of calcium L-ascorbate, calcium alginate, calcium disodium ethylenediaminetetraacetate, calcium chloride, carboxymethylcellulose calcium, calcium citrate, calcium glycerophosphate, calcium gluconate, calcium Di-L-glutamate, calcium silicate, calcium acetate, calcium oxide, calcium hydroxide, calcium stearate, calcium stearoyl lactate, calcium sorbate, calcium carbonate, calcium lactate, calcium pantothenate, calcium dihydrogen pyrophosphate, calcium ferrocyanide, calcium propionate, calcium 5′-ribonucleotide, calcium sulfate, tricalcium phosphate, calcium monohydrogen phosphate, calcium dihydrogen phosphate, and a mixture thereof.
[27] The method according to any one of [15] to [26], wherein the tea beverage comprises 17 mg/100 ml or more and less than 40 mg/100 ml of sodium, comprises 10 to 21 mg/100 ml of potassium and/or 10 to 22 mg/100 ml of calcium, energy is 50 Kcal/100 ml or less, and X1+X2 is 6 or more.
[28] The method according to any one of [15] to [27], which uses a tea leaf of Camellia sinensis.
[29] A concentrate for providing the tea beverage according to [1], comprising:

(a) a natural sugar in an amount corresponding to a sweetness intensity X4;

(b) a high-intensity sweetener in an amount corresponding to a sweetness intensity X5;

(c) less than 500 mg/100 ml of sodium; and

(d) 1 to 520 mg/100 ml of potassium and/or 1 to 520 mg/100 ml of calcium,

wherein (X4+X5)≤200 is satisfied.

[30] A method for enhancing a sweetness of a tea beverage, comprising: containing

(a) a natural sugar in an amount corresponding to a sweetness intensity X1;

(b) a high-intensity sweetener in an amount corresponding to a sweetness intensity X2;

(c) less than 50 mg/100 ml of sodium; and

(d) 0.1 to 52 mg/100 ml of potassium and/or 0.1 to 52 mg/100 ml of calcium

in the tea beverage.

### Advantageous Effects of Invention

The present invention provides a method for increasing the sweetness of a tea beverage, which is not a simple sweetness that is obtained by increasing the amounts of a natural sugar and a high-intensity sweetener used, and providing good taste quality. In addition, the method of the present invention provides a tea beverage having good taste quality with increased sweetness by a means other than control of the used amounts of sugar and sweetener.

### DESCRIPTION OF EMBODIMENTS

Hereinafter, the present invention will be described in detail. The following embodiments are examples to describe the present invention and do not intend to limit the present invention only to these embodiments. The present invention can be carried out in various embodiments without departing from the spirit of the present invention.

Note that all of the literatures, laid-open publications, patent publications, and other patent literatures cited herein are deemed to be incorporated by reference into the present specification.

In the present specification, for example, the phrase “the content of the A component is X mg/100 ml” means that “X mg of the A component is contained in 100 ml of the beverage”. In addition, for example, the phrase “the content of the B component is Y ppm” means that “the B component is contained in Y ppm with respect to the total amount (100 mass %) of the beverage”.

1. Tea Beverage Having Improved Taste Quality Exhibited by Natural Sugar and High-Intensity Sweetener

The present invention provides, as a first aspect, the following tea beverage (hereinafter, referred to as “the tea beverage of the present invention”).

A tea beverage comprising:
(a) a natural sugar in an amount corresponding to a sweetness intensity X1;
(b) a high-intensity sweetener in an amount corresponding to a sweetness intensity X2; and
(c) less than 50 mg/100 ml of sodium,
(d) 0.1 to 52 mg/100 ml of potassium and/or 0.1 to 52 mg/100 ml of calcium,

wherein the high-intensity sweetener comprises at least one high-intensity sweetener b1 selected from the group consisting of rebaudioside M, rebaudioside D, rebaudioside N, rebaudioside O, rebaudioside E, a Luo han guo extract, mogroside V, and thaumatin; and

0.1<(X1+X2)≤20 is satisfied.

In the tea beverage of the present invention, sweetness of a sweetness intensity X3 is exhibited by the above-mentioned components (a) to (d).

That is, in the tea beverage of the present invention, the components having sweetness are (a) a natural sugar in a specific amount and (b) a specific high-intensity sweetener in a specific amount. The calculated sweetness of the tea beverage of the present invention is supposed to be the total value of the sweetness intensity when the component (a) is added to the tea beverage and the sweetness intensity when the component (b) is added to the tea beverage. However, although the concentrations are low, (c) sodium and (d) potassium and/or calcium are present in the tea beverage. Consequently, the sweetness exhibited by (a) a natural sugar and (b) a high-intensity sweetener is enhanced, and the tea beverage of the present invention achieves sweetness exceeding the mere sum of the individual sweetness intensities. The present invention means to possibly include additional components such as milk component, an acidulant, a flavoring agent, and an extract, in addition to these components (a) to (d). However, the tea beverage of the present invention does not contain a sweet component other than the components (a) and (b) as a sweetener.

Further, the tea beverage according to a preferable aspect of the present invention achieves an effect of improving the taste quality, in addition to an increase in sweetness. For example, in a tea beverage according to an aspect of the present invention, it is preferable to improve at least one of the intensity of flavor and suppression of odd taste (such as bitter taste and astringent taste). Incidentally, the effect of extracting flavor can be confirmed by not only sensory evaluation but also analysis of the amount of volatilized aroma components by gas chromatography. In addition, in an aspect of the present invention, the flavor of a tea beverage can be improved while suppressing an increase in saltiness by increasing the addition amount of K and/or Ca instead of Na.

### (Tea Beverage)

In the present description, examples of the tea beverage include a processed product produced using a fresh leaf plucked from a tea plant (scientific name: Camellia sinensis) as a raw material. Alternatively, examples of the tea beverage also include a processed product produced using a raw material collected from a plant other than a tea plant, called chagaicha such as barley tea, hydrangea tea, bitter gourd tea, coca tea, rooibos tea, silvervine tea, vine tea, pearl barley tea, yuzu tea, honeybush tea, chimpi tea, dokudami tea, kumazasa tea, bamboo tea, herb tea, kombu tea, ume-kombu tea, mate tea, buckwheat tea, habu tea, sweet tea, shiso tea, luo han tea, or shiitake tea.

Preferably, the tea beverage is a processed product produced using a fresh leaf plucked from a tea plant (scientific name: Camellia sinensis) as a raw material. The variety, production area, cultivation method, tea season, and the like of a fresh leaf that can be used in the present invention are not limited as long as the fresh leaf is a leaf of a tea plant.

Examples of the tea plant variety include Yabukita, Yutaka Midori, Okumidori, Sayamakaori, Kanayamidori, Saemidori, and Asatsuyu. Examples of the production area include Shizuoka, Kagoshima, Mie, Kumamoto, Fukuoka, Kyoto, Miyazaki, and Saitama. Examples of the cultivation method include roji, kabuse, and gyokuro. Examples of the tea season include ichibancha, nibancha, sanbancha, yonbancha, toshunshubancha, and kariban.

A tea beverage produced using a leaf of a tea plant generally includes a step of heating a freshly picked fresh leaf with steam and drying the same to obtain aracha, a step of subjecting the aracha to operations such as hiire and sorting to obtain shiagecha, an extraction step of extracting the shiagecha with warm water or the like, a rough filtration step of removing the extraction residue from the extract, a cooling step of cooling the extract, a filtration step of removing a fine solid from the extract, a formulation step of adding water, green tea extract, an antioxidant, a pH adjuster, and the like to the extract to obtain a formulation, and a sterilization step of sterilizing the formulation. However, the steps described above are merely examples, and the present invention is not limited to these, and for example, the order of the steps can be changed, another step can be added, or some steps can be omitted. Examples of the step that can be added include, when the tea beverage is a matcha beverage, a step of milling the shiagecha with a mortar or the like.

In addition, an oolong tea beverage can be produced by using a semi-fermented tea leaf obtained by semi-fermenting a fresh leaf, a black tea beverage can be produced by using a fermented tea leaf, and a dark tea beverage such as Pu-erh tea can be produced by using a tea leaf obtained by fermenting green tea, which is an unfermented tea, with microorganism such as mold. As the varieties used for these productions, general varieties can be used.

A tea leaf derived from a leaf of a tea plant and a tea leaf for chagaicha can be mixed and used.

The produced green tea, oolong tea, black tea, and dark tea can be used alone as a tea beverage, but these can also be used as a mixed tea beverage by appropriately mixing these at a preferable ratio. Further, an extract of a grain, a herb, or the like can also be added to a tea beverage produced by the above tea leaf extracts to make a tea beverage.

The tea beverage of the present invention preferably contains a polyphenol.

The polyphenol includes a polyphenol derived from a raw material such as a tea leaf, a leaf of chagaicha, a grain, or a herb, or a polyphenol added as a food additive as needed. Examples thereof include anthocyanin, resveratrol, isoflavone, lignan, hesperidin, curcumin, catechin, tannin, proanthocyanin, rutin, chlorogenic acid, ellagic acid, coumarin, and procyanidin.

The content of a polyphenol is preferably 200 to 600 ppm and particularly preferably 300 to 500 ppm based on the total amount (100% by mass) of the tea beverage. The polyphenol content can be measured by any of the commonly known methods.

The content of catechin of polyphenols is preferably 200 to 600 ppm and particularly preferably 300 to 500 ppm based on the total amount (100% by mass) of the tea beverage.

### (Natural Sugar)

In the present invention, a “natural sugar”, which is represented by the general formula of Cₘ(H₂O)ₙ, wherein m and n independently represent a natural number, contains a D-form carbohydrate, digestible by humans. Examples of the D-form carbohydrate include glucose, sucrose, fructose, maltose, oligosaccharides (for example, fructooligosaccharide, maltooligosaccharide, isomaltooligosaccharide, and galactooligosaccharide), high-fructose corn syrup (isomerized sugars), lactose, psicose, allose, tagatose, and combinations thereof.

Examples of the combination of glucose, sucrose, fructose, maltose, oligosaccharides, high-fructose corn syrup, and lactose include the following. Specifically, the combination includes sucrose and high-fructose corn syrup, sucrose and glucose, sucrose and fructose, sucrose and maltose, sucrose and an oligosaccharide, sucrose and lactose, high-fructose corn syrup and an oligosaccharide, sucrose and psicose; sucrose, high-fructose corn syrup, and glucose; sucrose, high-fructose corn syrup, and fructose; sucrose, high-fructose corn syrup, and maltose; sucrose, high-fructose corn syrup, and an oligosaccharide; sucrose, high-fructose corn syrup, glucose, and an oligosaccharide; sucrose, glucose, fructose, and an oligosaccharides; and glucose, sucrose, fructose, maltose, an oligosaccharide, high-fructose corn syrup, lactose, and tagatose. In addition, milk component-derived sugars are also included in natural sugar.

Since a natural sugar has high energy, the energy (calorie) of the tea beverage can be greatly reduced by decreasing the content of the natural sugar. The present invention keeps the concentration of the natural sugar low to decrease the energy (i.e., low calorie), but strong sweetness is felt when ingested by a combination of a natural sugar, a high-intensity sweetener, sodium and potassium and/or calcium. Accordingly, the amount of the natural sugar of a sweetness intensity X1 is preferably an amount of providing an energy of 50 Kcal/100 ml or less. The energy of the tea beverage of the present invention may be 0 to 50 Kcal/100 ml, 0 to 45 Kcal/100 ml, 0 to 40 Kcal/100 ml, 0 to 35 Kcal/100 ml, 0 to 30 Kcal/100 ml, 0 to 25 Kcal/100 ml, 0 to 22 Kcal/100 ml, 0 to 20 Kcal/100 ml, 0 to 15 Kcal/100 ml, 0 to 10 Kcal/100 ml, 0 to 5 Kcal/100 ml, 5 to 50 Kcal/100 ml, 5 to 45 Kcal/100 ml, 5 to 40 Kcal/100 ml, 5 to 35 Kcal/100 ml, 5 to 30 Kcal/100 ml, 5 to 25 Kcal/100 ml, 5 to 20 Kcal/100 ml, 5 to 15 Kcal/100 ml, 5 to 10 Kcal/100 ml, 10 to 50 Kcal/100 ml, 10 to 45 Kcal/100 ml, 10 to 40 Kcal/100 ml, 10 to 35 Kcal/100 ml, 10 to 30 Kcal/100 ml, 10 to 25 Kcal/100 ml, 10 to 20 Kcal/100 ml, 10 to 15 Kcal/100 ml, 15 to 50 Kcal/100 ml, 15 to 45 Kcal/100 ml, 15 to 40 Kcal/100 ml, 15 to 35 Kcal/100 ml, 15 to 30 Kcal/100 ml, 15 to 25 Kcal/100 ml, 15 to 20 Kcal/100 ml, 20 to 50 Kcal/100 ml, 20 to 45 Kcal/100 ml, 20 to 40 Kcal/100 ml, 20 to 35 Kcal/100 ml, 20 to 30 Kcal/100 ml, 20 to 25 Kcal/100 ml, 25 to 50 Kcal/100 ml, 25 to 45 Kcal/100 ml, 25 to 40 Kcal/100 ml, 25 to 35 Kcal/100 ml, or 25 to 30 Kcal/100 ml, depending on embodiments. The energy of the tea beverage of the present invention may also be 0 to 32 Kcal/100 ml, 0 to 24 Kcal/100 ml, 0 to 8 Kcal/100 ml, 0 to 4 Kcal/100 ml, 4 to 32 Kcal/100 ml, 4 to 24 Kcal/100 ml, 4 to 8 Kcal/100 ml, 8 to 32 Kcal/100 ml, 8 to 24 Kcal/100 ml, or 24 to 32 Kcal/100 ml, depending on embodiments. When a high calorie component such as a milk component, a total calorie of a natural sugar and a component such as a milk component is preferably 50 Kcal/100 ml or less.

Additionally, X1 of “the sweetness intensity X1” may be 0 to 0.5, 0 to 1.0, 0 to 1.5, 0 to 2.0, 0 to 2.5, 0 to 3.0, 0 to 3.5, 0 to 4.0, 0 to 4.5, 0 to 5.0, 0 to 5.5, 0 to 6.0, 0 to 6.5, 0 to 7.0, 0 to 7.5, 0 to 8.0, 0 to 8.25, 0 to 8.5, 0 to 8.75, 0 to 9.0, 0 to 9.25, 0 to 9.5, 0 to 9.75, 0 to 10.0, 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.05 to 6.0, 0.05 to 6.5, 0.05 to 7.0, 0.05 to 7.5, 0.05 to 8.0, 0.05 to 8.25, 0.05 to 8.5, 0.05 to 8.75, 0.05 to 9.0, 0.05 to 9.25, 0.05 to 9.5, 0.05 to 9.75, 0.05 to 10.0, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 5.9, 0.1 to 6.0, 0.1 to 6.5, 0.1 to 7.0, 0.1 to 7.5, 0.1 to 8.0, 0.1 to 8.25, 0.1 to 8.5, 0.1 to 8.75, 0.1 to 9.0, 0.1 to 9.25, 0.1 to 9.5, 0.1 to 9.75, 0.1 to 10.0, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 0.5 to 6.0, 0.5 to 6.5, 0.5 to 7.0, 0.5 to 7.5, 0.5 to 8.0, 0.5 to 8.25, 0.5 to 8.5, 0.5 to 8.75, 0.5 to 9.0, 0.5 to 9.25, 0.5 to 9.5, 0.5 to 9.75, 0.5 to 10.0, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.25, 1.0 to 8.5, 1.0 to 8.75, 1.0 to 9.0, 1.0 to 9.25, 1.0 to 9.5, 1.0 to 9.75, 1.0 to 10.0, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 1.5 to 6.0, 1.5 to 6.5, 1.5 to 7.0, 1.5 to 7.5, 1.5 to 8.0, 1.5 to 8.25, 1.5 to 8.5, 1.5 to 8.75, 1.5 to 9.0, 1.5 to 9.25, 1.5 to 9.5, 1.5 to 9.75, 1.5 to 10.0, 2.0 to 2.5, 2.0 to 3.0, 2.0 to 3.5, 2.0 to 4.0, 2.0 to 4.5, 2.0 to 5.0, 2.0 to 5.5, 2.0 to 6.0, 2.0 to 6.5, 2.0 to 7.0, 2.0 to 7.5, 2.0 to 8.0, 2.0 to 8.25, 2.0 to 8.5, 2.0 to 8.75, 2.0 to 9.0, 2.0 to 9.25, 2.0 to 9.5, 2.0 to 9.75, 2.0 to 10.0, 2.5 to 3.0, 2.5 to 3.5, 2.5 to 4.0, 2.5 to 4.5, 2.5 to 5.0, 2.5 to 5.5, 2.5 to 6.0, 2.5 to 6.5, 2.5 to 7.0, 2.5 to 7.5, 2.5 to 8.0, 2.5 to 8.25, 2.5 to 8.5, 2.5 to 8.75, 2.5 to 9.0, 2.5 to 9.25, 2.5 to 9.5, 2.5 to 9.75, or 2.5 to 10.0.

X1 may also be 0 to 10.5, 0 to 11.0, 0 to 11.5, 0 to 12.0, 0 to 12.5, 0 to 13.0, 0 to 13.5, 0 to 14.0, 0 to 14.5, 0 to 15.0, 0.05 to 10.5, 0.05 to 11.0, 0.05 to 11.5, 0.05 to 12.0, 0.05 to 12.5, 0.05 to 13.0, 0.05 to 13.5, 0.05 to 14.0, 0.05 to 14.5, 0.05 to 15.0, 0.1 to 10.5, 0.1 to 11.0, 0.1 to 11.5, 0.1 to 12.0, 0.1 to 12.5, 0.1 to 13.0, 0.1 to 13.5, 0.1 to 14.0, 0.1 to 14.5, 0.1 to 15.0, 0.5 to 10.5, 0.5 to 11.0, 0.5 to 11.5, 0.5 to 12.0, 0.5 to 12.5, 0.5 to 13.0, 0.5 to 13.5, 0.5 to 14.0, 0.5 to 14.5, 0.5 to 15.0, 1.0 to 10.5, 1.0 to 11.0, 1.0 to 11.5, 1.0 to 12.0, 1.0 to 12.5, 1.0 to 13.0, 1.0 to 13.5, 1.0 to 14.0, 1.0 to 14.5, 1.0 to 15.0, 1.5 to 10.5, 1.5 to 11.0, 1.5 to 11.5, 1.5 to 12.0, 1.5 to 12.5, 1.5 to 13.0, 1.5 to 13.5, 1.5 to 14.0, 1.5 to 14.5, 1.5 to 15.0, 2.0 to 10.5, 2.0 to 11.0, 2.0 to 11.5, 2.0 to 12.0, 2.0 to 12.5, 2.0 to 13.0, 2.0 to 13.5, 2.0 to 14.0, 2.0 to 14.5, 2.0 to 15.0, 2.5 to 10.5, 2.5 to 11.0, 2.5 to 11.5, 2.5 to 12.0, 2.5 to 12.5, 2.5 to 13.0, 2.5 to 13.5, 2.5 to 14.0, 2.5 to 14.5, or 2.5 to 15.0.

The amount corresponding to the sweetness intensity X1 of the natural sugar refers to an amount (a concentration) that exhibits the sweetness of the sweetness intensity X1 under conditions where the natural sugar is dissolved in water at 20° C. having a volume equivalent to that of the tea beverage of the present invention.

Here, the sweetness intensity means sweetness exhibited by a substance. For example, in the case where the sweetness intensity exhibited by sucrose per unit concentration Brix 1 is defined as a degree of sweetness of 1, glucose has a degree of sweetness of 0.6 to 0.7 (center value: 0.65). A numerical value obtained by multiplying this degree of sweetness by the concentration Brix value of glucose is the sweetness intensity of glucose. Thus, when the concentration of glucose is Brix 1.5, the sweetness intensity of glucose is 0.65×1.5=0.975. When calculating the sweetness intensity in the present invention, the sweetness intensity of a sugar showing a range in the degree of sweetness, the center value is used unless otherwise noted.

TABLE 1

| | Degree of |
|---|---|
| Sugar (D-form) | sweetness |
| Sucrose | 1 |
| Glucose | 0.6 to 0.7 |
| Fructose | 1.3 to 1.7 |
| Maltose | 0.4 |
| Fructooligosaccharide | 0.6 |
| Maltooligosaccharide | 0.3 |
| Isomaltooligosaccharide | 0.4 to 0.5 |
| Galactooligosaccharide | 0.7 |
| Isomerized sugar | 0.8 to 0.9 |
| Lactose | 0.2 to 0.3 |
| Psicose | 0.7 |
| Allose | 0.8 |
| Tagatose | 0.9 |

### (High-Intensity Sweetener)

In the present invention, the “high-intensity sweetener” refers to a compound having sweetness more intense than that of sucrose, and may be a naturally occurring compound, a synthetic compound, and a combination of a naturally occurring compound and a synthetic compound. The high-intensity sweetener, in an amount equivalent to sucrose, exhibits sweetness 5 times or more, 10 times or more, 50 times or more, 100 times or more, 500 times or more, 1000 times or more, 5000 times or more, 10000 times or more, 50000 times or more, or 100000 times or more as that of sucrose. The high-intensity sweetener exhibits extremely intense sweetness in this way. When the existence of the natural sugar and high-intensity sweetener in the food or beverage of the present invention is expressed in a weight ratio, “natural sugar:high-intensity sweetener” is 5:1 to 10:1, 50:1 to 100:1, 50:1 to 200:1, 500:1 to 1000:1, 5000:1 to 10000:1, and 50000:1 to 100000:1.

In the present invention, as the high-intensity sweetener, at least one high-intensity sweetener b1 selected from the group consisting of rebaudioside M, rebaudioside D, rebaudioside N, rebaudioside O, rebaudioside E, a Luo han guo extract, mogroside V, and thaumatin is used.

The content of the high-intensity sweetener b1 based on the total amount (100 mass %) of the high-intensity sweetener as the component (b) is preferably 50 mass % or more, more preferably 60 mass % or more, further preferably 70 mass % or more, more further preferably 80 mass % or more, and particularly preferably 90 mass % or more. In an aspect of the present invention, the high-intensity sweetener as the component (b) may substantially consist of the high-intensity sweetener b1. In the present specification, the phrase “substantially consist of the high-intensity sweetener b1” means that impurities, such as other steviol glycoside and mogroside, which are inevitably included in the process (e.g., purification of a stevia extract or a Luo han guo extract or biosynthesis) of preparing the high-intensity sweetener b1 may be included.

Rebaudioside M, rebaudioside D, rebaudioside N, rebaudioside O, and rebaudioside E may be directly extracted from stevia or may be obtained by attaching glucose to a compound having another structure contained in a stevia extract.

The Luo han guo extract as a sweetener is an extract of Luo han guo containing a sweet substance derived from Luo han guo, and has been approved as a food additive in various countries including Japan and is commercially available. Examples of the sweet substance derived from Luo han guo include mogroside V, mogroside IV, 11-oxo-mogroside V, and Siamenoside I.

Mogroside V is one of the major mogrol glycosides contained in Luo han guo, and it has been reported that it has a good-quality sweetness property close to sucrose when compared with rebaudioside A. In addition, the degree of sweetness of mogroside V is about 300 times that of sucrose (Murata Y. et al., Nippon Shokuhin Kagaku Kogaku Kaishi, Vol. 53, No. 10, 527 to 533, (2006)). Mogroside V can be obtained from a Luo han guo extract (e.g., an alcohol extract of Luo han guo) through purification by chromatography or the like. Alternatively, mogroside V may be obtained by attaching glucose to a compound having another structure contained in a Luo han guo extract.

The Luo han guo extract preferably contains mogroside V and the ratio thereof is not limited and can be 10 wt % or more, 15 wt % or more, 20 wt % or more, 25 wt % or more, 30 wt % or more, 35 wt % or more, 40 wt % or more, 45 wt % or more, 50 wt % or more, 55 wt % or more, 60 wt % or more, 65 wt % or more, 70 wt % or more, and 75 wt % or more, of the total dry weight of a Luo han guo extract. The content of mogroside V can be determined by a known technique such as liquid chromatography. The Luo han guo extract can be obtained by extracting a fruit of Luo han guo (Siraitia grosvenorii) with a suitable solvent (for example, an aqueous solvent such as water, an alcohol solvent such as ethanol or methanol, a mixed solvent of an aqueous solvent and an alcohol solvent such as water-containing ethanol or water-containing methanol), and then optionally carrying out a treatment such as degreasing, purification, concentration, and drying.

Mogroside V may be one having a high purity, for example, a purity of 80% or more, 85% or more, 90% or more, 91% or more, 92% or more, 93% or more, 94% or more, 95% or more, 96% or more, 97% or more, or 98% or more. In mogroside V obtained by purifying a Luo han guo extract, understandably, the amount of Luo han guo extract components other than mogroside V is decreased with an increase in purity.

Thaumatin is a protein-based sweetener extracted from a plant.

In the present invention, an optional high-intensity sweetener b2 may be used in combination with the above-described high-intensity sweetener b1, as needed. Specific examples of the optional high-intensity sweetener b2 include peptide-based sweeteners, such as aspartame, neotame, and alitame; sucrose derivatives, such as sucralose; synthetic sweeteners, such as acesulfame K, saccharine, advantame, cyclamate, and dulcin; protein-based sweeteners extracted from plants, such as monellin, curculin, and brazzein, other than thaumatin; high-intensity sweeteners other than protein-based sweetener extracted from plants; tourmaline; and neohesperidin dihydrochalcone.

The sucrose derivative is that obtained by substituting the OH group or the H group of sucrose with another substituent, and examples thereof include halogen derivatives of sucrose (sucralose), oxathiazinonedioxide derivatives, sugar alcohols, aldonic acid, and uronic acid.

Examples of the high-intensity sweetener other than the protein-based sweeteners extracted from plants include sweeteners present in a stevia extract, other than rebaudioside M, rebaudioside D, rebaudioside N, rebaudioside O, and rebaudioside E; sweeteners present in a Luo han guo extract, other than mogroside V; sweeteners present in a Glycyrrhiza extract; and glycosides thereof, and also include monatin and glycyrrhizin.

Examples of the sweetener present in a stevia extract, other than rebaudioside M, rebaudioside D, rebaudioside N, rebaudioside O, and rebaudioside E and the glycoside thereof include steviol, stevioside, rebaudioside A, rebaudioside B, and rebaudioside C.

Examples of the sweetener present in a Luo han guo extract, other than mogroside V and the glycoside thereof include mogroside IV.

The Glycyrrhiza extract refers to that obtained from roots or rhizomes of Glycyrrhiza uralensis Fisher, Glycyrrhiza inflata Batalin, or Glycyrrhiza glabra Linne and having glycyrrhizic acid as a main component. Examples of the Glycyrrhiza extract include a Glycyrrhiza extract, glycyrrhizin, and a licorice extract.

In the present invention, the high-intensity sweetener b1 is suitable at least one selected from the group consisting of rebaudioside M, rebaudioside D, a Luo han guo extract, mogroside V, and a combination thereof. In particular, rebaudioside D, rebaudioside M, or a mixture of rebaudioside D and rebaudioside M is suitable as the high-intensity sweetener b1.

Rebaudioside D and rebaudioside M have less negative flavor, such as astringent taste and metallic taste, which is observed in rebaudioside A and have characteristics, such as good-quality sweetness, and they are expected to be used in the fields of food and drink (NIPPON KAGAKU KAISHI, (5), (1981), 726-735, “Sweet Diterpene-Glycoside of Leaves of Stevia rebaudiana Bertoni Synthesis and Structure-Sweetness Relationship of Rebaudiosides-A, -D, -E and Their Related glycosides”, Kasai, Kaneda, Tanaka, Yamasaki, Sakamoto, Morimoto, Okada, Kitahata, and Furukawa). Thus, rebaudioside D and rebaudioside M when used alone are excellent in that they have less odd taste compared to rebaudioside A and sweetness close to sucrose. Rebaudioside D and rebaudioside M each have sweetness about 200 times that of sucrose.

Examples of the combination of the high-intensity sweeteners b1 and the combination of the high-intensity sweetener b1 and the optional high-intensity sweetener b2 include the followings. Specifically, the examples include combinations of rebaudioside D and rebaudioside M; rebaudioside D and rebaudioside A; rebaudioside M and rebaudioside A; rebaudioside M and mogroside V; rebaudioside D and mogroside V; rebaudioside D and advantame; rebaudioside D and acesulfame K; rebaudioside D and sucralose; rebaudioside M, rebaudioside D, and rebaudioside A; rebaudioside M, rebaudioside D, and mogroside V; rebaudioside M, rebaudioside D, and advantame; rebaudioside M, rebaudioside D, and acesulfame K; rebaudioside M, rebaudioside D, and sucralose; rebaudioside A, rebaudioside M, rebaudioside D, and mogroside V; rebaudioside A, rebaudioside M, mogroside V, and sucralose; rebaudioside D, rebaudioside M, mogroside V, and acesulfame K; rebaudioside M, rebaudioside A, mogroside V, and neohesperidin dihydrochalcone; and rebaudioside M, rebaudioside D, sucralose, neohesperidin dihydrochalcone, and brazzein.

In addition, the examples include combinations of rebaudioside D and mogroside V; rebaudioside D and a Luo han guo extract; rebaudioside M and a Luo han guo extract; rebaudioside M, rebaudioside D, and a Luo han guo extract; rebaudioside A, rebaudioside M, rebaudioside D, and a Luo han guo extract; rebaudioside A, rebaudioside M, a Luo han guo extract, and sucralose; rebaudioside D, rebaudioside M, a Luo han guo extract, and acesulfame K; and rebaudioside M, rebaudioside A, a Luo han guo extract, and neohesperidin dihydrochalcone.

X2 of “the sweetness intensity X2” may be 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, 3.0 to 5.5, 2.0 to 6.5, 2.0 to 7.0, 2.0 to 7.5, 2.0 to 6.0, 2.5 to 7.0, 2.5 to 7.5, 2.5 to 6.0, 2.5 to 6.5, 3.0 to 6.0, 3.0 to 6.5, 3.0 to 7.0, 3.0 to 7.5, 3.0 to 8.0, 3.0 to 8.5, 3.0 to 9.0, 3.0 to 9.5, 3.5 to 7.0, 3.5 to 7.5, 3.5 to 8.0, 3.5 to 9.0, 3.5 to 9.5, 4.0 to 7.5, 4.0 to 8.0, 4.0 to 8.5, 4.0 to 9.0, 4.0 to 9.5, 3.5 to 8.5, 3.5 to 10.0, 3.5 to 10.5, 3.5 to 11.0, 3.5 to 11.5, 4.0 to 11.5, or 4.5 to 8.5.

X2 may also be 0.05 to 6.0, 0.05 to 6.5, 0.05 to 7.0, 0.05 to 7.5, 0.05 to 8.0, 0.05 to 8.5, 0.05 to 9.0, 0.05 to 9.5, 0.05 to 10.0, 0.05 to 10.5, 0.05 to 11.0, 0.05 to 11.5, 0.05 to 12.0, 0.05 to 13.0, 0.05 to 14.0, 0.05 to 15.0, 0.05 to 16.0, 0.05 to 17.0, 0.05 to 18.0, 0.5 to 6.0, 0.5 to 6.5, 0.5 to 7.0, 0.5 to 7.5, 0.5 to 8.0, 0.5 to 8.5, 0.5 to 9.0, 0.5 to 9.5, 0.5 to 10.0, 0.5 to 10.5, 0.5 to 11.0, 0.5 to 11.5, 0.5 to 12.0, 0.5 to 13.0, 0.5 to 14.0, 0.5 to 15.0, 0.5 to 16.0, 0.5 to 17.0, 0.5 to 18.0, 1.0 to 6.0, 1.0 to 6.5, 1.0 to 7.0, 1.0 to 7.5, 1.0 to 8.0, 1.0 to 8.5, 1.0 to 9.0, 1.0 to 9.5, 1.0 to 10.0, 1.0 to 10.5, 1.0 to 11.0, 1.0 to 11.5, 1.0 to 12.0, 1.0 to 13.0, 1.0 to 14.0, 1.0 to 15.0, 1.0 to 16.0, 1.0 to 17.0, 1.0 to 18.0, 1.5 to 6.0, 1.5 to 6.5, 1.5 to 7.0, 1.5 to 7.5, 1.5 to 8.0, 1.5 to 8.5, 1.5 to 9.0, 1.5 to 9.5, 1.5 to 10.0, 1.5 to 10.5, 1.5 to 11.0, 1.5 to 11.5, 1.5 to 12.0, 1.5 to 13.0, 1.5 to 14.0, 1.5 to 15.0, 1.5 to 16.0, 1.5 to 17.0, 1.5 to 18.0, 2.0 to 8.0, 2.0 to 8.5, 2.0 to 9.0, 2.0 to 9.5, 2.0 to 10.0, 2.0 to 10.5, 2.0 to 11.0, 2.0 to 11.5, 2.0 to 12.0, 2.0 to 13.0, 2.0 to 14.0, 2.0 to 15.0, 2.0 to 16.0, 2.0 to 17.0, 2.0 to 18.0, 2.5 to 8.0, 2.5 to 8.5, 2.5 to 9.0, 2.5 to 9.5, 2.5 to 10.0, 2.5 to 10.5, 2.5 to 11.0, 2.5 to 11.5, 2.5 to 12.0, 2.5 to 13.0, 2.5 to 14.0, 2.5 to 15.0, 2.5 to 16.0, 2.5 to 17.0, 2.5 to 18.0, 3.0 to 10.0, 3.0 to 10.5, 3.0 to 11.0, 3.0 to 11.5, 3.0 to 12.0, 3.0 to 13.0, 3.0 to 14.0, 3.0 to 15.0, 3.0 to 16.0, 3.0 to 17.0, 3.0 to 18.0, 3.5 to 4.0, 3.5 to 4.5, 3.5 to 5.0, 3.5 to 5.5, 3.5 to 6.0, 3.5 to 6.5, 3.5 to 12.0, 3.5 to 13.0, 3.5 to 14.0, 3.5 to 15.0, 3.5 to 16.0, 3.5 to 17.0, 3.5 to 18.0, 4.0 to 4.5, 4.0 to 5.0, 4.0 to 5.5, 4.0 to 6.0, 4.0 to 6.5, 4.0 to 7.0, 4.0 to 10.0, 4.0 to 10.5, 4.0 to 11.0, 4.0 to 12.0, 4.0 to 13.0, 4.0 to 14.0, 4.0 to 15.0, 4.0 to 16.0, 4.0 to 17.0, or 4.0 to 18.0.

The amount corresponding to a sweetness intensity X2 of a high-intensity sweetener refers to an amount which provides sweetness of a sweetness intensity X2 under the conditions when the high-intensity sweetener is dissolved in water having the same volume as the tea beverage of the present invention at 20° C.

As in a natural sugar, also here, the sweetness intensity means the sweetness exhibited by a substance. For example, when the sweetness intensity exhibited by sucrose per unit concentration Brix 1 is defined as a degree of sweetness of 1, the degree of sweetness of rebaudioside D is 200 to 250 (center value 225), the degree of sweetness of rebaudioside M is 200 to 260 (center value 230), the degree of sweetness of rebaudioside N is 230 to 240 (center value 235), the degree of sweetness of rebaudioside 0 is 200 to 250 (center value 225), the degree of sweetness of rebaudioside N is 200 to 250 (center value 225), the degree of sweetness of rebaudioside E is 70 to 80 (center value 75), the degree of sweetness of a Luo han guo extract is 110 to 150 (center value 130), the degree of sweetness of mogroside V is 240 to 300 (center value 270), and the degree of sweetness of thaumatin is 2,000. The numerical value obtained by multiplying these degrees of sweetness by the concentration (w/v % (considered to be the same as w/w % in the case of a beverage)) of the high-intensity sweetener in the tea beverage is the sweetness intensity of the high-intensity sweetener. When calculating the sweetness intensity in the present invention, the sweetness intensity of a high-intensity sweetener showing a range in the degree of sweetness, the center value is used unless otherwise noted.

Further, the amount of a high-intensity sweetener can be P2 ppm and P2 ppm herein refers to an amount corresponding to a sweetness intensity X2. The P2 herein can be a value of 20 to 550, 25 to 550, 30 to 550, 35 to 550, 40 to 550, 45 to 550, 50 to 550, 55 to 550, 20 to 540, 25 to 540, 30 to 540, 35 to 540, 40 to 540, 45 to 540, 50 to 540, 55 to 540, 20 to 530, 25 to 530, 30 to 530, 35 to 530, 40 to 530, 45 to 530, 50 to 530, 55 to 530, 20 to 520, 25 to 520, 30 to 520, 35 to 520, 40 to 520, 45 to 520, 50 to 520, 55 to 520, 20 to 510, 25 to 510, 30 to 510, 35 to 510, 40 to 510, 45 to 510, 50 to 510, 55 to 510, 20 to 505, 25 to 505, 30 to 505, 35 to 505, 40 to 505, 45 to 505, 50 to 505, 55 to 505, 20 to 500, 25 to 500, 30 to 500, 35 to 500, 40 to 500, 45 to 500, 50 to 500, 55 to 500, 20 to 495, 25 to 495, 30 to 495, 35 to 495, 40 to 495, 45 to 495, 50 to 495, 55 to 495, 20 to 490, 25 to 490, 30 to 490, 35 to 490, 40 to 490, 45 to 490, 50 to 490, or 55 to 490.

The P2 can also be a value of 1 to 1500, 1 to 1200, 5 to 1200, 1 to 1000, 5 to 1000, 10 to 1000, 1 to 900, 5 to 900, 10 to 900, 15 to 900, 20 to 900, 25 to 900, 30 to 900, 35 to 900, 40 to 900, 45 to 900, 50 to 900, 55 to 900, 1 to 800, 5 to 800, 10 to 800, 15 to 800, 20 to 800, 25 to 800, 30 to 800, 35 to 800, 40 to 800, 45 to 800, 50 to 800, 55 to 800, 1 to 700, 5 to 700, 10 to 700, 15 to 700, 20 to 700, 25 to 700, 30 to 700, 35 to 700, 40 to 700, 45 to 700, 50 to 700, 55 to 700, 1 to 600, 5 to 600, 10 to 600, 15 to 600, 20 to 600, 25 to 600, 30 to 600, 35 to 600, 40 to 600, 45 to 600, 50 to 600, 55 to 600, 1 to 550, 1 to 540, 1 to 530, 1 to 520, 1 to 510, 1 to 505, 1 to 500, 1 to 495, 1 to 490, 5 to 550, 5 to 540, 5 to 530, 5 to 520, 5 to 510, 5 to 505, 5 to 500, 5 to 495, 5 to 490, 10 to 550, 10 to 540, 10 to 530, 10 to 520, 10 to 510, 10 to 505, 10 to 500, 10 to 495, 10 to 490, 15 to 550, 15 to 540, 15 to 530, 15 to 520, 15 to 510, 15 to 505, 15 to 500, 15 to 495, or 15 to 490.

### (Sodium)

The present invention contains (c) less than 50 mg/100 ml of sodium, which means that the amount of sodium atoms is less than 50 mg/100 ml of sodium. The amount of sodium may be the amount of 0.1 mg/100 ml or more and less than 50 mg/100 ml, 0.1 to 45 mg/100 ml, 0.1 to 40 mg/100 ml, 0.1 to 35 mg/100 ml, 0.1 to 30 mg/100 ml, 0.1 to 25 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 mg/100 ml or more and less than 50 mg/100 ml, 1 to 45 mg/100 ml, 1 to 40 mg/100 ml, 1 to 35 mg/100 ml, 1 to 30 mg/100 ml, 1 to 25 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 5 mg/100 ml or more and less than 50 mg/100 ml, 5 to 45 mg/100 ml, 5 to 40 mg/100 ml, 5 to 35 mg/100 ml, 5 to 30 mg/100 ml, 5 to 25 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 7 mg/100 ml or more and less than 50 mg/100 ml, 7 to 45 mg/100 ml, 7 to 40 mg/100 ml, 7 mg/100 ml or more and less than 40 mg/100 ml, 7 to 35 mg/100 ml, 7 to 30 mg/100 ml, 7 to 25 mg/100 ml, 7 to 20 mg/100 ml, 7 to 19 mg/100 ml, 7 to 18 mg/100 ml, 7 to 17 mg/100 ml, 7 to 16 mg/100 ml, 7 to 15 mg/100 ml, 7 to 14 mg/100 ml, 7 to 13 mg/100 ml, 7 to 12 mg/100 ml, 7 to 11 mg/100 ml, 7 to 10 mg/100 ml, 10 mg/100 ml or more and less than 50 mg/100 ml, 10 to 45 mg/100 ml, 10 to 40 mg/100 ml, 10 to 35 mg/100 ml, 10 to 30 mg/100 ml, 10 to 25 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 mg/100 ml or more and less than 50 mg/100 ml, 15 to 45 mg/100 ml, 15 to 40 mg/100 ml, 15 to 35 mg/100 ml, 15 to 30 mg/100 ml, 15 to 25 mg/100 ml, 15 to 20 mg/100 ml, 17 mg/100 ml or more and less than 50 mg/100 ml, to 45 mg/100 ml, 17 mg/100 ml or more and less than 40 mg/100 ml, 17 to 40 mg/100 ml, 17 to 35 mg/100 ml, 17 to 30 mg/100 ml, 17 to 25 mg/100 ml, 17 to 20 mg/100 ml, 17 to 19 mg/100 ml, 17 to 18 mg/100 ml, 20 mg/100 ml or more and less than 50 mg/100 ml, 20 to 45 mg/100 ml, 20 to 40 mg/100 ml, 20 to 35 mg/100 ml, 20 to 30 mg/100 ml, 20 to 25 mg/100 ml, 25 mg/100 ml or more and less than 50 mg/100 ml, 25 to 45 mg/100 ml, 25 to 40 mg/100 ml, 25 to 35 mg/100 ml, or 25 to 30 mg/100 ml, depending on embodiments.

The amount of sodium may be the amount of 0.1 to 22 mg/100 ml, 0.1 to 21 mg/100 ml, 1 to 22 mg/100 ml, 1 to 21 mg/100 ml, 4 to 40 mg/100 ml, 4 to 35 mg/100 ml, 4 to 34 mg/100 ml, 4 to 33 mg/100 ml, 4 to 32 mg/100 ml, 4 to 31 mg/100 ml, 4 to 30 mg/100 ml, 4 to 29 mg/100 ml, 4 to 26 mg/100 ml, 4 to 25 mg/100 ml, 4 to 22 mg/100 ml, 4 to 21 mg/100 ml, 4 to 20 mg/100 ml, 4 to 19 mg/100 ml, 4 to 18 mg/100 ml, 4 to 17 mg/100 ml, 4 to 16 mg/100 ml, 4 to 15 mg/100 ml, 4 to 14 mg/100 ml, 4 to 13 mg/100 ml, 4 to 12 mg/100 ml, 4 to 11 mg/100 ml, 4 to 10 mg/100 ml, 5 to 34 mg/100 ml, 5 to 33 mg/100 ml, 5 to 32 mg/100 ml, 5 to 31 mg/100 ml, 5 to 29 mg/100 ml, 5 to 22 mg/100 ml, 5 to 21 mg/100 ml, 10 to 34 mg/100 ml, 10 to 33 mg/100 ml, 10 to 32 mg/100 ml, 10 to 31 mg/100 ml, 10 to 29 mg/100 ml, 10 to 22 mg/100 ml, 10 to 21 mg/100 ml, 11.5 to 34 mg/100 ml, 11.5 to 33 mg/100 ml, 11.5 to 32 mg/100 ml, 11.5 to 31 mg/100 ml, 11.5 to 30 mg/100 ml, 11.5 to 29 mg/100 ml, 11.5 to 22 mg/100 ml, 11.5 to 21 mg/100 ml, 11.5 to 20 mg/100 ml, 11.5 to 19 mg/100 ml, 11.5 to 18 mg/100 ml, 11.5 to 17 mg/100 ml, 11.5 to 16 mg/100 ml, 11.5 to 15 mg/100 ml, 11.5 to 14 mg/100 ml, 11.5 to 13 mg/100 ml, 11.5 to 12 mg/100 ml, 5.75 to 34.5 mg/100 ml, 5.75 to 28.75 mg/100 ml, 5.75 to 23 mg/100 ml, 5.75 to 17.25 mg/100 ml, 5.75 to 11.5 mg/100 ml, 11.5 to 34.5 mg/100 ml, 11.5 to 28.75 mg/100 ml, 11.5 to 23 mg/100 ml, 11.5 to 17.25 mg/100 ml, 17.25 to 34.5 mg/100 ml, 17.25 to 28.75 mg/100 ml, 17.25 to 23 mg/100 ml, 23 to 34.5 mg/100 ml, 23 to 28.75 mg/100 ml, or 28.75 to 34.5 mg/100 ml, depending on embodiments.

In addition, the amount of sodium that is added to a tea beverage may be 0.1 mg/100 ml or more and less than 50 mg/100 ml, 0.1 to 45 mg/100 ml, 0.1 to 40 mg/100 ml, 0.1 to 35 mg/100 ml, 0.1 to 30 mg/100 ml, 0.1 to 25 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 mg/100 ml or more and less than 50 mg/100 ml, 1 to 45 mg/100 ml, 1 to 40 mg/100 ml, 1 to 35 mg/100 ml, 1 to 30 mg/100 ml, 1 to 25 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 5 mg/100 ml or more and less than 50 mg/100 ml, 5 to 45 mg/100 ml, 5 to 40 mg/100 ml, 5 to 35 mg/100 ml, 5 to 30 mg/100 ml, 5 to 25 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 10 mg/100 ml or more and less than 50 mg/100 ml, 10 to 45 mg/100 ml, 10 to 40 mg/100 ml, 10 to 35 mg/100 ml, 10 to 30 mg/100 ml, 10 to 25 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 mg/100 ml or more and less than 50 mg/100 ml, 15 to 45 mg/100 ml, 15 to 40 mg/100 ml, 15 to 35 mg/100 ml, 15 to 30 mg/100 ml, 15 to 25 mg/100 ml, 15 to 20 mg/100 ml, 20 mg/100 ml or more and less than 50 mg/100 ml, 20 to 45 mg/100 ml, 20 to 40 mg/100 ml, 20 to 35 mg/100 ml, 20 to 30 mg/100 ml, 20 to 25 mg/100 ml, 25 mg/100 ml or more and less than 50 mg/100 ml, 25 to 45 mg/100 ml, 25 to 40 mg/100 ml, 25 to 35 mg/100 ml, or 25 to 30 mg/100 ml.

Forms of sodium is not particularly limited provided that sodium in an ingestible state is contained in the tea beverage of the present invention, and may be in at least one form selected from the group consisting of sodium chloride, sodium hydroxide, sodium malate, sodium sulfate, sodium citrate, sodium phosphate, sodium carbonate, sodium disulfide, sodium bicarbonate, sodium alginate, sodium argininate, sodium glucoheptanoate, sodium gluconate, sodium glutamate, sodium tartrate, sodium aspartate, sodium lactate, sodium caseinate, sodium ascorbate, and a mixture thereof, for example. In addition, sodium is also contained in tea leaves in some cases, and in such a case, sodium obtained when extracting tea from tea leaves is included in the sodium contained in the tea beverage of the present invention. In an aspect of the present invention, sodium derived from a sodium component that is used as a preservative (e.g., sodium benzoate, sodium sulfite, sodium hyposulfite, sodium dehydroacetate, sodium pyrosulfite, or sodium propionate) is not substantially included in the component (c).

In the present specification, the sodium content in a beverage can be measured by atomic absorption spectrometry. Incidentally, when the amount of a sodium-containing compound contained in the beverage is known, the value calculated from the amount may be used.

### (Potassium)

The present invention may contain (d) 0.1 mg/100 ml to 52 mg/100 ml of potassium, which means that the amount of potassium atoms is 0.1 mg/100 ml to 52 mg/100 ml of potassium. The amount of potassium may be the amount of 0.1 to 50 mg/100 ml, 0.1 to 45 mg/100 ml, 0.1 to 40 mg/100 ml, 0.1 to 35 mg/100 ml, 0.1 to 32 mg/100 ml, 0.1 to 30 mg/100 ml, 0.1 to 25 mg/100 ml, 0.1 to 21 mg/100 ml, 0.1 to 20 mg/100 ml, 0.1 to 15 mg/100 ml, 0.1 to 10 mg/100 ml, 0.1 to 5 mg/100 ml, 0.5 to 52 mg/100 ml, 0.5 to 50 mg/100 ml, 0.5 to 45 mg/100 ml, 0.5 to 40 mg/100 ml, 0.5 to 35 mg/100 ml, 0.5 to 30 mg/100 ml, 0.5 to 25 mg/100 ml, 0.5 to 21 mg/100 ml, 0.5 to 20 mg/100 ml, 0.5 to 15 mg/100 ml, 0.5 to 10 mg/100 ml, 0.5 to 5 mg/100 ml, 1 to 52 mg/100 ml, 1 to 50 mg/100 ml, 1 to 45 mg/100 ml, 1 to 40 mg/100 ml, 1 to 35 mg/100 ml, 1 to 32 mg/100 ml, 1 to 30 mg/100 ml, 1 to 25 mg/100 ml, 1 to 21 mg/100 ml, 1 to 20 mg/100 ml, 1 to 15 mg/100 ml, 1 to 10 mg/100 ml, 1 to 5 mg/100 ml, 5 to 52 mg/100 ml, 5 to 50 mg/100 ml, 5 to 45 mg/100 ml, 5 to 40 mg/100 ml, 5 to 35 mg/100 ml, 5 to 32 mg/100 ml, 5 to 30 mg/100 ml, 5 to 25 mg/100 ml, 5 to 21 mg/100 ml, 5 to 20 mg/100 ml, 5 to 15 mg/100 ml, 5 to 10 mg/100 ml, 5 to 5 mg/100 ml, 10 to 52 mg/100 ml, 10 to 50 mg/100 ml, 10 to 45 mg/100 ml, 10 to 40 mg/100 ml, 10 to 35 mg/100 ml, 10 to 32 mg/100 ml, 10 to 30 mg/100 ml, 10 to 25 mg/100 ml, 10 to 21 mg/100 ml, 10 to 20 mg/100 ml, 10 to 15 mg/100 ml, 12 to 52 mg/120 ml, 12 to 50 mg/120 ml, 12 to 45 mg/120 ml, 12 to 40 mg/120 ml, 12 to 35 mg/120 ml, 12 to 32 mg/100 ml, 12 to 30 mg/120 ml, 12 to 25 mg/120 ml, 12 to 21 mg/100 ml, 12 to 20 mg/120 ml, 12 to 15 mg/120 ml, 15 to 52 mg/100 ml, 15 to 50 mg/100 ml, 15 to 45 mg/100 ml, 15 to 40 mg/100 ml, 15 to 35 mg/100 ml, 15 to 32 mg/100 ml, 15 to 30 mg/100 ml, 15 to 25 mg/100 ml, 15 to 21 mg/100 ml, 15 to 20 mg/100 ml, 20 to 52 mg/100 ml, 20 to 50 mg/100 ml, 20 to 45 mg/100 ml, 20 to 40 mg/100 ml, 20 to 35 mg/100 ml, 20 to 32 mg/100 ml, 20 to 30 mg/100 ml, or 20 to 25 mg/100 ml, depending on embodiments.

In addition, the amount of potassium that is added to a tea beverage may be 0.1 to 52 mg/100 ml, 0.1 to 50 mg/100 ml, 0.1 to 45 mg/100 ml, 0.1 to 40 mg/100 ml, 0.1 to 35 mg/100 ml, 0.1 to 30 mg/100 ml, 0.1 to 25 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 to 50 mg/100 ml, 1 to 45 mg/100 ml, 1 to 40 mg/100 ml, 1 to 35 mg/100 ml, 1 to 30 mg/100 ml, 1 to 25 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 5 to 50 mg/100 ml, 5 to 45 mg/100 ml, 5 to 40 mg/100 ml, 5 to 35 mg/100 ml, 5 to 30 mg/100 ml, 5 to 25 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 10 to 50 mg/100 ml, 10 to 45 mg/100 ml, 10 to 40 mg/100 ml, 10 to 35 mg/100 ml, 10 to 30 mg/100 ml, 10 to 25 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 to 50 mg/100 ml, 15 to 45 mg/100 ml, 15 to 40 mg/100 ml, 15 to 35 mg/100 ml, 15 to 30 mg/100 ml, 15 to 25 mg/100 ml, 15 to 20 mg/100 ml, 20 to 50 mg/100 ml, 20 to 45 mg/100 ml, 20 to 40 mg/100 ml, 20 to 35 mg/100 ml, 20 to 30 mg/100 ml, 20 to 25 mg/100 ml, 25 to 50 mg/100 ml, 25 to 45 mg/100 ml, 25 to 40 mg/100 ml, 25 to 35 mg/100 ml, or 25 to 30 mg/100 ml.

The form of potassium is not particularly limited as long as it is contained in the tea beverage of the present invention in an ingestible state. For example, the form may be at least one form selected from the group consisting of potassium alginate, potassium chloride, potassium citrate, potassium gluconate, L-potassium glutamate, potassium bromate, DL-potassium hydrogen tartrate, L-potassium hydrogen tartrate, potassium nitrate, potassium hydroxide, potassium sorbate, potassium carbonate, potassium lactate, potassium norbixin, potassium pyrosulfate, tetrapotassium pyrophosphate, potassium ferrocyanide, potassium polyphosphate, potassium metaphosphate, potassium aluminum sulfate, potassium sulfate, tripotassium phosphate, dipotassium hydrogen phosphate, potassium dihydrogen phosphate, and a mixture thereof. In addition, potassium is also contained in tea leaves in some cases, and in such a case, potassium obtained when extracting tea from tea leaves is also encompassed in the potassium contained in the tea beverage of the present invention. In addition, potassium may also be contained in tea leaves in some cases, and in such a case, potassium obtained when a component is extracted from the tea leaves is also included in the potassium contained in the tea beverage of the present invention. In addition, when a tea beverage contains a milk component, such as milk, cow's milk, or a dairy product, potassium contained in the milk component is also encompassed.

In the present specification, the content of potassium in a beverage can be measured by atomic absorption spectrometry. Incidentally, when the amount of a potassium-containing compound contained in the beverage is known, the value calculated from the amount may be used.

### (Calcium)

The present invention may contain (d) 0.1 mg/100 ml to 52 mg/100 ml of calcium, which means that the amount of calcium atoms is 0.5 mg/100 ml to 50 mg/100 ml of calcium. The amount of calcium may be the amount of 0.1 to 50 mg/100 ml, 0.1 to 45 mg/100 ml, 0.1 to 40 mg/100 ml, 0.1 to 35 mg/100 ml, 0.1 to 32 mg/100 ml, 0.1 to 30 mg/100 ml, 0.1 to 25 mg/100 ml, 0.1 to 22 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 to 50 mg/100 ml, 1 to 45 mg/100 ml, 1 to 40 mg/100 ml, 1 to 35 mg/100 ml, 1 to 32 mg/100 ml, 1 to 30 mg/100 ml, 1 to 25 mg/100 ml, 1 to 22 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 5 to 50 mg/100 ml, 5 to 45 mg/100 ml, 5 to 40 mg/100 ml, 5 to 35 mg/100 ml, 5 to 32 mg/100 ml, 5 to 30 mg/100 ml, 5 to 25 mg/100 ml, 5 to 22 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 10 to 50 mg/100 ml, 10 to 45 mg/100 ml, 10 to 40 mg/100 ml, 10 to 35 mg/100 ml, 10 to 32 mg/100 ml, 10 to 30 mg/100 ml, 10 to 25 mg/100 ml, 10 to 22 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 12 to 52 mg/120 ml, 12 to 50 mg/120 ml, 12 to 45 mg/120 ml, 12 to 40 mg/120 ml, 12 to 35 mg/120 ml, 12 to 32 mg/100 ml, 12 to 30 mg/120 ml, 12 to 25 mg/120 ml, 12 to 22 mg/100 ml, 12 to 20 mg/120 ml, 12 to 15 mg/120 ml, 15 to 50 mg/100 ml, 15 to 45 mg/100 ml, 15 to 40 mg/100 ml, 15 to 35 mg/100 ml, 15 to 32 mg/100 ml, 15 to 30 mg/100 ml, 15 to 25 mg/100 ml, 15 to 22 mg/100 ml, 15 to 20 mg/100 ml, 20 to 50 mg/100 ml, 20 to 45 mg/100 ml, 20 to 40 mg/100 ml, 20 to 35 mg/100 ml, 20 to 32 mg/100 ml, 20 to 30 mg/100 ml, 20 to 25 mg/100 ml, 25 to 50 mg/100 ml, 25 to 45 mg/100 ml, 25 to 40 mg/100 ml, 25 to 35 mg/100 ml, 25 to 32 mg/100 ml, or 25 to 30 mg/100 ml, depending on embodiments.

In addition, the amount of calcium that is added to a tea beverage may be 0.1 to 52 mg/100 ml, 0.1 to 50 mg/100 ml, 0.1 to 45 mg/100 ml, 0.1 to 40 mg/100 ml, 0.1 to 35 mg/100 ml, 0.1 to 30 mg/100 ml, 0.1 to 25 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 to 52 mg/100 ml, 1 to 50 mg/100 ml, 1 to 45 mg/100 ml, 1 to 40 mg/100 ml, 1 to 35 mg/100 ml, 1 to 30 mg/100 ml, 1 to 25 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 2 to 40 mg/100 ml, 2 to 35 mg/100 ml, 2 to 30 mg/100 ml, 2 to 25 mg/100 ml, 2 to 20 mg/100 ml, 2 to 19 mg/100 ml, 2 to 18 mg/100 ml, 2 to 17 mg/100 ml, 2 to 16 mg/100 ml, 2 to 15 mg/100 ml, 2 to 14 mg/100 ml, 2 to 13 mg/100 ml, 2 to 12 mg/100 ml, 2 to 11 mg/100 ml, 2 to 10 mg/100 ml, 5 to 40 mg/100 ml, 5 to 35 mg/100 ml, 5 to 30 mg/100 ml, 5 to 25 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 10 to 40 mg/100 ml, 10 to 35 mg/100 ml, 10 to 30 mg/100 ml, 10 to 25 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 to 40 mg/100 ml, 15 to 35 mg/100 ml, 15 to 30 mg/100 ml, 15 to 25 mg/100 ml, 15 to 20 mg/100 ml, 20 to 40 mg/100 ml, 20 to 35 mg/100 ml, 20 to 30 mg/100 ml, 20 to 25 mg/100 ml, 25 to 40 mg/100 ml, 25 to 35 mg/100 ml, or 25 to 30 mg/100 ml.

The form of calcium is not particularly limited as long as it is contained in the tea beverage of the present invention in an ingestible state. For example, the form may be at least one form selected from the group consisting of L-calcium ascorbate, calcium alginate, calcium disodium ethylenediaminetetraacetate, calcium chloride, calcium carboxymethyl cellulose, calcium citrate, calcium glycerophosphate, calcium gluconate, L-calcium glutamate, calcium silicate, calcium acetate, calcium oxide, calcium hydroxide, calcium stearate, calcium stearoyl lactate, calcium sorbate, calcium carbonate, calcium lactate, calcium pantothenate, calcium dihydrogen pyrophosphate, calcium ferrocyanide, calcium propionate, calcium 5′-ribonucleotide, calcium sulfate, tricalcium phosphate, calcium monohydrogen phosphate, calcium dihydrogen phosphate, and a mixture thereof. In addition, calcium is also contained in tea leaves and water (in particular, hard water) in some cases, and in such a case, calcium obtained when extracting a component from tea leaves is also encompassed in the calcium contained in the tea beverage of the present invention. In addition, when a tea beverage contains a milk component, such as milk, cow's milk, or a dairy product, calcium contained in the milk component is also encompassed.

In the present specification, the content of calcium in a beverage can be measured by ICP emission spectrometry. Incidentally, when the amount of a calcium-containing compound contained in the beverage is known, the value calculated from the amount may be used. In addition, for example, when an additive containing two or more atoms selected from sodium, potassium, and calcium, such as calcium disodium ethylenediaminetetraacetate, is added, the amount thereof is adjusted such that the amounts of sodium, potassium, and calcium are within the above-mentioned ranges.

The tea beverage of the present invention has an enhanced sweetness as having been already mentioned. Whether or not the sweetness of the tea beverage of the present invention is enhanced can be evaluated by panelists who received sensory trainings. Further, for the sweetness intensity of the tea beverage of the present invention, standard tea beverages to be the sweetness standards are prepared with sucrose concentrations assigned as sweetness intensities 1, 2, 3, 4, 5, 6, 7, 8, 9, 10, 11, 12, 13, 14, and 15 and panelists compare the sweetness of the tea beverage of the present invention with the sweetnesses of these standard tea beverages thereby to measure the sweetness of the tea beverage of the present invention. Note that the standard tea beverages having a sweetness intensity of 1, 2, . . . 15 are prepared by adding sucrose in such a way that a sucrose content is 1 g/100 g, 2 g/100 g, . . . 15 g/100 g to the tea beverage to which sucrose is not added.

Furthermore, of the standard tea beverages having a lower sweetness than the tea beverage of the present invention in the above measurement, the standard tea beverage having the closest sweetness to that of the tea beverage of the present invention is selected and adjusted in such a way as to have the same sweetness as that of the tea beverage of the present invention by adding sucrose to the selected standard tea beverage, during which a sweetness intensity X3 of the tea beverage of the present invention can also be measured from a sucrose content in the adjusted standard tea beverage.

Other examples of the method for measuring a sweetness of the tea beverage of the present invention include a sweetness intensity rating using Visual Analogue Scale (VAS method). For the VAS method, literatures in The journal of Japanese Society of Stomatognathic Function (2014)≤20 pp. 115-129 (“Construction of a Screening Test for Gustatory Function in Four Basic Tastes” by Toyota et al.) and the like can be referred. Specifically, in the measurement of sweetness intensity by the VAS method, for example, evaluators define sweetness intensities as “not sweet at all” at the lower end and “nothing is sweeter than this” at the upper end and, using a piece of paper on which a vertical line indicating the intensities of sweetness on the straight line, assess a sweetness intensity sensed at that time by showing a position on the straight line.

X3 may be 4.0 to 20, 4.0 to 15, 4.0 to 12.5, 4.0 to 10, 4.5 to 20, 4.5 to 15, 4.5 to 12.5, 4.5 to 10, 5.0 to 20, 5.0 to 15, 5.0 to 12.5, 5.0 to 10, 5.5 to 20, 5.5 to 15, 5.5 to 12.5, 5.5 to 10, 6.0 to 20, 6.0 to 15, 6.0 to 12.5, 6.0 to 10, 6.5 to 20, 6.5 to 15, 6.5 to 12.5, 6.5 to 10, 7.0 to 20, 7.0 to 15, 7.0 to 12.5, 7.0 to 10, 7.5 to 20, 7.5 to 15, 7.5 to 12.5, 7.5 to 10, 7.5 to 9, 7.5 to 8, 8.0 to 20, 8.0 to 20, 8.0 to 15, 8.0 to 12.5, 8.0 to 10, 8.5 to 20, 8.5 to 15, 8.5 to 12.5, 8.5 to 10, 9.0 to 20, 9.0 to 15, 9.0 to 12.5, 9.0 to 10, 9.5 to 20, 9.5 to 15, 9.5 to 12.5, 9.5 to 10, 10.0 to 20, 10.0 to 15, 10.0 to 12.5, 10.5 to 20, 10.5 to 15, or 10.5 to 12.5. Alternatively, X3 may be 4.0 to 18, 4.0 to 16, 4.0 to 15.5, 4.0 to 14, 4.5 to 18, 4.5 to 16, 4.5 to 15.5, 4.5 to 14, 5.0 to 18, 5.0 to 16, 5.0 to 15.5, 5.0 to 14, 5.5 to 18, 5.5 to 16, 5.5 to 15.5, 5.5 to 14, 6.0 to 18, 6.0 to 16, 6.0 to 15.5, 6.0 to 14, 6.5 to 18, 6.5 to 16, 6.5 to 15.5, 6.5 to 14, 7.0 to 18, 7.0 to 16, 7.0 to 15.5, 7.0 to 14, 7.5 to 18, 7.5 to 16, 7.5 to 15.5, 7.5 to 14, 7.5 to 9, 7.5 to 8, 8.0 to 18, 8.0 to 16, 8.0 to 15.5, 8.0 to 14, 8.5 to 18, 8.5 to 16, 8.5 to 15.5, 8.5 to 14, 9.0 to 18, 9.0 to 16, 9.0 to 15.5, 9.0 to 14, 9.5 to 18, 9.5 to 16, 9.5 to 15.5, 9.5 to 14, 10.0 to 18, 10.0 to 16, 10.0 to 15.5, 10.5 to 18, 10.5 to 16, or 10.5 to 15.5.

In a certain embodiment, the tea beverage of the present invention is a tea beverage comprising:

(a) a natural sugar in an amount corresponding to a sweetness intensity X1 of 0.1 to 5;

(b) a high-intensity sweetener in an amount corresponding to a sweetness intensity X2 of 0.1 to 5; and

(c) 7 mg/100 ml or more and less than 40 mg/100 ml of sodium; and

(d) 0.1 to 52 mg/100 ml of potassium and/or 0.1 to 52 mg/100 ml of calcium,

wherein sweetness of a sweetness intensity X3 of 5.5 to 12.5 is exhibited by the components (a) to (d).

In another embodiment, the tea beverage of the present invention is a tea beverage comprising:

(a) a natural sugar in an amount corresponding to a sweetness intensity X1 of 3 to 5;

(b) a high-intensity sweetener in an amount corresponding to a sweetness intensity X2 of 1 to 5; and

(c) 17 mg/100 ml or more and less than 40 mg/100 ml of sodium; and

(d) 0.1 to 32 mg/100 ml of potassium and/or 0.1 to 32 mg/100 ml of calcium,

wherein sweetness of a sweetness intensity X3 of 5.5 to 12.5 is exhibited by the components (a) to (d). Preferably, in the tea beverage of the present invention further has an energy of 50 Kcal/100 ml or less, and X1+X2 is 6.0 or more.

In the tea beverage of the present invention, the sweetness intensity X1 of the natural sugar, the sweetness intensity X2 of the high-intensity sweetener, the sodium content, the content of potassium and/or calcium, the sweetness intensity X3 exhibited by the tea beverage, and the energy of the tea beverage may be any values as long as 0.1<(X1+X2)≤20 is satisfied. For example, it is also possible to combine any of the numerical values of the following sweetness intensity X1, sweetness intensity X2, the sodium content, the content of potassium and/or calcium, sweetness intensity X3, and energy.

“The sweetness intensity X1”: 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.5 to 2.0, 1.5 to 2.5, 1.5 to 3.0, 1.5 to 3.5, 1.5 to 4.0, 1.5 to 4.5, 1.5 to 5.0, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 3.0 to 3.5, 3.0 to 4.0, 3.0 to 4.5, or 3.0 to 5.0.

“The sweetness intensity X2”: 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.5 to 2.0, 1.5 to 2.5, 1.5 to 3.0, 1.5 to 3.5, 1.5 to 4.0, 1.5 to 4.5, 1.5 to 5.0, 2.0 to 2.5, 2.0 to 3.0, 2.0 to 3.5, 2.0 to 4.0, 2.0 to 4.5, 2.0 to 5.0, 2.5 to 3.0, 2.5 to 3.5, 2.5 to 4.0, 2.5 to 4.5, 2.5 to 5.0, 3.0 to 3.5, 3.0 to 4.0, 3.0 to 4.5, or 3.0 to 5.0.

“The amount of sodium”: 7 to 40 mg/100 ml, 7 mg/100 ml or more and less than 40 mg/100 ml, 7 to 35 mg/100 ml, 7 to 30 mg/100 ml, 7 to 25 mg/100 ml, 7 to 20 mg/100 ml, 7 to 19 mg/100 ml, 7 to 18 mg/100 ml, 7 to 17 mg/100 ml, 7 to 16 mg/100 ml, 7 to 15 mg/100 ml, 7 to 14 mg/100 ml, 7 to 13 mg/100 ml, 7 to 12 mg/100 ml, 7 to 11 mg/100 ml, 7 to 10 mg/100 ml, 10 to 40 mg/100 ml, 10 to 35 mg/100 ml, 10 to 30 mg/100 ml, 10 to 25 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 to 40 mg/100 ml, 15 to 35 mg/100 ml, 15 to 30 mg/100 ml, 15 to 25 mg/100 ml, 15 to 20 mg/100 ml, 17 to 40 mg/100 ml, 17 mg/100 ml or more and less than 40 mg/100 ml, 17 to 35 mg/100 ml, 17 to 30 mg/100 ml, 17 to 25 mg/100 ml, or 17 to 20 mg/100 ml.

“The amount of potassium”: 0.1 to 52 mg/100 ml, 0.1 to 50 mg/100 ml, 0.1 to 45 mg/100 ml, 0.1 to 40 mg/100 ml, 0.1 to 35 mg/100 ml, 0.1 to 32 mg/100 ml, 0.1 to 30 mg/100 ml, 0.1 to 25 mg/100 ml, 0.1 to 21 mg/100 ml, 0.1 to 20 mg/100 ml, 0.1 to 15 mg/100 ml, 0.1 to 10 mg/100 ml, 0.1 to 5 mg/100 ml, 0.5 to 52 mg/100 ml, 0.5 to 50 mg/100 ml, 0.5 to 45 mg/100 ml, 0.5 to 40 mg/100 ml, 0.5 to 35 mg/100 ml, 0.5 to 30 mg/100 ml, 0.5 to 25 mg/100 ml, 0.5 to 21 mg/100 ml, 0.5 to 20 mg/100 ml, 0.5 to 15 mg/100 ml, 0.5 to 10 mg/100 ml, 0.5 to 5 mg/100 ml, 1 to 52 mg/100 ml, 1 to 50 mg/100 ml, 1 to 45 mg/100 ml, 1 to 40 mg/100 ml, 1 to 35 mg/100 ml, 1 to 32 mg/100 ml, 1 to 30 mg/100 ml, 1 to 25 mg/100 ml, 1 to 21 mg/100 ml, 1 to 20 mg/100 ml, 1 to 15 mg/100 ml, 1 to 10 mg/100 ml, 1 to 5 mg/100 ml, 5 to 52 mg/100 ml, 5 to 50 mg/100 ml, 5 to 45 mg/100 ml, 5 to 40 mg/100 ml, 5 to 35 mg/100 ml, 5 to 32 mg/100 ml, 5 to 30 mg/100 ml, 5 to 25 mg/100 ml, 5 to 21 mg/100 ml, 5 to 20 mg/100 ml, 5 to 15 mg/100 ml, 5 to 10 mg/100 ml, 5 to 5 mg/100 ml, 10 to 52 mg/100 ml, 10 to 50 mg/100 ml, 10 to 45 mg/100 ml, 10 to 40 mg/100 ml, 10 to 35 mg/100 ml, 10 to 32 mg/100 ml, 10 to 30 mg/100 ml, 10 to 25 mg/100 ml, 10 to 21 mg/100 ml, 10 to 20 mg/100 ml, 10 to 15 mg/100 ml, 12 to 52 mg/120 ml, 12 to 50 mg/120 ml, 12 to 45 mg/120 ml, 12 to 40 mg/120 ml, 12 to 32 mg/100 ml, 12 to 35 mg/120 ml, 12 to 30 mg/120 ml, 12 to 25 mg/120 ml, 12 to 21 mg/100 ml, 12 to 20 mg/120 ml, 12 to 15 mg/120 ml, 15 to 52 mg/100 ml, 15 to 50 mg/100 ml, 15 to 45 mg/100 ml, 15 to 40 mg/100 ml, 15 to 35 mg/100 ml, 15 to 32 mg/100 ml, 15 to 30 mg/100 ml, 15 to 25 mg/100 ml, 15 to 21 mg/100 ml, 15 to 20 mg/100 ml, 20 to 52 mg/100 ml, 20 to 50 mg/100 ml, 20 to 45 mg/100 ml, 20 to 40 mg/100 ml, 20 to 35 mg/100 ml, 20 to 32 mg/100 ml, 20 to 30 mg/100 ml, or 20 to 25 mg/100 ml.

“The amount of calcium”: 0.1 to 52 mg/100 ml, 0.1 to 50 mg/100 ml, 0.1 to 45 mg/100 ml, 0.1 to 40 mg/100 ml, 0.1 to 35 mg/100 ml, 0.1 to 32 mg/100 ml, 0.1 to 30 mg/100 ml, 0.1 to 25 mg/100 ml, 0.1 to 22 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 to 50 mg/100 ml, 1 to 45 mg/100 ml, 1 to 40 mg/100 ml, 1 to 35 mg/100 ml, 1 to 32 mg/100 ml, 1 to 30 mg/100 ml, 1 to 25 mg/100 ml, 1 to 22 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 5 to 50 mg/100 ml, 5 to 45 mg/100 ml, 5 to 40 mg/100 ml, 5 to 35 mg/100 ml, 5 to 32 mg/100 ml, 5 to 30 mg/100 ml, 5 to 25 mg/100 ml, 5 to 22 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 10 to 50 mg/100 ml, 10 to 45 mg/100 ml, 10 to 40 mg/100 ml, 10 to 35 mg/100 ml, 10 to 32 mg/100 ml, 10 to 30 mg/100 ml, 10 to 25 mg/100 ml, 10 to 22 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 12 to 52 mg/120 ml, 12 to 50 mg/120 ml, 12 to 45 mg/120 ml, 12 to 40 mg/120 ml, 12 to 35 mg/120 ml, 12 to 32 mg/100 ml, 12 to 30 mg/120 ml, 12 to 25 mg/120 ml, 12 to 22 mg/100 ml, 12 to 20 mg/120 ml, 12 to 15 mg/120 ml, 15 to 50 mg/100 ml, 15 to 45 mg/100 ml, 15 to 40 mg/100 ml, 15 to 35 mg/100 ml, 15 to 32 mg/100 ml, 15 to 30 mg/100 ml, 15 to 25 mg/100 ml, 15 to 22 mg/100 ml, 15 to 20 mg/100 ml, 20 to 50 mg/100 ml, 20 to 45 mg/100 ml, 20 to 40 mg/100 ml, 20 to 35 mg/100 ml, 20 to 32 mg/100 ml, 20 to 30 mg/100 ml, 20 to 25 mg/100 ml, 25 to 50 mg/100 ml, 25 to 45 mg/100 ml, 25 to 40 mg/100 ml, 25 to 35 mg/100 ml, 25 to 32 mg/100 ml, or 25 to 30 mg/100 ml.

“The sweetness intensity X3”: 4.0 to 20, 4.0 to 15, 4.0 to 12.5, 4.0 to 10, 4.5 to 20, 4.5 to 15, 4.5 to 12.5, 4.5 to 10, 5.0 to 20, 5.0 to 15, 5.0 to 12.5, 5.0 to 10, 5.5 to 20, 5.5 to 15, 5.5 to 12.5, 5.5 to 10, 6.0 to 20, 6.0 to 15, 6.0 to 12.5, 6.0 to 10, 6.5 to 20, 6.5 to 15, 6.5 to 12.5, 6.5 to 10, 7.0 to 20, 7.0 to 15, 7.0 to 12.5, 7.0 to 10, 7.5 to 20, 7.5 to 15, 7.5 to 12.5, 7.5 to 10, 7.5 to 9, 7.5 to 8, 8.0 to 20, 8.0 to 20, 8.0 to 15, 8.0 to 12.5, 8.0 to 10, 8.5 to 20, 8.5 to 15, 8.5 to 12.5, 8.5 to 10, 9.0 to 20, 9.0 to 15, 9.0 to 12.5, 9.0 to 10, 9.5 to 20, 9.5 to 15, 9.5 to 12.5, 9.5 to 10, 10.0 to 20, 10.0 to 15, 10.0 to 12.5, 10.5 to 20, 10.5 to 15, or 10.5 to 12.5.

The energy: 0 to 50 Kcal/100 ml, 0 to 45 Kcal/100 ml, 0 to 40 Kcal/100 ml, 0 to 35 Kcal/100 ml, 0 to 30 Kcal/100 ml, 0 to 25 Kcal/100 ml, 0 to 20 Kcal/100 ml, 0 to 15 Kcal/100 ml, 0 to 10 Kcal/100 ml, 0 to 5 Kcal/100 ml, 5 to 50 Kcal/100 ml, 5 to 45 Kcal/100 ml, 5 to 40 Kcal/100 ml, 5 to 35 Kcal/100 ml, 5 to 30 Kcal/100 ml, 5 to 25 Kcal/100 ml, 5 to 20 Kcal/100 ml, 5 to 15 Kcal/100 ml, 5 to 10 Kcal/100 ml, 10 to 50 Kcal/100 ml, 10 to 45 Kcal/100 ml, 10 to 40 Kcal/100 ml, 10 to 35 Kcal/100 ml, 10 to 30 Kcal/100 ml, 10 to 25 Kcal/100 ml, 10 to 20 Kcal/100 ml, 10 to 15 Kcal/100 ml, 15 to 50 Kcal/100 ml, 15 to 45 Kcal/100 ml, 15 to 40 Kcal/100 ml, 15 to 35 Kcal/100 ml, 15 to 30 Kcal/100 ml, 15 to 25 Kcal/100 ml, 15 to 20 Kcal/100 ml, 20 to 50 Kcal/100 ml, 20 to 45 Kcal/100 ml, 20 to 40 Kcal/100 ml, 20 to 35 Kcal/100 ml, 20 to 30 Kcal/100 ml, 20 to 25 Kcal/100 ml, 25 to 50 Kcal/100 ml, 25 to 45 Kcal/100 ml, 25 to 40 Kcal/100 ml, 25 to 35 Kcal/100 ml, or 25 to 30 Kcal/100 ml.

In addition, in the tea beverage of the present invention, the sweetness intensity X1 of the natural sugar, the sweetness intensity X2 of the high-intensity sweetener, the sodium content, the content of potassium and/or calcium, the sweetness intensity X3 exhibited by the tea beverage, and the energy of the tea beverage are not limited to combinations of the above-mentioned numerical values, and any of the numerical values of the sweetness intensity X1, the sweetness intensity X2, the sodium content, the content of potassium and/or calcium, the sweetness intensity X3, and the energy described in the present specification can be combined within a range that satisfies 0.1<(X1+X2)≤20.

The tea beverage of the present invention can appropriately contain, for example, an antioxidant (e.g., sodium erythorbate), an emulsifier (e.g., sucrose esters of fatty acids, sorbitan esters of fatty acids, and polyglycerin esters of fatty acids), and a flavoring agent (e.g., a tea flavoring agent) as long as the effects of the present invention are not impaired.

In a specific aspect, the present invention provides the following tea beverage (hereinafter, referred to as “the tea beverage A of the present invention”).

A tea beverage comprising:
(a) a natural sugar in an amount corresponding to a sweetness intensity X1;
(b) a high-intensity sweetener selected from the group consisting of rebaudioside M, rebaudioside D, and a combination thereof in an amount corresponding to a sweetness intensity X2;
(c) 17 mg/100 ml or more and less than 40 mg/100 ml of sodium; and
(d) 10 to 21 mg/100 ml of potassium and/or 10 to 22 mg/100 ml of calcium,

wherein sweetness of a sweetness intensity X3 is exhibited by the components (a) to (d), and 0.1<(X1+X2)≤20 is satisfied.

In the tea beverage A of the present invention, the preferable ranges of the sweetness intensity X1, the sweetness intensity X2, the sodium content, the content of potassium and/or calcium, the sweetness intensity X3, the concentration P2 of the high-intensity sweetener, and the energy are, for example, as follows. These numerical values can be arbitrarily combined within a range of satisfying 0.1<(X1+X2)≤20.

“The sweetness intensity X1”: 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.05 to 6.0, 0.05 to 6.5, 0.05 to 7.0, 0.05 to 7.5, 0.05 to 8.0, 0.05 to 8.25, 0.05 to 8.5, 0.05 to 8.75, 0.05 to 9.0, 0.05 to 9.25, 0.05 to 9.5, 0.05 to 9.75, 0.05 to 10.0, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 5.9, 0.1 to 6.0, 0.1 to 6.5, 0.1 to 7.0, 0.1 to 7.5, 0.1 to 8.0, 0.1 to 8.25, 0.1 to 8.5, 0.1 to 8.75, 0.1 to 9.0, 0.1 to 9.25, 0.1 to 9.5, 0.1 to 9.75, 0.1 to 10.0, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 0.5 to 6.0, 0.5 to 6.5, 0.5 to 7.0, 0.5 to 7.5, 0.5 to 8.0, 0.5 to 8.25, 0.5 to 8.5, 0.5 to 8.75, 0.5 to 9.0, 0.5 to 9.25, 0.5 to 9.5, 0.5 to 9.75, 0.5 to 10.0, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.25, 1.0 to 8.5, 1.0 to 8.75, 1.0 to 9.0, 1.0 to 9.25, 1.0 to 9.5, 1.0 to 9.75, 1.0 to 10.0, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 1.5 to 6.0, 1.5 to 6.5, 1.5 to 7.0, 1.5 to 7.5, 1.5 to 8.0, 1.5 to 8.25, 1.5 to 8.5, 1.5 to 8.75, 1.5 to 9.0, 1.5 to 9.25, 1.5 to 9.5, 1.5 to 9.75, 1.5 to 10.0, 2.0 to 2.5, 2.0 to 3.0, 2.0 to 3.5, 2.0 to 4.0, 2.0 to 4.5, 2.0 to 5.0, 2.0 to 5.5, 2.0 to 6.0, 2.0 to 6.5, 2.0 to 7.0, 2.0 to 7.5, 2.0 to 8.0, 2.0 to 8.25, 2.0 to 8.5, 2.0 to 8.75, 2.0 to 9.0, 2.0 to 9.25, 2.0 to 9.5, 2.0 to 9.75, 2.0 to 10.0, 2.5 to 3.0, 2.5 to 3.5, 2.5 to 4.0, 2.5 to 4.5, 2.5 to 5.0, 2.5 to 5.5, 2.5 to 6.0, 2.5 to 6.5, 2.5 to 7.0, 2.5 to 7.5, 2.5 to 8.0, 2.5 to 8.25, 2.5 to 8.5, 2.5 to 8.75, 2.5 to 9.0, 2.5 to 9.25, 2.5 to 9.5, 2.5 to 9.75, or 2.5 to 10.0. More preferably, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, or 3.0 to 5.5.

“The sweetness intensity X2”: 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, 3.0 to 5.5, 2.0 to 6.5, 2.0 to 7.0, 2.0 to 7.5, 2.0 to 6.0, 2.5 to 7.0, 2.5 to 7.5, 2.5 to 6.0, 2.5 to 6.5, 3.0 to 6.0, 3.0 to 6.5, 3.0 to 7.0, 3.0 to 7.5, 3.0 to 8.0, 3.0 to 8.5, 3.0 to 9.0, 3.0 to 9.5, 3.5 to 7.0, 3.5 to 7.5, 3.5 to 8.0, 4.5 to 8.5, 3.5 to 9.0, 3.5 to 9.5, 4.0 to 7.5, 4.0 to 8.0, 4.0 to 8.5, 4.0 to 9.0, 4.0 to 9.5, 3.5 to 8.5, 3.5 to 10.0, 3.5 to 10.5, 3.5 to 11.0, 3.5 to 11.5, 4.0 to 11.5, 0.05 to 6.0, 0.05 to 6.5, 0.05 to 7.0, 0.05 to 7.5, 0.05 to 8.0, 0.05 to 8.5, 0.05 to 9.0, 0.05 to 9.5, 0.05 to 10.0, 0.05 to 10.5, 0.05 to 11.0, 0.05 to 11.5, 0.5 to 6.0, 0.5 to 6.5, 0.5 to 7.0, 0.5 to 7.5, 0.5 to 8.0, 0.5 to 8.5, 0.5 to 9.0, 0.5 to 9.5, 0.5 to 10.0, 0.5 to 10.5, 0.5 to 11.0, 0.5 to 11.5, 1.0 to 6.0, 1.0 to 6.5, 1.0 to 7.0, 1.0 to 7.5, 1.0 to 8.0, 1.0 to 8.5, 1.0 to 9.0, 1.0 to 9.5, 1.0 to 10.0, 1.0 to 10.5, 1.0 to 11.0, 1.0 to 11.5, 1.5 to 6.0, 1.5 to 6.5, 1.5 to 7.0, 1.5 to 7.5, 1.5 to 8.0, 1.5 to 8.5, 1.5 to 9.0, 1.5 to 9.5, 1.5 to 10.0, 1.5 to 10.5, 1.5 to 11.0, 1.5 to 11.5, 2.0 to 8.0, 2.0 to 8.5, 2.0 to 9.0, 2.0 to 9.5, 2.0 to 10.0, 2.0 to 10.5, 2.0 to 11.0, 2.0 to 11.5, 2.5 to 8.0, 2.5 to 8.5, 2.5 to 9.0, 2.5 to 9.5, 2.5 to 10.0, 2.5 to 10.5, 2.5 to 11.0, 2.5 to 11.5, 3.0 to 10.0, 3.0 to 10.5, 3.0 to 11.0, 3.0 to 11.5, 3.5 to 4.0, 3.5 to 4.5, 3.5 to 5.0, 3.5 to 5.5, 3.5 to 6.0, 3.5 to 6.5, 4.0 to 4.5, 4.0 to 5.0, 4.0 to 5.5, 4.0 to 6.0, 4.0 to 6.5, 4.0 to 7.0, 4.0 to 10.0, 4.0 to 10.5, or 4.0 to 11.0. More preferably, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, or 3.0 to 5.5.

“The amount of sodium”: 17 to 40 mg/100 ml, 17 mg/100 ml or more and less than 40 mg/100 ml, 17 to 35 mg/100 ml, 17 to 30 mg/100 ml, 17 to 25 mg/100 ml, 17 to 20 mg/100 ml, 22 to 40 mg/100 ml, 22 to 35 mg/100 ml, 22 to 30 mg/100 ml, 22 to 25 mg/100 ml, 27 to 40 mg/100 ml, 27 to 35 mg/100 ml, or 27 to 30 mg/100 ml.

“The amount of potassium”: 10 to 21 mg/100 ml, 10 to 20 mg/100 ml, 10 to 15 mg/100 ml, 12 to 21 mg/100 ml, 12 to 20 mg/120 ml, 12 to 15 mg/120 ml, 15 to 21 mg/100 ml, or 15 to 20 mg/100 ml.

“The amount of calcium”: 10 to 22 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 to 22 mg/100 ml, 15 to 20 mg/100 ml, 20 to 25 mg/100 ml, or 20 to 22 mg/100 ml.

“The sweetness intensity X3”: 4.0 to 20, 4.0 to 15, 4.0 to 12.5, 4.0 to 10, 4.5 to 20, 4.5 to 15, 4.5 to 12.5, 4.5 to 10, 5.0 to 20, 5.0 to 15, 5.0 to 12.5, 5.0 to 10, 5.5 to 20, 5.5 to 15, 5.5 to 12.5, 5.5 to 10, 6.0 to 20, 6.0 to 15, 6.0 to 12.5, 6.0 to 10, 6.5 to 20, 6.5 to 15, 6.5 to 12.5, 6.5 to 10, 7.0 to 20, 7.0 to 15, 7.0 to 12.5, 7.0 to 10, 7.5 to 20, 7.5 to 15, 7.5 to 12.5, 7.5 to 10, 7.5 to 9, 7.5 to 8, 8.0 to 20, 8.0 to 20, 8.0 to 15, 8.0 to 12.5, 8.0 to 10, 8.5 to 20, 8.5 to 15, 8.5 to 12.5, 8.5 to 10, 9.0 to 20, 9.0 to 15, 9.0 to 12.5, 9.0 to 10, 9.5 to 20, 9.5 to 15, 9.5 to 12.5, 9.5 to 10, 10.0 to 20, 10.0 to 15, 10.0 to 12.5, 10.5 to 20, 10.5 to 15, or 10.5 to 12.5.

“The amount of a high intensity sweetener P2 (ppm)”: 20 to 550, 25 to 550, 30 to 550, 35 to 550, 40 to 550, 45 to 550, 50 to 550, 55 to 550, 20 to 540, 25 to 540, 30 to 540, 35 to 540, 40 to 540, 45 to 540, 50 to 540, 55 to 540, 20 to 530, 25 to 530, 30 to 530, 35 to 530, 40 to 530, 45 to 530, 50 to 530, 55 to 530, 20 to 520, 25 to 520, 30 to 520, 35 to 520, 40 to 520, 45 to 520, 50 to 520, 55 to 520, 20 to 510, 25 to 510, 30 to 510, 35 to 510, 40 to 510, 45 to 510, 50 to 510, 55 to 510, 20 to 505, 25 to 505, 30 to 505, 35 to 505, 40 to 505, 45 to 505, 50 to 505, 55 to 505, 20 to 500, 25 to 500, 30 to 500, 35 to 500, 40 to 500, 45 to 500, 50 to 500, 55 to 500, 20 to 495, 25 to 495, 30 to 495, 35 to 495, 40 to 495, 45 to 495, 50 to 495, 55 to 495, 20 to 490, 25 to 490, 30 to 490, 35 to 490, 40 to 490, 45 to 490, 50 to 490, or 55 to 490.

The energy: 0 to 25 Kcal/100 ml, 0 to 20 Kcal/100 ml, 0 to 15 Kcal/100 ml, 0 to 10 Kcal/100 ml, 0 to 5 Kcal/100 ml, 5 to 25 Kcal/100 ml, 5 to 20 Kcal/100 ml, 5 to 15 Kcal/100 ml, 5 to 10 Kcal/100 ml, 10 to 25 Kcal/100 ml, 10 to 20 Kcal/100 ml, 10 to 15 Kcal/100 ml, 15 to 25 Kcal/100 ml, 15 to 20 Kcal/100 ml, 20 to 25 Kcal/100 ml, 0 to 24 Kcal/100 ml, 0 to 8 Kcal/100 ml, 0 to 4 Kcal/100 ml, 4 to 24 Kcal/100 ml, 4 to 8 Kcal/100 ml, or 8 to 24 Kcal/100 ml.

In the tea beverage A of the present invention, the forms of the natural sugar (including examples of the combination of glucose, sucrose, fructose, maltose, oligosaccharide, high-fructose corn syrup, or lactose), sodium, potassium, and calcium are defined as described in the section for the tea beverage of the present invention.

In another specific aspect, the present invention provides the following tea beverage (hereinafter, referred to as “the tea beverage B of the present invention”).

A tea beverage comprising:
(a) a natural sugar in an amount corresponding to a sweetness intensity X1;
(b) a Luo han guo extract in an amount corresponding to a sweetness intensity X2;
(c) 17 mg/100 ml or more and less than 40 mg/100 ml of sodium; and
(d) 10 to 21 mg/100 ml of potassium and/or 10 to 22 mg/100 ml of calcium,

wherein sweetness of a sweetness intensity X3 is exhibited by the components (a) to (d), and 0.1<(X1+X2)≤20 is satisfied.

In the tea beverage B of the present invention, preferable ranges of the sweetness intensity X1, the sweetness intensity X2, the sodium content, the content of potassium and/or calcium, the sweetness intensity X3, the content P2 of the Luo han guo extract, and the energy are, for example, as follows. These numerical values can be arbitrarily combined within a range of satisfying 0.1<(X1+X2)≤20.

“The sweetness intensity X1”: 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.05 to 6.0, 0.05 to 6.5, 0.05 to 7.0, 0.05 to 7.5, 0.05 to 8.0, 0.05 to 8.25, 0.05 to 8.5, 0.05 to 8.75, 0.05 to 9.0, 0.05 to 9.25, 0.05 to 9.5, 0.05 to 9.75, 0.05 to 10.0, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 5.9, 0.1 to 6.0, 0.1 to 6.5, 0.1 to 7.0, 0.1 to 7.5, 0.1 to 8.0, 0.1 to 8.25, 0.1 to 8.5, 0.1 to 8.75, 0.1 to 9.0, 0.1 to 9.25, 0.1 to 9.5, 0.1 to 9.75, 0.1 to 10.0, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 0.5 to 6.0, 0.5 to 6.5, 0.5 to 7.0, 0.5 to 7.5, 0.5 to 8.0, 0.5 to 8.25, 0.5 to 8.5, 0.5 to 8.75, 0.5 to 9.0, 0.5 to 9.25, 0.5 to 9.5, 0.5 to 9.75, 0.5 to 10.0, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.25, 1.0 to 8.5, 1.0 to 8.75, 1.0 to 9.0, 1.0 to 9.25, 1.0 to 9.5, 1.0 to 9.75, 1.0 to 10.0, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 1.5 to 6.0, 1.5 to 6.5, 1.5 to 7.0, 1.5 to 7.5, 1.5 to 8.0, 1.5 to 8.25, 1.5 to 8.5, 1.5 to 8.75, 1.5 to 9.0, 1.5 to 9.25, 1.5 to 9.5, 1.5 to 9.75, 1.5 to 10.0, 2.0 to 2.5, 2.0 to 3.0, 2.0 to 3.5, 2.0 to 4.0, 2.0 to 4.5, 2.0 to 5.0, 2.0 to 5.5, 2.0 to 6.0, 2.0 to 6.5, 2.0 to 7.0, 2.0 to 7.5, 2.0 to 8.0, 2.0 to 8.25, 2.0 to 8.5, 2.0 to 8.75, 2.0 to 9.0, 2.0 to 9.25, 2.0 to 9.5, 2.0 to 9.75, 2.0 to 10.0, 2.5 to 3.0, 2.5 to 3.5, 2.5 to 4.0, 2.5 to 4.5, 2.5 to 5.0, 2.5 to 5.5, 2.5 to 6.0, 2.5 to 6.5, 2.5 to 7.0, 2.5 to 7.5, 2.5 to 8.0, 2.5 to 8.25, 2.5 to 8.5, 2.5 to 8.75, 2.5 to 9.0, 2.5 to 9.25, 2.5 to 9.5, 2.5 to 9.75, 2.5 to 10.0, 0 to 10.5, 0 to 11.0, 0 to 11.5, 0 to 12.0, 0 to 12.5, 0 to 13.0, 0 to 13.5, 0 to 14.0, 0 to 14.5, 0 to 15.0, 0.05 to 10.5, 0.05 to 11.0, 0.05 to 11.5, 0.05 to 12.0, 0.05 to 12.5, 0.05 to 13.0, 0.05 to 13.5, 0.05 to 14.0, 0.05 to 14.5, 0.05 to 15.0, 0.1 to 10.5, 0.1 to 11.0, 0.1 to 11.5, 0.1 to 12.0, 0.1 to 12.5, 0.1 to 13.0, 0.1 to 13.5, 0.1 to 14.0, 0.1 to 14.5, 0.1 to 15.0, 0.5 to 10.5, 0.5 to 11.0, 0.5 to 11.5, 0.5 to 12.0, 0.5 to 12.5, 0.5 to 13.0, 0.5 to 13.5, 0.5 to 14.0, 0.5 to 14.5, 0.5 to 15.0, 1.0 to 10.5, 1.0 to 11.0, 1.0 to 11.5, 1.0 to 12.0, 1.0 to 12.5, 1.0 to 13.0, 1.0 to 13.5, 1.0 to 14.0, 1.0 to 14.5, 1.0 to 15.0, 1.5 to 10.5, 1.5 to 11.0, 1.5 to 11.5, 1.5 to 12.0, 1.5 to 12.5, 1.5 to 13.0, 1.5 to 13.5, 1.5 to 14.0, 1.5 to 14.5, 1.5 to 15.0, 2.0 to 10.5, 2.0 to 11.0, 2.0 to 11.5, 2.0 to 12.0, 2.0 to 12.5, 2.0 to 13.0, 2.0 to 13.5, 2.0 to 14.0, 2.0 to 14.5, 2.0 to 15.0, 2.5 to 10.5, 2.5 to 11.0, 2.5 to 11.5, 2.5 to 12.0, 2.5 to 12.5, 2.5 to 13.0, 2.5 to 13.5, 2.5 to 14.0, 2.5 to 14.5, or 2.5 to 15.0. More preferably, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 5.9, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, or 3.0 to 5.5.

“The sweetness intensity X2”: 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, 3.0 to 5.5, 2.0 to 6.5, 2.0 to 7.0, 2.0 to 7.5, 2.0 to 6.0, 2.0 to 6.5, 2.0 to 7.0, 2.0 to 7.5, 2.5 to 7.0, 2.5 to 7.5, 2.5 to 6.0, 2.5 to 6.5, 2.5 to 7.0, 2.5 to 7.5, 3.0 to 7.5, 3.0 to 6.0, 3.0 to 6.5, 3.0 to 7.0, 3.0 to 7.5, 3.0 to 8.0, 3.0 to 8.5, 3.0 to 9.0, 3.0 to 9.5, 3.5 to 7.0, 3.5 to 7.5, 3.5 to 8.0, 4.5 to 8.5, 3.5 to 9.0, 3.5 to 9.5, 4.0 to 7.5, 4.0 to 8.0, 4.0 to 8.5, 4.0 to 9.0, 4.0 to 9.5, 3.5 to 8.5, 3.5 to 9.0, 3.5 to 9.5, 3.5 to 10.0, 3.5 to 10.5, 3.5 to 11.0, 3.5 to 11.5, 4.0 to 11.5, 0.05 to 6.0, 0.05 to 6.5, 0.05 to 7.0, 0.05 to 7.5, 0.05 to 8.0, 0.05 to 8.5, 0.05 to 9.0, 0.05 to 9.5, 0.05 to 10.0, 0.05 to 10.5, 0.05 to 11.0, 0.05 to 11.5, 0.05 to 12.0, 0.05 to 13.0, 0.05 to 14.0, 0.05 to 15.0, 0.05 to 16.0, 0.05 to 17.0, 0.05 to 18.0, 0.5 to 6.0, 0.5 to 6.5, 0.5 to 7.0, 0.5 to 7.5, 0.5 to 8.0, 0.5 to 8.5, 0.5 to 9.0, 0.5 to 9.5, 0.5 to 10.0, 0.5 to 10.5, 0.5 to 11.0, 0.5 to 11.5, 0.5 to 12.0, 0.5 to 13.0, 0.5 to 14.0, 0.5 to 15.0, 0.5 to 16.0, 0.5 to 17.0, 0.5 to 18.0, 1.0 to 6.0, 1.0 to 6.5, 1.0 to 7.0, 1.0 to 7.5, 1.0 to 8.0, 1.0 to 8.5, 1.0 to 9.0, 1.0 to 9.5, 1.0 to 10.0, 1.0 to 10.5, 1.0 to 11.0, 1.0 to 11.5, 1.0 to 12.0, 1.0 to 13.0, 1.0 to 14.0, 1.0 to 15.0, 1.0 to 16.0, 1.0 to 17.0, 1.0 to 18.0, 1.5 to 6.0, 1.5 to 6.5, 1.5 to 7.0, 1.5 to 7.5, 1.5 to 8.0, 1.5 to 8.5, 1.5 to 9.0, 1.5 to 9.5, 1.5 to 10.0, 1.5 to 10.5, 1.5 to 11.0, 1.5 to 11.5, 1.5 to 12.0, 1.5 to 13.0, 1.5 to 14.0, 1.5 to 15.0, 1.5 to 16.0, 1.5 to 17.0, 1.5 to 18.0, 2.0 to 8.0, 2.0 to 8.5, 2.0 to 9.0, 2.0 to 9.5, 2.0 to 10.0, 2.0 to 10.5, 2.0 to 11.0, 2.0 to 11.5, 2.0 to 12.0, 2.0 to 13.0, 2.0 to 14.0, 2.0 to 15.0, 2.0 to 16.0, 2.0 to 17.0, 2.0 to 18.0, 2.5 to 8.0, 2.5 to 8.5, 2.5 to 9.0, 2.5 to 9.5, 2.5 to 10.0, 2.5 to 10.5, 2.5 to 11.0, 2.5 to 11.5, 2.5 to 12.0, 2.5 to 13.0, 2.5 to 14.0, 2.5 to 15.0, 2.5 to 16.0, 2.5 to 17.0, 2.5 to 18.0, 3.0 to 10.0, 3.0 to 10.5, 3.0 to 11.0, 3.0 to 11.5, 3.0 to 12.0, 3.0 to 13.0, 3.0 to 14.0, 3.0 to 15.0, 3.0 to 16.0, 3.0 to 17.0, 3.0 to 18.0, 3.5 to 4.0, 3.5 to 4.5, 3.5 to 5.0, 3.5 to 5.5, 3.5 to 6.0, 3.5 to 6.5, 3.5 to 12.0, 3.5 to 13.0, 3.5 to 14.0, 3.5 to 15.0, 3.5 to 16.0, 3.5 to 17.0, 3.5 to 18.0, 4.0 to 4.5, 4.0 to 5.0, 4.0 to 5.5, 4.0 to 6.0, 4.0 to 6.5, 4.0 to 7.0, 4.0 to 10.0, 4.0 to 10.5, 4.0 to 11.0, 4.0 to 12.0, 4.0 to 13.0, 4.0 to 14.0, 4.0 to 15.0, 4.0 to 16.0, 4.0 to 17.0, or 4.0 to 18.0. More preferably, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, or 3.0 to 5.5.

“The amount of sodium”: 17 to 40 mg/100 ml, 17 mg/100 ml or more and less than 40 mg/100 ml, 17 to 35 mg/100 ml, 17 to 30 mg/100 ml, 17 to 25 mg/100 ml, 17 to 20 mg/100 ml, 22 to 40 mg/100 ml, 22 to 35 mg/100 ml, 22 to 30 mg/100 ml, 22 to 25 mg/100 ml, 27 to 40 mg/100 ml, 27 to 35 mg/100 ml, or 27 to 30 mg/100 ml.

“The amount of potassium”: 10 to 21 mg/100 ml, 10 to 20 mg/100 ml, 10 to 15 mg/100 ml, 12 to 21 mg/100 ml, 12 to 20 mg/120 ml, 12 to 15 mg/120 ml, 15 to 21 mg/100 ml, or 15 to 20 mg/100 ml.

“The amount of calcium”: 10 to 22 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 to 22 mg/100 ml, 15 to 20 mg/100 ml, 20 to 25 mg/100 ml, or 20 to 22 mg/100 ml.

“The sweetness intensity X3”: 4.0 to 20, 4.0 to 15, 4.0 to 12.5, 4.0 to 10, 4.5 to 20, 4.5 to 15, 4.5 to 12.5, 4.5 to 10, 5.0 to 20, 5.0 to 15, 5.0 to 12.5, 5.0 to 10, 5.5 to 20, 5.5 to 15, 5.5 to 12.5, 5.5 to 10, 6.0 to 20, 6.0 to 15, 6.0 to 12.5, 6.0 to 10, 6.5 to 20, 6.5 to 15, 6.5 to 12.5, 6.5 to 10, 7.0 to 20, 7.0 to 15, 7.0 to 12.5, 7.0 to 10, 7.5 to 20, 7.5 to 15, 7.5 to 12.5, 7.5 to 10, 7.5 to 9, 7.5 to 8, 8.0 to 20, 8.0 to 20, 8.0 to 15, 8.0 to 12.5, 8.0 to 10, 8.5 to 20, 8.5 to 15, 8.5 to 12.5, 8.5 to 10, 9.0 to 20, 9.0 to 15, 9.0 to 12.5, 9.0 to 10, 9.5 to 20, 9.5 to 15, 9.5 to 12.5, 9.5 to 10, 10.0 to 20, 10.0 to 15, 10.0 to 12.5, 10.5 to 20, 10.5 to 15, 10.5 to 12.5, 4.0 to 18, 4.0 to 16, 4.0 to 15.5, 4.0 to 14, 4.5 to 18, 4.5 to 16, 4.5 to 15.5, 4.5 to 14, 5.0 to 18, 5.0 to 16, 5.0 to 15.5, 5.0 to 14, 5.5 to 18, 5.5 to 16, 5.5 to 15.5, 5.5 to 14, 6.0 to 18, 6.0 to 16, 6.0 to 15.5, 6.0 to 14, 6.5 to 18, 6.5 to 16, 6.5 to 15.5, 6.5 to 14, 7.0 to 18, 7.0 to 16, 7.0 to 15.5, 7.0 to 14, 7.5 to 18, 7.5 to 16, 7.5 to 15.5, 7.5 to 14, 7.5 to 9, 7.5 to 8, 8.0 to 18, 8.0 to 18, 8.0 to 16, 8.0 to 15.5, 8.0 to 14, 8.5 to 18, 8.5 to 16, 8.5 to 15.5, 8.5 to 14, 9.0 to 18, 9.0 to 16, 9.0 to 15.5, 9.0 to 14, 9.5 to 18, 9.5 to 16, 9.5 to 15.5, 9.5 to 14, 10.0 to 18, 10.0 to 16, 10.0 to 15.5, 10.5 to 18, 10.5 to 16, or 10.5 to 15.5.

“The amount of Luo han guo extract P2 (ppm)”: 20 to 550, 25 to 550, 30 to 550, 35 to 550, 40 to 550, 45 to 550, 50 to 550, 55 to 550, 20 to 540, 25 to 540, 30 to 540, 35 to 540, 40 to 540, 45 to 540, 50 to 540, 55 to 540, 20 to 530, 25 to 530, 30 to 530, 35 to 530, 40 to 530, 45 to 530, 50 to 530, 55 to 530, 20 to 520, 25 to 520, 30 to 520, 35 to 520, 40 to 520, 45 to 520, 50 to 520, 55 to 520, 20 to 510, 25 to 510, 30 to 510, 35 to 510, 40 to 510, 45 to 510, 50 to 510, 55 to 510, 20 to 505, 25 to 505, 30 to 505, 35 to 505, 40 to 505, 45 to 505, 50 to 505, 55 to 505, 20 to 500, 25 to 500, 30 to 500, 35 to 500, 40 to 500, 45 to 500, 50 to 500, 55 to 500, 20 to 495, 25 to 495, 30 to 495, 35 to 495, 40 to 495, 45 to 495, 50 to 495, 55 to 495, 20 to 490, 25 to 490, 30 to 490, 35 to 490, 40 to 490, 45 to 490, 50 to 490, 55 to 490, 1 to 1500, 1 to 1200, 5 to 1200, 1 to 1000, 5 to 1000, 10 to 1000, 1 to 900, 5 to 900, 10 to 900, 15 to 900, 20 to 900, 25 to 900, 30 to 900, 35 to 900, 40 to 900, 45 to 900, 50 to 900, 55 to 900, 1 to 800, 5 to 800, 10 to 800, 15 to 800, 20 to 800, 25 to 800, 30 to 800, 35 to 800, 40 to 800, 45 to 800, 50 to 800, 55 to 800, 1 to 700, 5 to 700, 10 to 700, 15 to 700, 20 to 700, 25 to 700, 30 to 700, 35 to 700, 40 to 700, 45 to 700, 50 to 700, 55 to 700, 1 to 600, 5 to 600, 10 to 600, 15 to 600, 20 to 600, 25 to 600, 30 to 600, 35 to 600, 40 to 600, 45 to 600, 50 to 600, 55 to 600, 1 to 550, 1 to 540, 1 to 530, 1 to 520, 1 to 510, 1 to 505, 1 to 500, 1 to 495, 1 to 490, 5 to 550, 5 to 540, 5 to 530, 5 to 520, 5 to 510, 5 to 505, 5 to 500, 5 to 495, 5 to 490, 10 to 550, 10 to 540, 10 to 530, 10 to 520, 10 to 510, 10 to 505, 10 to 500, 10 to 495, 10 to 490, 15 to 550, 15 to 550, 15 to 530, 15 to 520, 15 to 510, 15 to 505, 15 to 500, 15 to 495, or 15 to 490.

The energy: 0 to 50 Kcal/100 ml, 0 to 45 Kcal/100 ml, 0 to 40 Kcal/100 ml, 0 to 35 Kcal/100 ml, 0 to 30 Kcal/100 ml, 0 to 25 Kcal/100 ml, 0 to 20 Kcal/100 ml, 0 to 15 Kcal/100 ml, 0 to 10 Kcal/100 ml, 0 to 5 Kcal/100 ml, 5 to 50 Kcal/100 ml, 5 to 45 Kcal/100 ml, 5 to 40 Kcal/100 ml, 5 to 35 Kcal/100 ml, 5 to 30 Kcal/100 ml, 5 to 25 Kcal/100 ml, 5 to 20 Kcal/100 ml, 5 to 15 Kcal/100 ml, 5 to 10 Kcal/100 ml, 10 to 50 Kcal/100 ml, 10 to 45 Kcal/100 ml, 10 to 40 Kcal/100 ml, 10 to 35 Kcal/100 ml, 10 to 30 Kcal/100 ml, 10 to 25 Kcal/100 ml, 10 to 20 Kcal/100 ml, 10 to 15 Kcal/100 ml, 15 to 50 Kcal/100 ml, 15 to 45 Kcal/100 ml, 15 to 40 Kcal/100 ml, 15 to 35 Kcal/100 ml, 15 to 30 Kcal/100 ml, 15 to 25 Kcal/100 ml, 15 to 20 Kcal/100 ml, 20 to 50 Kcal/100 ml, 20 to 45 Kcal/100 ml, 20 to 40 Kcal/100 ml, 20 to 35 Kcal/100 ml, 20 to 30 Kcal/100 ml, 20 to 25 Kcal/100 ml, 25 to 50 Kcal/100 ml, 25 to 45 Kcal/100 ml, 25 to 40 Kcal/100 ml, 25 to 35 Kcal/100 ml, 25 to 30 Kcal/100 ml, 0 to 32 Kcal/100 ml, 0 to 24 Kcal/100 ml, 0 to 8 Kcal/100 ml, 0 to 4 Kcal/100 ml, 4 to 32 Kcal/100 ml, 4 to 24 Kcal/100 ml, 4 to 8 Kcal/100 ml, 8 to 32 Kcal/100 ml, 8 to 24 Kcal/100 ml, or 24 to 32 Kcal/100 ml.

In addition, in the tea beverage B of the present invention, the forms of the natural sugar (including examples of the combination of glucose, sucrose, fructose, maltose, oligosaccharide, high-fructose corn syrup, or lactose), sodium, potassium, and calcium are defined as described in the section for the tea beverage of the present invention.

In another specific aspect, the present invention provides the following tea beverage (hereinafter, referred to as “the tea beverage C of the present invention”).

A tea beverage comprising:
(a) a natural sugar in an amount corresponding to a sweetness intensity X1;
(b) mogroside V in an amount corresponding to a sweetness intensity X2;
(c) 17 mg/100 ml or more and less than 40 mg/100 ml of sodium; and
(d) 10 mg/100 ml to 21 mg/100 ml of potassium and/or 10 mg/100 ml to 22 mg/100 ml of calcium,

wherein sweetness of a sweetness intensity X3 is exhibited by the components (a) to (d), and 0.1<(X1+X2)≤20 is satisfied.

In the tea beverage C of the present invention, preferable ranges of the sweetness intensity X1, the sweetness intensity X2, the sodium content, the content of potassium and/or calcium, the sweetness intensity X3, the content P2 (ppm) of mogroside V, and the energy are, for example, as follows. These numerical values can be arbitrarily combined within a range of satisfying 0.1<(X1+X2)≤20.

“The sweetness intensity X1”: 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.05 to 6.0, 0.05 to 6.5, 0.05 to 7.0, 0.05 to 7.5, 0.05 to 8.0, 0.05 to 8.25, 0.05 to 8.5, 0.05 to 8.75, 0.05 to 9.0, 0.05 to 9.25, 0.05 to 9.5, 0.05 to 9.75, 0.05 to 10.0, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 5.9, 0.1 to 6.0, 0.1 to 6.5, 0.1 to 7.0, 0.1 to 7.5, 0.1 to 8.0, 0.1 to 8.25, 0.1 to 8.5, 0.1 to 8.75, 0.1 to 9.0, 0.1 to 9.25, 0.1 to 9.5, 0.1 to 9.75, 0.1 to 10.0, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 0.5 to 6.0, 0.5 to 6.5, 0.5 to 7.0, 0.5 to 7.5, 0.5 to 8.0, 0.5 to 8.25, 0.5 to 8.5, 0.5 to 8.75, 0.5 to 9.0, 0.5 to 9.25, 0.5 to 9.5, 0.5 to 9.75, 0.5 to 10.0, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.0 to 6.0, 1.0 to 6.5, 1.0 to 7.0, 1.0 to 7.5, 1.0 to 8.0, 1.0 to 8.25, 1.0 to 8.5, 1.0 to 8.75, 1.0 to 9.0, 1.0 to 9.25, 1.0 to 9.5, 1.0 to 9.75, 1.0 to 10.0, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 1.5 to 6.0, 1.5 to 6.5, 1.5 to 7.0, 1.5 to 7.5, 1.5 to 8.0, 1.5 to 8.25, 1.5 to 8.5, 1.5 to 8.75, 1.5 to 9.0, 1.5 to 9.25, 1.5 to 9.5, 1.5 to 9.75, 1.5 to 10.0, 2.0 to 2.5, 2.0 to 3.0, 2.0 to 3.5, 2.0 to 4.0, 2.0 to 4.5, 2.0 to 5.0, 2.0 to 5.5, 2.0 to 6.0, 2.0 to 6.5, 2.0 to 7.0, 2.0 to 7.5, 2.0 to 8.0, 2.0 to 8.25, 2.0 to 8.5, 2.0 to 8.75, 2.0 to 9.0, 2.0 to 9.25, 2.0 to 9.5, 2.0 to 9.75, 2.0 to 10.0, 2.5 to 3.0, 2.5 to 3.5, 2.5 to 4.0, 2.5 to 4.5, 2.5 to 5.0, 2.5 to 5.5, 2.5 to 6.0, 2.5 to 6.5, 2.5 to 7.0, 2.5 to 7.5, 2.5 to 8.0, 2.5 to 8.25, 2.5 to 8.5, 2.5 to 8.75, 2.5 to 9.0, 2.5 to 9.25, 2.5 to 9.5, 2.5 to 9.75, 2.5 to 10.0, 0 to 10.5, 0 to 11.0, 0 to 11.5, 0 to 12.0, 0 to 12.5, 0 to 13.0, 0 to 13.5, 0 to 14.0, 0 to 14.5, 0 to 15.0, 0.05 to 10.5, 0.05 to 11.0, 0.05 to 11.5, 0.05 to 12.0, 0.05 to 12.5, 0.05 to 13.0, 0.05 to 13.5, 0.05 to 14.0, 0.05 to 14.5, 0.05 to 15.0, 0.1 to 10.5, 0.1 to 11.0, 0.1 to 11.5, 0.1 to 12.0, 0.1 to 12.5, 0.1 to 13.0, 0.1 to 13.5, 0.1 to 14.0, 0.1 to 14.5, 0.1 to 15.0, 0.5 to 10.5, 0.5 to 11.0, 0.5 to 11.5, 0.5 to 12.0, 0.5 to 12.5, 0.5 to 13.0, 0.5 to 13.5, 0.5 to 14.0, 0.5 to 14.5, 0.5 to 15.0, 1.0 to 10.5, 1.0 to 11.0, 1.0 to 11.5, 1.0 to 12.0, 1.0 to 12.5, 1.0 to 13.0, 1.0 to 13.5, 1.0 to 14.0, 1.0 to 14.5, 1.0 to 15.0, 1.5 to 10.5, 1.5 to 11.0, 1.5 to 11.5, 1.5 to 12.0, 1.5 to 12.5, 1.5 to 13.0, 1.5 to 13.5, 1.5 to 14.0, 1.5 to 14.5, 1.5 to 15.0, 2.0 to 10.5, 2.0 to 11.0, 2.0 to 11.5, 2.0 to 12.0, 2.0 to 12.5, 2.0 to 13.0, 2.0 to 13.5, 2.0 to 14.0, 2.0 to 14.5, 2.0 to 15.0, 2.5 to 10.5, 2.5 to 11.0, 2.5 to 11.5, 2.5 to 12.0, 2.5 to 12.5, 2.5 to 13.0, 2.5 to 13.5, 2.5 to 14.0, 2.5 to 14.5, or 2.5 to 15.0. More preferably, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.1 to 5.9, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, or 3.0 to 5.5.

“The sweetness intensity X2”: 0.05 to 0.5, 0.05 to 1.0, 0.05 to 1.5, 0.05 to 2.0, 0.05 to 2.5, 0.05 to 3.0, 0.05 to 3.5, 0.05 to 4.0, 0.05 to 4.5, 0.05 to 5.0, 0.05 to 5.5, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, 3.0 to 5.5, 2.0 to 6.5, 2.0 to 7.0, 2.0 to 7.5, 2.0 to 6.0, 2.0 to 6.5, 2.0 to 7.0, 2.0 to 7.5, 2.5 to 7.0, 2.5 to 7.5, 2.5 to 6.0, 2.5 to 6.5, 2.5 to 7.0, 2.5 to 7.5, 3.0 to 7.5, 3.0 to 6.0, 3.0 to 6.5, 3.0 to 7.0, 3.0 to 7.5, 3.0 to 8.0, 3.0 to 8.5, 3.0 to 9.0, 3.0 to 9.5, 3.5 to 7.0, 3.5 to 7.5, 3.5 to 8.0, 4.5 to 8.5, 3.5 to 9.0, 3.5 to 9.5, 4.0 to 7.5, 4.0 to 8.0, 4.0 to 8.5, 4.0 to 9.0, 4.0 to 9.5, 3.5 to 8.5, 3.5 to 9.0, 3.5 to 9.5, 3.5 to 10.0, 3.5 to 10.5, 3.5 to 11.0, 3.5 to 11.5, 4.0 to 11.5, 0.05 to 6.0, 0.05 to 6.5, 0.05 to 7.0, 0.05 to 7.5, 0.05 to 8.0, 0.05 to 8.5, 0.05 to 9.0, 0.05 to 9.5, 0.05 to 10.0, 0.05 to 10.5, 0.05 to 11.0, 0.05 to 11.5, 0.05 to 12.0, 0.05 to 13.0, 0.05 to 14.0, 0.05 to 15.0, 0.05 to 16.0, 0.05 to 17.0, 0.05 to 18.0, 0.5 to 6.0, 0.5 to 6.5, 0.5 to 7.0, 0.5 to 7.5, 0.5 to 8.0, 0.5 to 8.5, 0.5 to 9.0, 0.5 to 9.5, 0.5 to 10.0, 0.5 to 10.5, 0.5 to 11.0, 0.5 to 11.5, 0.5 to 12.0, 0.5 to 13.0, 0.5 to 14.0, 0.5 to 15.0, 0.5 to 16.0, 0.5 to 17.0, 0.5 to 18.0, 1.0 to 6.0, 1.0 to 6.5, 1.0 to 7.0, 1.0 to 7.5, 1.0 to 8.0, 1.0 to 8.5, 1.0 to 9.0, 1.0 to 9.5, 1.0 to 10.0, 1.0 to 10.5, 1.0 to 11.0, 1.0 to 11.5, 1.0 to 12.0, 1.0 to 13.0, 1.0 to 14.0, 1.0 to 15.0, 1.0 to 16.0, 1.0 to 17.0, 1.0 to 18.0, 1.5 to 6.0, 1.5 to 6.5, 1.5 to 7.0, 1.5 to 7.5, 1.5 to 8.0, 1.5 to 8.5, 1.5 to 9.0, 1.5 to 9.5, 1.5 to 10.0, 1.5 to 10.5, 1.5 to 11.0, 1.5 to 11.5, 1.5 to 12.0, 1.5 to 13.0, 1.5 to 14.0, 1.5 to 15.0, 1.5 to 16.0, 1.5 to 17.0, 1.5 to 18.0, 2.0 to 8.0, 2.0 to 8.5, 2.0 to 9.0, 2.0 to 9.5, 2.0 to 10.0, 2.0 to 10.5, 2.0 to 11.0, 2.0 to 11.5, 2.0 to 12.0, 2.0 to 13.0, 2.0 to 14.0, 2.0 to 15.0, 2.0 to 16.0, 2.0 to 17.0, 2.0 to 18.0, 2.5 to 8.0, 2.5 to 8.5, 2.5 to 9.0, 2.5 to 9.5, 2.5 to 10.0, 2.5 to 10.5, 2.5 to 11.0, 2.5 to 11.5, 2.5 to 12.0, 2.5 to 13.0, 2.5 to 14.0, 2.5 to 15.0, 2.5 to 16.0, 2.5 to 17.0, 2.5 to 18.0, 3.0 to 10.0, 3.0 to 10.5, 3.0 to 11.0, 3.0 to 11.5, 3.0 to 12.0, 3.0 to 13.0, 3.0 to 14.0, 3.0 to 15.0, 3.0 to 16.0, 3.0 to 17.0, 3.0 to 18.0, 3.5 to 4.0, 3.5 to 4.5, 3.5 to 5.0, 3.5 to 5.5, 3.5 to 6.0, 3.5 to 6.5, 3.5 to 12.0, 3.5 to 13.0, 3.5 to 14.0, 3.5 to 15.0, 3.5 to 16.0, 3.5 to 17.0, 3.5 to 18.0, 4.0 to 4.5, 4.0 to 5.0, 4.0 to 5.5, 4.0 to 6.0, 4.0 to 6.5, 4.0 to 7.0, 4.0 to 10.0, 4.0 to 10.5, 4.0 to 11.0, 4.0 to 12.0, 4.0 to 13.0, 4.0 to 14.0, 4.0 to 15.0, 4.0 to 16.0, 4.0 to 17.0, or 4.0 to 18.0. More preferably, 0.1 to 0.5, 0.1 to 1.0, 0.1 to 1.5, 0.1 to 2.0, 0.1 to 2.5, 0.1 to 3.0, 0.1 to 3.5, 0.1 to 4.0, 0.1 to 4.5, 0.1 to 5.0, 0.1 to 5.5, 0.5 to 1.0, 0.5 to 1.5, 0.5 to 2.0, 0.5 to 2.5, 0.5 to 3.0, 0.5 to 3.5, 0.5 to 4.0, 0.5 to 4.5, 0.5 to 5.0, 0.5 to 5.5, 1.0 to 1.5, 1.0 to 2.0, 1.0 to 2.5, 1.0 to 3.0, 1.0 to 3.5, 1.0 to 4.0, 1.0 to 4.5, 1.0 to 5.0, 1.0 to 5.5, 1.5 to 2.0, 1.5 to 2.5, 1.5 to 3.0, 1.5 to 3.5, 1.5 to 4.0, 1.5 to 4.5, 1.5 to 5.0, 1.5 to 5.5, 2.0 to 2.5, 2.0 to 3.0, 2.0 to 3.5, 2.0 to 4.0, 2.0 to 4.5, 2.0 to 5.0, 2.0 to 5.5, 2.5 to 3.0, 2.5 to 3.5, 2.5 to 4.0, 2.5 to 4.5, 2.5 to 5.0, 2.5 to 5.5, 3.0 to 3.5, 3.0 to 4.0, 3.0 to 4.5, 3.0 to 5.0, or 3.0 to 5.5.

“The amount of sodium”: 17 to 40 mg/100 ml, 17 mg/100 ml or more and less than 40 mg/100 ml, 17 to 35 mg/100 ml, 17 to 30 mg/100 ml, 17 to 25 mg/100 ml, 17 to 20 mg/100 ml, 22 to 40 mg/100 ml, 22 to 35 mg/100 ml, 22 to 30 mg/100 ml, 22 to 25 mg/100 ml, 27 to 40 mg/100 ml, 27 to 35 mg/100 ml, or 27 to 30 mg/100 ml.

“The amount of potassium”: 10 to 21 mg/100 ml, 10 to 20 mg/100 ml, 10 to 15 mg/100 ml, 12 to 21 mg/100 ml, 12 to 20 mg/120 ml, 12 to 15 mg/120 ml, 15 to 21 mg/100 ml, or 15 to 20 mg/100 ml.

“The amount of calcium”: 10 to 22 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 to 22 mg/100 ml, 15 to 20 mg/100 ml, 20 to 25 mg/100 ml, or 20 to 22 mg/100 ml.

“The sweetness intensity X3”: 4.0 to 20, 4.0 to 15, 4.0 to 12.5, 4.0 to 10, 4.5 to 20, 4.5 to 15, 4.5 to 12.5, 4.5 to 10, 5.0 to 20, 5.0 to 15, 5.0 to 12.5, 5.0 to 10, 5.5 to 20, 5.5 to 15, 5.5 to 12.5, 5.5 to 10, 6.0 to 20, 6.0 to 15, 6.0 to 12.5, 6.0 to 10, 6.5 to 20, 6.5 to 15, 6.5 to 12.5, 6.5 to 10, 7.0 to 20, 7.0 to 15, 7.0 to 12.5, 7.0 to 10, 7.5 to 20, 7.5 to 15, 7.5 to 12.5, 7.5 to 10, 7.5 to 9, 7.5 to 8, 8.0 to 20, 8.0 to 20, 8.0 to 15, 8.0 to 12.5, 8.0 to 10, 8.5 to 20, 8.5 to 15, 8.5 to 12.5, 8.5 to 10, 9.0 to 20, 9.0 to 15, 9.0 to 12.5, 9.0 to 10, 9.5 to 20, 9.5 to 15, 9.5 to 12.5, 9.5 to 10, 10.0 to 20, 10.0 to 15, 10.0 to 12.5, 10.5 to 20, 10.5 to 15, 10.5 to 12.5, 4.0 to 18, 4.0 to 16, 4.0 to 15.5, 4.0 to 14, 4.5 to 18, 4.5 to 16, 4.5 to 15.5, 4.5 to 14, 5.0 to 18, 5.0 to 16, 5.0 to 15.5, 5.0 to 14, 5.5 to 18, 5.5 to 16, 5.5 to 15.5, 5.5 to 14, 6.0 to 18, 6.0 to 16, 6.0 to 15.5, 6.0 to 14, 6.5 to 18, 6.5 to 16, 6.5 to 15.5, 6.5 to 14, 7.0 to 18, 7.0 to 16, 7.0 to 15.5, 7.0 to 14, 7.5 to 18, 7.5 to 16, 7.5 to 15.5, 7.5 to 14, 7.5 to 9, 7.5 to 8, 8.0 to 18, 8.0 to 18, 8.0 to 16, 8.0 to 15.5, 8.0 to 14, 8.5 to 18, 8.5 to 16, 8.5 to 15.5, 8.5 to 14, 9.0 to 18, 9.0 to 16, 9.0 to 15.5, 9.0 to 14, 9.5 to 18, 9.5 to 16, 9.5 to 15.5, 9.5 to 14, 10.0 to 18, 10.0 to 16, 10.0 to 15.5, 10.5 to 18, 10.5 to 16, or 10.5 to 15.5.

“The amount of mogroside V P2 (ppm)”: 20 to 550, 25 to 550, 30 to 550, 35 to 550, 40 to 550, 45 to 550, 50 to 550, 55 to 550, 20 to 540, 25 to 540, 30 to 540, 35 to 540, 40 to 540, 45 to 540, 50 to 540, 55 to 540, 20 to 530, 25 to 530, 30 to 530, 35 to 530, 40 to 530, 45 to 530, 50 to 530, 55 to 530, 20 to 520, 25 to 520, 30 to 520, 35 to 520, 40 to 520, 45 to 520, 50 to 520, 55 to 520, 20 to 510, 25 to 510, 30 to 510, 35 to 510, 40 to 510, 45 to 510, 50 to 510, 55 to 510, 20 to 505, 25 to 505, 30 to 505, 35 to 505, 40 to 505, 45 to 505, 50 to 505, 55 to 505, 20 to 500, 25 to 500, 30 to 500, 35 to 500, 40 to 500, 45 to 500, 50 to 500, 55 to 500, 20 to 495, 25 to 495, 30 to 495, 35 to 495, 40 to 495, 45 to 495, 50 to 495, 55 to 495, 20 to 490, 25 to 490, 30 to 490, 35 to 490, 40 to 490, 45 to 490, 50 to 490, 55 to 490, 1 to 700, 5 to 700, 10 to 700, 15 to 700, 20 to 700, 25 to 700, 30 to 700, 35 to 700, 40 to 700, 45 to 700, 50 to 700, 55 to 700, 1 to 600, 5 to 600, 10 to 600, 15 to 600, 20 to 600, 25 to 600, 30 to 600, 35 to 600, 40 to 600, 45 to 600, 50 to 600, 55 to 600, 1 to 550, 1 to 540, 1 to 530, 1 to 520, 1 to 510, 1 to 505, 1 to 500, 1 to 495, 1 to 490, 5 to 550, 5 to 540, 5 to 530, 5 to 520, 5 to 510, 5 to 505, 5 to 500, 5 to 495, 5 to 490, 10 to 550, 10 to 540, 10 to 530, 10 to 520, 10 to 510, 10 to 505, 10 to 500, 10 to 495, 10 to 490, 15 to 550, 15 to 550, 15 to 530, 15 to 520, 15 to 510, 15 to 505, 15 to 500, 15 to 495, or 15 to 490.

The energy: 0 to 50 Kcal/100 ml, 0 to 45 Kcal/100 ml, 0 to 40 Kcal/100 ml, 0 to 35 Kcal/100 ml, 0 to 30 Kcal/100 ml, 0 to 25 Kcal/100 ml, 0 to 20 Kcal/100 ml, 0 to 15 Kcal/100 ml, 0 to 10 Kcal/100 ml, 0 to 5 Kcal/100 ml, 5 to 50 Kcal/100 ml, 5 to 45 Kcal/100 ml, 5 to 40 Kcal/100 ml, 5 to 35 Kcal/100 ml, 5 to 30 Kcal/100 ml, 5 to 25 Kcal/100 ml, 5 to 20 Kcal/100 ml, 5 to 15 Kcal/100 ml, 5 to 10 Kcal/100 ml, 10 to 50 Kcal/100 ml, 10 to 45 Kcal/100 ml, 10 to 40 Kcal/100 ml, 10 to 35 Kcal/100 ml, 10 to 30 Kcal/100 ml, 10 to 25 Kcal/100 ml, 10 to 20 Kcal/100 ml, 10 to 15 Kcal/100 ml, 15 to 50 Kcal/100 ml, 15 to 45 Kcal/100 ml, 15 to 40 Kcal/100 ml, 15 to 35 Kcal/100 ml, 15 to 30 Kcal/100 ml, 15 to 25 Kcal/100 ml, 15 to 20 Kcal/100 ml, 20 to 50 Kcal/100 ml, 20 to 45 Kcal/100 ml, 20 to 40 Kcal/100 ml, 20 to 35 Kcal/100 ml, 20 to 30 Kcal/100 ml, 20 to 25 Kcal/100 ml, 25 to 50 Kcal/100 ml, 25 to 45 Kcal/100 ml, 25 to 40 Kcal/100 ml, 25 to 35 Kcal/100 ml, 25 to 30 Kcal/100 ml, 0 to 32 Kcal/100 ml, 0 to 24 Kcal/100 ml, 0 to 8 Kcal/100 ml, 0 to 4 Kcal/100 ml, 4 to 32 Kcal/100 ml, 4 to 24 Kcal/100 ml, 4 to 8 Kcal/100 ml, 8 to 32 Kcal/100 ml, 8 to 24 Kcal/100 ml, or 24 to 32 Kcal/100 ml.

In addition, in the tea beverage C of the present invention, the forms of the natural sugar (including examples of the combination of glucose, sucrose, fructose, maltose, oligosaccharide, high-fructose corn syrup, or lactose), sodium, potassium, and calcium are defined as described in the section for the tea beverage of the present invention.

Further, another aspect of the present invention provides a tea beverage comprising:

(a) a natural sugar in an amount of 0.1 to 0.5 w/v %, 0.1 to 1.0 w/v %, 0.1 to 1.5 w/v %, 0.1 to 2.0 w/v %, 0.1 to 2.5 w/v %, 0.1 to 3.0 w/v %, 0.1 to 3.5 w/v %, 0.1 to 4.0 w/v %, 0.1 to 4.5 w/v %, 0.1 to 5.0 w/v %, 0.1 to 5.5 w/v %, 0.1 to 5.9 w/v %, 0.5 to 1.0 w/v %, 0.5 to 1.5 w/v %, 0.5 to 2.0 w/v %, 0.5 to 2.5 w/v %, 0.5 to 3.0 w/v %, 0.5 to 3.5 w/v %, 0.5 to 4.0 w/v %, 0.5 to 4.5 w/v %, 0.5 to 5.0 w/v %, 0.5 to 5.5 w/v %, 0.5 to 5.9 w/v %, 1.0 to 1.5 w/v %, 1.0 to 2.0 w/v %, 1.0 to 2.5 w/v %, 1.0 to 3.0 w/v %, 1.0 to 3.5 w/v %, 1.0 to 4.0 w/v %, 1.0 to 4.5 w/v %, 1.0 to 5.0 w/v %, 1.0 to 5.5 w/v %, 1.0 to 5.9 w/v %, 1.5 to 2.0 w/v %, 1.5 to 2.5 w/v %, 1.5 to 3.0 w/v %, 1.5 to 3.5 w/v %, 1.5 to 4.0 w/v %, 1.5 to 4.5 w/v %, 1.5 to 5.0 w/v %, 1.5 to 5.5 w/v %, 1.5 to 5.9 w/v %, 2.0 to 2.5 w/v %, 2.0 to 3.0 w/v %, 2.0 to 3.5 w/v %, 2.0 to 4.0 w/v %, 2.0 to 4.5 w/v %, 2.0 to 5.0 w/v %, 2.0 to 5.5 w/v %, or 2.0 to 5.9 w/v %;
(b) at least one high-intensity sweetener selected from the group consisting of rebaudioside M, rebaudioside D, a Luo han guo extract, mogroside V, and a combination thereof in an amount of 20 to 550 ppm, 25 to 550 ppm, 30 to 550 ppm, 35 to 550 ppm, 40 to 550 ppm, 45 to 550 ppm, 50 to 550 ppm, 55 to 550 ppm, 20 to 540 ppm, 25 to 540 ppm, 30 to 540 ppm, 35 to 540 ppm, 40 to 540 ppm, 45 to 540 ppm, 50 to 540 ppm, 55 to 540 ppm, 20 to 530 ppm, 25 to 530 ppm, 30 to 530 ppm, 35 to 530 ppm, 40 to 530 ppm, 45 to 530 ppm, 50 to 530 ppm, 55 to 530 ppm, 20 to 520 ppm, 25 to 520 ppm, 30 to 520 ppm, 35 to 520 ppm, 40 to 520 ppm, 45 to 520 ppm, 50 to 520 ppm, 55 to 520 ppm, 20 to 510 ppm, 25 to 510 ppm, 30 to 510 ppm, 35 to 510 ppm, 40 to 510 ppm, 45 to 510 ppm, 50 to 510 ppm, 55 to 510 ppm, 20 to 505 ppm, 25 to 505 ppm, 30 to 505 ppm, 35 to 505 ppm, 40 to 505 ppm, 45 to 505 ppm, 50 to 505 ppm, 55 to 505 ppm, 20 to 500 ppm, 25 to 500 ppm, 30 to 500 ppm, 35 to 500 ppm, 40 to 500 ppm, 45 to 500 ppm, 50 to 500 ppm, 55 to 500 ppm, 20 to 495 ppm, 25 to 495 ppm, 30 to 495 ppm, 35 to 495 ppm, 40 to 495 ppm, 45 to 495 ppm, 50 to 495 ppm, 55 to 495 ppm, 20 to 490 ppm, 25 to 490 ppm, 30 to 490 ppm, 35 to 490 ppm, 40 to 490 ppm, 45 to 490 ppm, 50 to 490 ppm, or 55 to 490 ppm; and
(c) 0.1 mg/100 ml or more and less than 50 mg/100 ml, 0.1 to 45 mg/100 ml, 0.1 to 40 mg/100 ml, 0.1 to 35 mg/100 ml, 0.1 to 30 mg/100 ml, 0.1 to 25 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 mg/100 ml or more and less than 50 mg/100 ml, 1 to 45 mg/100 ml, 1 to 40 mg/100 ml, 1 to 35 mg/100 ml, 1 to 30 mg/100 ml, 1 to 25 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 5 mg/100 ml or more and less than 50 mg/100 ml, 5 to 45 mg/100 ml, 5 to 40 mg/100 ml, 5 to 35 mg/100 ml, 5 to 30 mg/100 ml, 5 to 25 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 7 mg/100 ml or more and less than 50 mg/100 ml, 7 to 45 mg/100 ml, 7 to 40 mg/100 ml, 7 mg/100 ml or more and less than 40 mg/100 ml, 7 to 35 mg/100 ml, 7 to 30 mg/100 ml, 7 to 25 mg/100 ml, 7 to 20 mg/100 ml, 7 to 19 mg/100 ml, 7 to 18 mg/100 ml, 7 to 17 mg/100 ml, 7 to 16 mg/100 ml, 7 to 15 mg/100 ml, 7 to 14 mg/100 ml, 7 to 13 mg/100 ml, 7 to 12 mg/100 ml, 7 to 11 mg/100 ml, 7 to 10 mg/100 ml, 10 mg/100 ml or more and less than 50 mg/100 ml, 10 to 45 mg/100 ml, 10 to 40 mg/100 ml, 10 to 35 mg/100 ml, 10 to 30 mg/100 ml, 10 to 25 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 15 mg/100 ml or more and less than 50 mg/100 ml, 15 to 45 mg/100 ml, 15 to 40 mg/100 ml, 15 to 35 mg/100 ml, 15 to 30 mg/100 ml, 15 to 25 mg/100 ml, 15 to 20 mg/100 ml, 17 mg/100 ml or more and less than 50 mg/100 ml, 17 to 45 mg/100 ml, 17 to 40 mg/100 ml, 17 mg/100 ml or more and less than 40 mg/100 ml, 17 to 35 mg/100 ml, 17 to 30 mg/100 ml, 17 to 25 mg/100 ml, 17 to 20 mg/100 ml, 17 to 19 mg/100 ml, 17 to 18 mg/100 ml, 20 mg/100 ml or more and less than 50 mg/100 ml, 20 to 45 mg/100 ml, 20 to 40 mg/100 ml, 20 to 35 mg/100 ml, 20 to 30 mg/100 ml, 20 to 25 mg/100 ml, 25 mg/100 ml or more and less than 50 mg/100 ml, 25 to 45 mg/100 ml, 25 to 40 mg/100 ml, 25 to 35 mg/100 ml, 25 to 30 mg/100 ml, 0.1 to 22 mg/100 ml, 0.1 to 21 mg/100 ml, 1 to 22 mg/100 ml, 1 to 21 mg/100 ml, 4 to 40 mg/100 ml, 4 to 35 mg/100 ml, 4 to 34 mg/100 ml, 4 to 33 mg/100 ml, 4 to 32 mg/100 ml, 4 to 31 mg/100 ml, 4 to 30 mg/100 ml, 4 to 29 mg/100 ml, 4 to 26 mg/100 ml, 4 to 25 mg/100 ml, 4 to 22 mg/100 ml, 4 to 21 mg/100 ml, 4 to 20 mg/100 ml, 4 to 19 mg/100 ml, 4 to 18 mg/100 ml, 4 to 17 mg/100 ml, 4 to 16 mg/100 ml, 4 to 15 mg/100 ml, 4 to 14 mg/100 ml, 4 to 13 mg/100 ml, 4 to 12 mg/100 ml, 4 to 11 mg/100 ml, 4 to 10 mg/100 ml, 5 to 34 mg/100 ml, 5 to 33 mg/100 ml, 5 to 32 mg/100 ml, 5 to 31 mg/100 ml, 5 to 29 mg/100 ml, 5 to 22 mg/100 ml, 5 to 21 mg/100 ml, 10 to 34 mg/100 ml, 10 to 33 mg/100 ml, 10 to 32 mg/100 ml, 10 to 31 mg/100 ml, 10 to 29 mg/100 ml, 10 to 22 mg/100 ml, 10 to 21 mg/100 ml, 11.5 to 34 mg/100 ml, 11.5 to 33 mg/100 ml, 11.5 to 32 mg/100 ml, 11.5 to 31 mg/100 ml, 11.5 to 30 mg/100 ml, 11.5 to 29 mg/100 ml, 11.5 to 22 mg/100 ml, 11.5 to 21 mg/100 ml, 11.5 to 20 mg/100 ml, 11.5 to 19 mg/100 ml, 11.5 to 18 mg/100 ml, 11.5 to 17 mg/100 ml, 11.5 to 16 mg/100 ml, 11.5 to 15 mg/100 ml, 11.5 to 14 mg/100 ml, 11.5 to 13 mg/100 ml, 11.5 to 12 mg/100 ml, 5.75 to 34.5 mg/100 ml, 5.75 to 28.75 mg/100 ml, 5.75 to 23 mg/100 ml, 5.75 to 17.25 mg/100 ml, 5.75 to 11.5 mg/100 ml, 11.5 to 34.5 mg/100 ml, 11.5 to 28.75 mg/100 ml, 11.5 to 23 mg/100 ml, 11.5 to 17.25 mg/100 ml, 17.25 to 34.5 mg/100 ml, 17.25 to 28.75 mg/100 ml, 17.25 to 23 mg/100 ml, 23 to 34.5 mg/100 ml, 23 to 28.75 mg/100 ml, or 28.75 to 34.5 mg/100 ml of sodium; and
(d) 0.1 to 52 mg/100 ml, 0.1 to 50 mg/100 ml, 0.1 to 45 mg/100 ml, 0.1 to 40 mg/100 ml, 0.1 to 35 mg/100 ml, 0.1 to 32 mg/100 ml, 0.1 to 30 mg/100 ml, 0.1 to 25 mg/100 ml, 0.1 to 21 mg/100 ml, 0.1 to 20 mg/100 ml, 0.1 to 15 mg/100 ml, 0.1 to 10 mg/100 ml, 0.1 to 5 mg/100 ml, 0.5 to 52 mg/100 ml, 0.5 to 50 mg/100 ml, 0.5 to 45 mg/100 ml, 0.5 to 40 mg/100 ml, 0.5 to 35 mg/100 ml, 0.5 to 30 mg/100 ml, 0.5 to 25 mg/100 ml, 0.5 to 21 mg/100 ml, 0.5 to 20 mg/100 ml, 0.5 to 15 mg/100 ml, 0.5 to 10 mg/100 ml, 0.5 to 5 mg/100 ml, 1 to 52 mg/100 ml, 1 to 50 mg/100 ml, 1 to 45 mg/100 ml, 1 to 40 mg/100 ml, 1 to 35 mg/100 ml, 1 to 32 mg/100 ml, 1 to 30 mg/100 ml, 1 to 25 mg/100 ml, 1 to 21 mg/100 ml, 1 to 20 mg/100 ml, 1 to 15 mg/100 ml, 1 to 10 mg/100 ml, 1 to 5 mg/100 ml, 5 to 52 mg/100 ml, 5 to 50 mg/100 ml, 5 to 45 mg/100 ml, 5 to 40 mg/100 ml, 5 to 35 mg/100 ml, 5 to 32 mg/100 ml, 5 to 30 mg/100 ml, 5 to 25 mg/100 ml, 5 to 21 mg/100 ml, 5 to 20 mg/100 ml, 5 to 15 mg/100 ml, 5 to 10 mg/100 ml, 5 to 5 mg/100 ml, 10 to 52 mg/100 ml, 10 to 50 mg/100 ml, 10 to 45 mg/100 ml, 10 to 40 mg/100 ml, 10 to 35 mg/100 ml, 10 to 32 mg/100 ml, 10 to 30 mg/100 ml, 10 to 25 mg/100 ml, 10 to 21 mg/100 ml, 10 to 20 mg/100 ml, 10 to 15 mg/100 ml, 12 to 52 mg/120 ml, 12 to 50 mg/120 ml, 12 to 45 mg/120 ml, 12 to 40 mg/120 ml, 12 to 35 mg/120 ml, 12 to 32 mg/100 ml, 12 to 30 mg/120 ml, 12 to 25 mg/120 ml, 12 to 21 mg/100 ml, 12 to 20 mg/120 ml, 12 to 15 mg/120 ml, 15 to 52 mg/100 ml, 15 to 50 mg/100 ml, 15 to 45 mg/100 ml, 15 to 40 mg/100 ml, 15 to 35 mg/100 ml, 15 to 32 mg/100 ml, 15 to 30 mg/100 ml, 15 to 25 mg/100 ml, 15 to 21 mg/100 ml, 15 to 20 mg/100 ml, 20 to 52 mg/100 ml, 20 to 50 mg/100 ml, 20 to 45 mg/100 ml, 20 to 40 mg/100 ml, 20 to 35 mg/100 ml, 20 to 32 mg/100 ml, 20 to 30 mg/100 ml, or 20 to 25 mg/100 ml of potassium, and/or 0.1 to 52 mg/100 ml, 0.1 to 50 mg/100 ml, 0.1 to 45 mg/100 ml, 0.1 to 40 mg/100 ml, 0.1 to 35 mg/100 ml, 0.1 to 32 mg/100 ml, 0.1 to 30 mg/100 ml, 0.1 to 25 mg/100 ml, 0.1 to 22 mg/100 ml, 0.1 to 20 mg/100 ml, 0.1 to 19 mg/100 ml, 0.1 to 18 mg/100 ml, 0.1 to 17 mg/100 ml, 0.1 to 16 mg/100 ml, 0.1 to 15 mg/100 ml, 0.1 to 14 mg/100 ml, 0.1 to 13 mg/100 ml, 0.1 to 12 mg/100 ml, 0.1 to 11 mg/100 ml, 0.1 to 10 mg/100 ml, 1 to 50 mg/100 ml, 1 to 45 mg/100 ml, 1 to 40 mg/100 ml, 1 to 35 mg/100 ml, 1 to 32 mg/100 ml, 1 to 30 mg/100 ml, 1 to 25 mg/100 ml, 1 to 22 mg/100 ml, 1 to 20 mg/100 ml, 1 to 19 mg/100 ml, 1 to 18 mg/100 ml, 1 to 17 mg/100 ml, 1 to 16 mg/100 ml, 1 to 15 mg/100 ml, 1 to 14 mg/100 ml, 1 to 13 mg/100 ml, 1 to 12 mg/100 ml, 1 to 11 mg/100 ml, 1 to 10 mg/100 ml, 5 to 50 mg/100 ml, 5 to 45 mg/100 ml, 5 to 40 mg/100 ml, 5 to 35 mg/100 ml, 5 to 32 mg/100 ml, 5 to 30 mg/100 ml, 5 to 25 mg/100 ml, 5 to 22 mg/100 ml, 5 to 20 mg/100 ml, 5 to 19 mg/100 ml, 5 to 18 mg/100 ml, 5 to 17 mg/100 ml, 5 to 16 mg/100 ml, 5 to 15 mg/100 ml, 5 to 14 mg/100 ml, 5 to 13 mg/100 ml, 5 to 12 mg/100 ml, 5 to 11 mg/100 ml, 5 to 10 mg/100 ml, 10 to 50 mg/100 ml, 10 to 45 mg/100 ml, 10 to 40 mg/100 ml, 10 to 35 mg/100 ml, 10 to 32 mg/100 ml, 10 to 30 mg/100 ml, 10 to 25 mg/100 ml, 10 to 22 mg/100 ml, 10 to 20 mg/100 ml, 10 to 19 mg/100 ml, 10 to 18 mg/100 ml, 10 to 17 mg/100 ml, 10 to 16 mg/100 ml, 10 to 15 mg/100 ml, 12 to 52 mg/120 ml, 12 to 50 mg/120 ml, 12 to 45 mg/120 ml, 12 to 40 mg/120 ml, 12 to 35 mg/120 ml, 12 to 32 mg/100 ml, 12 to 30 mg/120 ml, 12 to 25 mg/120 ml, 12 to 22 mg/100 ml, 12 to 20 mg/120 ml, 12 to 15 mg/120 ml, 15 to 50 mg/100 ml, 15 to 45 mg/100 ml, 15 to 40 mg/100 ml, 15 to 35 mg/100 ml, 15 to 32 mg/100 ml, 15 to 30 mg/100 ml, 15 to 25 mg/100 ml, 15 to 22 mg/100 ml, 15 to 20 mg/100 ml, 20 to 50 mg/100 ml, 20 to 45 mg/100 ml, 20 to 40 mg/100 ml, 20 to 35 mg/100 ml, 20 to 32 mg/100 ml, 20 to 30 mg/100 ml, 20 to 25 mg/100 ml, 25 to 50 mg/100 ml, 25 to 45 mg/100 ml, 25 to 40 mg/100 ml, 25 to 35 mg/100 ml, 25 to 32 mg/100 ml, or 25 to 30 mg/100 ml of calcium.

2. Method for Producing a Tea Beverage

Even in a tea beverage with a reduced energy (Kcal/100 ml) level by setting the amounts of the natural sugar and the high-intensity sweetener to low, it is possible to enhance the sweetness based on the natural sugar and the high-intensity sweetener by adding potassium and/or calcium in low concentrations in addition to sodium in a concentration so low as to not be detectable by the human.

Accordingly, the present invention provides, as a further another aspect, the following method for producing a tea beverage with enhanced sweetness (hereinafter, referred to as “the method of the present invention”).

A method for producing a tea beverage, comprising: to a raw material,
(i) adding (a) a natural sugar in an amount corresponding to a sweetness intensity X1 and (b) a high-intensity sweetener in an amount corresponding to a sweetness intensity X2;
(ii) adding (c) sodium such that a sodium concentration in the beverage is less than 50 mg/100 ml; and
(iii) adding (d) potassium such that a potassium content in the beverage is 0.1 to 52 mg/100 ml and/or calcium such that a calcium content in the beverage is 0.1 to 52 mg/100 ml,

Wherein the high-intensity sweetener comprises at least one high-intensity sweetener b1 selected from the group consisting of rebaudioside M, rebaudioside D, rebaudioside N, rebaudioside O, rebaudioside E, a Luo han guo extract, mogroside V, and thaumatin; and

sweetness of a sweetness intensity X3 is exhibited by the components (a) to (d), and 0.1<(X1+X2)≤20 is satisfied.

The tea beverage produced by the method of the present invention is the tea beverage of the present invention described in the above section “1. Tea beverage having improved taste quality exhibited by natural sugar and high-intensity sweetener”. In addition, the “raw material” in the method of the present invention may be each material, for example, a tea leaf and an aqueous medium, or a mixture thereof (that is, an extract from a tea leaf) necessary for production of a tea beverage, and may further include an additional component such as a preservative, a flavoring agent, a carrier, or a milk component. In addition, the “raw material” may be composed of a plurality of materials. However, regardless of the type of the raw material, the finally produced tea beverage of the present invention does not include a component that exhibits sweetness other than (a) and (b) as a sweetener.

In the method of the present invention, any of the following steps (i) to (iii) may be performed first:
(i) a step of adding (a) a natural sugar in an amount corresponding to a sweetness intensity X1 and (b) a high-intensity sweetener in an amount corresponding to a sweetness intensity X2;
(ii) a step of adding (c) sodium such that a sodium concentration in the beverage is less than 50 mg/100 ml; and
(iii) a step of adding (d) potassium such that a potassium content in the beverage is 0.1 to 52 mg/100 ml and/or calcium such that a calcium content in the beverage is 0.1 to 52 mg/100 ml.

In step (i), (a) a natural sugar in an amount corresponding to a sweetness intensity X1 and (b) a high-intensity sweetener in an amount corresponding to a sweetness intensity X2 are added to a raw material, where (a) a natural sugar in an amount corresponding to a sweetness intensity X1 and (b) a high-intensity sweetener in an amount corresponding to sweetness intensity X2 may be separately added.

Furthermore, when (a) a natural sugar in an amount corresponding to a sweetness intensity X1 is added, the natural sugar in an amount corresponding to the sweetness intensity X1 need not be added at once and may be added in several batches. Similarly, when (b) a high-intensity sweetener in an amount corresponding to a sweetness intensity X2 is added, the natural sugar in an amount corresponding to the sweetness intensity X2 need not be added at once and may be added in several batches.

In addition, as another aspect, it is also possible to adjust the amounts of a natural sugar and a high-intensity sweetener contained in the finally produced tea beverage to the amounts corresponding to a sweetness intensity X1 and a sweetness intensity X2, respectively, by adding a mixture of the natural sugar and the high-intensity sweetener in several batches.

In step (ii), also when (c) sodium is added such that the sodium concentration in the beverage is less than 50 mg/100 ml, sodium need not be added at once and may be added in several batches.

Sodium that is added to a raw material in step (ii) may be, for example, at least one form selected from the group consisting of sodium chloride, sodium hydroxide, sodium malate, sodium sulfate, sodium citrate, sodium phosphate, sodium carbonate, sodium disulfide, sodium bicarbonate, sodium alginate, sodium argininate, sodium glucoheptanoate, sodium gluconate, sodium glutamate, sodium tartrate, sodium aspartate, sodium lactate, sodium caseinate, sodium ascorbate, and a mixture thereof. In addition, since sodium is also contained in an extract of tea leaves, the amount of sodium is adjusted such that the total content of this sodium derived from tea leaves and the additional sodium is less than 50 mg/100 ml.

Potassium that can be added to a raw material in step (iii) may be, for example, at least one form selected from the group consisting of potassium alginate, potassium chloride, potassium citrate, potassium gluconate, L-potassium glutamate, potassium bromate, DL-potassium hydrogen tartrate, L-potassium hydrogen tartrate, potassium nitrate, potassium hydroxide, potassium sorbate, potassium carbonate, potassium lactate, potassium norbixin, potassium pyrosulfate, tetrapotassium pyrophosphate, potassium ferrocyanide, potassium polyphosphate, potassium metaphosphate, potassium aluminum sulfate, potassium sulfate, tripotassium phosphate, dipotassium hydrogen phosphate, potassium dihydrogen phosphate, and a mixture thereof. In addition, potassium is also contained in an extract of tea leaves in some cases, and in such a case, the amount of potassium is adjusted such that the total content of this potassium derived from tea leaves and the additional potassium is 0.1 mg/100 ml to 52 mg/100 ml. In addition, when a tea beverage contains a milk component, such as milk, cow's milk, or a dairy product, the potassium content contained in the milk component is also considered.

Calcium that can be added to a raw material in step (iii) may be, for example, at least one form selected from the group consisting of L-calcium ascorbate, calcium alginate, calcium disodium ethylenediaminetetraacetate, calcium chloride, calcium carboxymethyl cellulose, calcium citrate, calcium glycerophosphate, calcium gluconate, L-calcium glutamate, calcium silicate, calcium acetate, calcium oxide, calcium hydroxide, calcium stearate, calcium stearoyl lactate, calcium sorbate, calcium carbonate, calcium lactate, calcium pantothenate, calcium dihydrogen pyrophosphate, calcium ferrocyanide, calcium propionate, calcium 5′-ribonucleotide, calcium sulfate, tricalcium phosphate, calcium monohydrogen phosphate, calcium dihydrogen phosphate, and a mixture thereof. In addition, calcium is also contained in an extract of tea leaves and water (in particular, hard water) in some cases, and in such a case, the amount of calcium is adjusted such that the total content of this calcium derived from tea leaves and the additional calcium is 0.1 mg/100 ml to 52 mg/100 ml. In addition, when a tea beverage contains a milk component, such as milk, cow's milk, or a dairy product, the calcium amount contained in the milk component is also considered.

The “addition” herein means not only the actual operation of adding either of the components (a) to (d) to a raw material but also the operation of adjusting the amounts of the components (a) to (d) in the finally produced tea beverage to an amount corresponding to a sweetness intensity X1, an amount corresponding to a sweetness intensity X2, less than 50 mg/100 ml, and 0.1 to 52 mg/100 ml, respectively, through the production process of a tea beverage of the present invention.

For example, in a case in which a first raw material contains a milk component, a grain, a bean, or an extract thereof, other than components extracted from tea leaves into an aqueous medium such as water, and thereby contains one or more of the components (a) to (d) in advance, a second raw material to be mixed with the first raw material also contains the components (a) to (d), and a tea beverage of the present invention can be produced by mixing the first and second raw materials, the operation of independently adding the components (a) to (d) to the raw materials is not carried out. However, in the method of the present invention, steps (i) to (iii) are considered to have been carried out as long as the finally produced tea beverage of the present invention contains (a) a natural sugar in an amount corresponding to a sweetness intensity X1, (b) a high-intensity sweetener in an amount corresponding to a sweetness intensity X2, (c) less than 50 mg/100 ml of sodium, and (d) 0.1 to 52 mg/100 ml of potassium and/or 0.1 to 52 mg/100 ml of calcium.

When the tea beverage of the present invention is a packaged beverage, the method for producing a beverage of the present invention includes a step of filling a container with the tea beverage. In addition, when provided as a packaged beverage, sterilization of the tea beverage before or after filling a container with the tea beverage allows long-term storage and is therefore preferable. For example, when provided as a canned tea beverage, a can is filled with a predetermined amount of the tea beverage, and for example, heat sterilization can be performed by carrying out retort sterilization at 120 to 125° C. for about 5 to 20 minutes. In addition, when provided as a beverage packed in a PET bottle, paper pack, or bottle, a packaged beverage can be obtained by performing, for example, UHT sterilization by keeping 130 to 145° C. for about 2 to 120 seconds and hot pack filling or low-temperature aseptic filling of a predetermined amount of the beverage.

In the method of the present invention, the “tea beverage”, the “natural sugar”, the “sweetness intensity X1”, the “high-intensity sweetener”, the “sweetness intensity X2”, the sodium content, the content of potassium and/or calcium, the form of sodium, potassium, and/or calcium in the tea beverage, the “sweetness intensity X3”, and the energy are defined as described in the above section for the tea beverage, and the numerical values described in the above section for the tea beverage are applicable as they are. In addition, examples of the “combination of glucose, sucrose, fructose, maltose, oligosaccharide, high-fructose corn syrup, or lactose” and the “combination of high-intensity sweetener” are the same as those described in the above section for the tea beverage.

In a certain embodiment, the tea beverage produced by the method of the present invention is a tea beverage comprising:
(a) a natural sugar in an amount corresponding to a sweetness intensity X1 of 0.1 to 5;
(b) a high-intensity sweetener in an amount corresponding to a sweetness intensity X2 of 0.1 to 3;
(c) less than 50 mg/100 ml of sodium, and
(d) 0.1 to 52 mg/100 ml of potassium and/or 0.1 to 52 mg/100 ml of calcium,

wherein sweetness of a sweetness intensity X3 of 5.5 to 12.5 is exhibited by the components (a) to (d), and 0.2<(X1+X2) 12.5 is satisfied.

In another embodiment, the tea beverage produced by the method of the present invention is a tea beverage comprising:
(a) a natural sugar in an amount corresponding to a sweetness intensity X1 of 3 to 5;
(b) a high-intensity sweetener in an amount corresponding to a sweetness intensity X2 of 1 to 3;
(c) less than 50 mg/100 ml of sodium, and
(d) 0.1 to 32 mg/100 ml of potassium and/or 0.1 to 32 mg/100 ml of calcium,

wherein sweetness of a sweetness intensity X3 of 5.5 to 12.5 is exhibited by the components (a) to (d), and 4<(X1+X2)≤12.5 is satisfied.

In further another embodiment, the tea beverage produced by the method of the present invention is a tea beverage comprising:
(a) a natural sugar in an amount corresponding to a sweetness intensity X1 of 0.1 to 5;
(b) a high-intensity sweetener in an amount corresponding to a sweetness intensity X2 of 0.1 to 3;
(c) 7 mg/100 ml or more and less than 40 mg/100 ml of sodium; and
(d) 0.1 to 52 mg/100 ml of potassium and/or 0.1 to 52 mg/100 ml of calcium,

wherein sweetness of a sweetness intensity X3 of 2.0 to 12.0 is exhibited by the components (a) to (d), and 0.2<(X1+X2)≤12.5 is satisfied.

In another embodiment, the tea beverage produced by the method of the present invention is a tea beverage comprising:
(a) a natural sugar in an amount corresponding to a sweetness intensity X1 of 3 to 5;
(b) a high-intensity sweetener in an amount corresponding to a sweetness intensity X2 of 1 to 3;
(c) 7 mg/100 ml or more and less than 40 mg/100 ml of sodium; and
(d) 0.1 to 32 mg/100 ml of potassium and/or 0.1 to 32 mg/100 ml of calcium,

wherein sweetness of a sweetness intensity X3 of 5.5 to 12.0 is exhibited by the components (a) to (d), and 4<(X1+X2)≤12.5 is satisfied.

In a specific aspect, the present invention provides the following method (hereinafter, referred to as “the method A of the present invention”).

A method for producing a tea beverage, the method comprising the steps of:
(i) adding (a) a natural sugar in an amount of a sweetness intensity X1 and (b) a high-intensity sweetener selected from the group consisting of rebaudioside M, rebaudioside D, and a combination thereof in an amount of a sweetness intensity X2;
(ii) adding (c) sodium such that the sodium content in the beverage is 17 mg/100 ml or more and less than 40 mg/100 ml; and
(iii) adding (d) potassium such that a potassium content in the beverage is 0.1 to 52 mg/100 ml and/or adding (d) calcium such that a calcium content in the beverage is 0.1 to 52 mg/100 ml

to a raw material,

wherein sweetness of a sweetness intensity X3 is exhibited by the components (a) to (d), and 0.1<(X1+X2)≤20 is satisfied.

In the method A of the present invention, the “tea beverage”, the “natural sugar” (including examples of the combination of glucose, sucrose, fructose, maltose, oligosaccharide, high-fructose corn syrup, or lactose), the “sweetness intensity X1”, the “high-intensity sweetener”, the “sweetness intensity X2”, the sodium content, the content of potassium and/or calcium, the form of sodium, potassium, and/or calcium in the tea beverage, the “sweetness intensity X3”, and the energy are defined as described in the above section for the tea beverage A, and the numerical values described in the above section for the tea beverage A are applicable as they are. In addition, the tea beverage in the method A of the present invention corresponds to the tea beverage A of the present invention, and the above items for the tea beverage A of the present invention are applicable as they are.

Furthermore, the “raw material”, the “addition”, the order of steps (i), (ii), and (iii), and the addition mode of each component in the method A of the present invention are defined as described for the method of the present invention.

In another specific aspect, the present invention provides the following method (hereinafter, referred to as “the method B of the present invention”).

A method for producing a tea beverage, the method comprising the steps of:
(i) adding (a) a natural sugar in an amount of a sweetness intensity X1 and (b) a Luo han guo extract in an amount of a sweetness intensity X2;
(ii) adding (c) sodium such that the sodium content in the beverage is 17 mg/100 ml or more and less than 40 mg/100 ml; and
(iii) adding (d) potassium such that a potassium content in the beverage is 0.1 to 52 mg/100 ml and/or adding (d) calcium such that a calcium content in the beverage is 0.1 to 52 mg/100 ml,

to a raw material,

wherein sweetness of a sweetness intensity X3 is exhibited by the components (a) to (d), and 0.1<(X1+X2)≤20 is satisfied.

In the method B of the present invention, the “tea beverage”, the “natural sugar” (including examples of the combination of glucose, sucrose, fructose, maltose, oligosaccharide, high-fructose corn syrup, or lactose), the “sweetness intensity X1”, the “Luo han guo extract”, the “sweetness intensity X2”, the sodium content, the content of potassium and/or calcium, the form of sodium, potassium and/or calcium in the tea beverage, the “sweetness intensity X3”, and the energy are defined as described in the above section for tea beverage B, and the numerical values described in the above section for the tea beverage B are applicable as they are. In addition, the tea beverage in the method B of the present invention corresponds to the tea beverage B of the present invention, and the above items for the tea beverage B of the present invention are applicable as they are. Furthermore, the “raw material”, the “addition”, the order of steps (i), (ii), and (iii), and the addition mode of each component in the method B of the present invention are defined as described for the method of the present invention.

In another specific aspect, the present invention provides the following method (hereinafter, referred to as “the method C of the present invention”).

A method for producing a tea beverage, the method comprising the steps of:
(i) adding (a) a natural sugar in an amount of a sweetness intensity X1 and (b) mogroside V in an amount of a sweetness intensity X2;
(ii) adding (c) sodium such that the sodium content in the beverage is 17 mg/100 ml or more and less than 40 mg/100 ml; and
(iii) adding (d) potassium such that a potassium content in the beverage is 0.1 to 52 mg/100 ml and/or adding (d) calcium such that a calcium content in the beverage is 0.1 to 52 mg/100 ml,

to a raw material,

wherein sweetness of a sweetness intensity X3 is exhibited by the components (a) to (d), and 0.1<(X1+X2)≤20 is satisfied.

In the method C of the present invention, the “tea beverage”, the “natural sugar” (including examples of the combination of glucose, sucrose, fructose, maltose, oligosaccharide, high-fructose corn syrup, or lactose), the “sweetness intensity X1”, the “mogroside V”, the “sweetness intensity X2”, the sodium content, the content of potassium and/or calcium, the form of sodium, potassium and/or calcium in the tea beverage, the “sweetness intensity X3”, and the energy are defined as described in the above section for the tea beverage C, and the numerical values described in the above section for the tea beverage C are applicable as they are. In addition, the tea beverage in the method C of the present invention corresponds to the tea beverage C of the present invention, and the above items for the tea beverage C of the present invention are applicable as they are. Furthermore, the “raw material”, the “addition”, the order of steps (i), (ii), and (iii), and the addition mode of each component in the method C of the present invention are defined as described for the method of the present invention.

In the tea beverage produced by a method of the present invention,

the sweetness intensity X1 of the natural sugar, the sweetness intensity X2 of the high-intensity sweetener, the sodium content, the content of potassium and/or calcium, and the sweetness intensity X3 exhibited by the tea beverage may be any values as long as 0.1<(X1+X2)≤20 is satisfied. For example, it is also possible to combine any of the numerical values of the sweetness intensity X1, the sweetness intensity X2, the sodium content, the content of potassium and/or calcium, the sweetness intensity X3, and the energy shown in the section for the tea beverage of the present invention.

3. Concentrate for Providing Tea Beverage

The present invention provides, as another embodiment, a concentrate for providing the tea beverage of the above present invention (hereinafter, referred to as “the concentrate of the present invention”). In an aspect of the present invention, the concentrate of the present invention comprises:
(a) a natural sugar in an amount corresponding to a sweetness intensity X4;
(b) a high-intensity sweetener in an amount corresponding to a sweetness intensity X5; and
(c) less than 500 mg/100 ml of sodium; and
(d) 1 to 520 mg/100 ml of potassium and/or 1 to 520 mg/100 ml of calcium,

wherein (X4+X5)≤200, preferably 1<(X4+X5)≤200, and more preferably 50<(X4+X5)≤200 are satisfied.

The concentrate of the present invention is used for providing a tea beverage by diluting in an arbitrary ratio. The “tea beverage” is the same as that described in “1. Tea beverage having improved taste quality exhibited by natural sugar and high-intensity sweetener”. For example, the concentrate of the present invention can be used in a beverage as a syrup or an undiluted solution. In this instance, the concentrate can be diluted 2-fold, 3-fold, 4-fold, 5-fold, 6-fold, 7-fold, 8-fold, 9-fold, or 10-fold and used. In addition, the concentrate of the present invention is concentrated and is therefore preferable in the aspects of preservability and transportability. The concentrate of the present invention may be solid or liquid.

The concentrate of the present invention is a 2 to 10-fold concentrate, preferably 3 to 9-fold concentrate, more preferably 4 to 8-fold concentrate, and further preferably 5 to 7-fold concentrate, of the tea beverage of the present invention.

The concentrate in an aspect of the present invention is a 5-fold concentrate of the tea beverage of the present invention and comprises:
(a) a natural sugar in an amount corresponding to a sweetness intensity X6;
(b) a high-intensity sweetener in an amount corresponding to a sweetness intensity X7;
(c) less than 250 mg/100 ml of sodium; and
(d) 1 to 260 mg/100 ml of potassium and/or 1 to 260 mg/100 ml of calcium,

wherein (X6+X7)≤100, preferably 0.5<(X6+X7)≤100, and more preferably 20<(X6+X7)≤100 are satisfied.

The concentrate in an aspect of the present invention is a 6-fold concentrate of the tea beverage of the present invention and comprises:
(a) a natural sugar in an amount corresponding to a sweetness intensity X8;
(b) a high-intensity sweetener in an amount corresponding to a sweetness intensity X9;
(c) less than 300 mg/100 ml of sodium; and
(d) 0.6 to 312 mg/100 ml of potassium and/or 0.6 to 312 mg/100 ml of calcium,

wherein (X8+X9)≤120, preferably 0.6<(X8+X9)≤120, and more preferably 30<(X8+X9)≤120 are satisfied.

The concentrate in another aspect of the present invention is a 8-fold concentrate of the tea beverage of the present invention and comprises:
(a) a natural sugar in an amount corresponding to a sweetness intensity X10;
(b) a high-intensity sweetener in an amount corresponding to a sweetness intensity X11;
(c) less than 400 mg/100 ml of sodium; and
(d) 0.8 to 416 mg/100 ml of potassium and/or 0.8 to 416 mg/100 ml of calcium,

wherein (X10+X11)≤160, preferably 0.8<(X10+X11)≤160, and more preferably 40<(X10+X11)≤160 are satisfied.

4. Method for Enhancing Sweetness of Tea Beverage

The present invention provides, as another embodiment, a method for enhancing a sweetness of a tea beverage (hereinafter, referred to as “the sweetness enhancing method of the present invention”). In an aspect of the present invention, the sweetness enhancing method of the present invention is characterized by containing,
(a) a natural sugar in an amount corresponding to a sweetness intensity X1,
(b) a high-intensity sweetener in an amount corresponding to a sweetness intensity X2,
(c) less than 50 mg/100 ml of sodium; and
(d) 0.1 to 52 mg/100 ml of potassium and/or 0.1 to 52 mg/100 ml of calcium
   in a tea beverage.

According to the sweetness enhancing method of the present invention, the sweetness of the tea beverage is enhanced, and it is possible to provide a tea beverage having a sweetness higher than the mere sum of the sweetness intensity when the component (a) is added to the tea beverage and the sweetness intensity when the component (b) is added to the tea beverage. In the sweetness enhancing method of the present invention, the “tea beverage”, the “natural sugar”, the “sweetness intensity X1”, the “high-intensity sweetener”, the “sweetness intensity X2”, the sodium content, the content of potassium and/or calcium content, the form of sodium, potassium and/or calcium in the tea beverage, the “sweetness intensity X3”, and the energy are defined as described in the above section for the tea beverage, and the numerical values described in the above section for the tea beverage are applicable as they are. In addition, examples of the “combination of glucose, sucrose, fructose, maltose, oligosaccharide, high-fructose corn syrup, or lactose” and the “combination of high-intensity sweetener” are the same as those described in the above section for the tea beverage.

In the present specification, the term “at least” means that the number of a specific item may be greater than or equal to the mentioned number. In addition, in the present application, the term “about” means that a subject matter is in a range of ±25%, ±10%, ±5%, ±3%, +2%, or ±1%, of the numerical value following the “about”. For example, “about 10” means a range of 7.5 to 12.5.

### EXAMPLE

Hereinafter, the present invention will be specifically described with reference to examples but is not limited to the following examples.

Incidentally, in examples shown below, the contents of sodium and potassium contained in a beverage as a base before the addition of various additives was measured by atomic absorption spectrometry using SpectrAA240FS (manufactured by Agilent Technologies, Inc.), and the content of calcium was measured by ICP emission spectrometry using 5100VDV (manufactured by Agilent Technologies, Inc.) and ICPE-9000 (manufactured by Shimadzu Corporation). In addition, the contents of sodium content in a beverage sample after the addition of various additives is that obtained by adding the sodium content contained in the various additives calculated from the amounts of the additives to the sodium content in the beverage as the base measured by the above method. The same applied to potassium and calcium.

### [Example 1] Evaluation of Taste Quality Improvement Effect by Sodium, Potassium, and Calcium in Oolong Tea Beverage

### Experiment Method

Natural sugars {sucrose (manufactured by Pacific Sugar Mfg. Co., Ltd.) and glucose (manufactured by Showa Sangyo Co., Ltd.)}, rebaudioside D (RebD) (purity: 95% or more), sodium gluconate, potassium chloride, and calcium chloride were dissolved in an oolong tea extract liquid (sodium content: 10 (mg/100 ml), potassium content: 0.2 mg/100 ml, calcium content: 11.3 mg/100 ml, polyphenol content: 400 (ppm), and energy: 0 (kcal/100 ml)) in the ratios shown in Table 2 below to prepare beverage samples. In addition, the solution not containing any of sodium gluconate, potassium chloride, and calcium chloride was added was used as sample 1.

Incidentally, the Brix in Table 2 was calculated from the concentrations of the natural sugars, the sodium content was calculated from the addition amount of sodium gluconate and the sodium content derived from tea leaves, the potassium content was calculated from the addition amount of potassium chloride and the potassium content derived from tea leaves, and the calcium content was calculated from the addition amount of calcium chloride and the calcium content derived from tea leaves, and the energy (kcal/100 ml) was calculated by taking those derived from RebD and sodium, potassium, and calcium-derived components as 0 (kcal/100 ml). As shown in Table 2, the addition amount of Na in sample 1-1 was 20 mg/100 ml, the total addition amount of Na and K in sample 1-2 was 20 mg/100 ml, and the total addition amount of Na and Ca in sample 1-3 was 20 mg/100 ml.

TABLE 2

| Content | Sample 1 | 1-1 | 1-2 | 1-3 |
|---|---|---|---|---|
| Sucrose (w/v %) | 1.0 | 1.0 | 1.0 | 1.0 |
| Glucose (w/v %) | 3.5 | 3.5 | 3.5 | 3.5 |
| Brix | 4.5 | 4.5 | 4.5 | 4.5 |
| (derived from sucrose + | | | | |
| glucose) | | | | |
| RebD (ppm) | 208 | 208 | 208 | 208 |
| Sodium gluconate (g/L) | 0 | 1.90 | 0.95 | 0.95 |
| Sodium content (mg/100 ml) | 10 | 30 | 20 | 20 |
| Potassium chloride (g/L) | 0 | 0 | 0.2 | 0 |
| Potassium content (mg/100 ml) | 0.2 | 0.2 | 10.2 | 0.2 |
| Calcium chloride (g/L) | 0 | 0 | 0 | 0.28 |
| Calcium content (mg/100 ml) | 11.3 | 11.3 | 11.3 | 21.3 |
| Energy (Kcal/100 ml) | 18 | 18 | 18 | 18 |

The taste quality improvement effect by sodium, potassium and calcium was verified by sensory comparison of taste qualities of these beverage samples. The taste qualities as sensory evaluation items were “intensity of sweetness”, “intensity of flavor (aroma)”, “intensity of odd taste (such as bitter taste and astringent taste)”, and “intensity of saltiness”, and the verification was carried out by those (four persons) who received sensory training as panelists.

First, each panelist calculated the “sensory evaluation score” for each taste quality of each beverage sample based on the common taste quality evaluation criteria possessed by the panelists through daily training.

The “sensory evaluation score” a difference in the taste quality from sample 1 quantified in a range of −3.0 to +3.0 based on the degree of taste quality of sample 1 defined as “0” (reference). The criteria of the “sensory evaluation score” of each item are as follows.

### (Sensory Evaluation Score)

“+3.0”: it is felt that the taste quality as an object is very strong compared with sample 1;

“+2.0”: it is felt that the taste quality as an object is strong compared with sample 1;

“+1.0”: it is felt that the taste quality as an object is slightly strong compared with sample 1;

“0”: it is felt that the taste quality as an object is equal to sample 1;

“−1.0”: it is felt that the taste quality as an object is slightly weak compared with sample 1;

“−2.0”: it is felt that the taste quality as an object is weak compared with sample 1; and “−3.0”: it is felt that the taste quality as an object is very weak compared with sample 1.

Incidentally, in light of the above criteria, for example, when it was judged that the taste quality was between “+1.0” and “+2.0”, it was scored as “+1.5” in 0.5 increments.

The “sensory evaluation score” calculated by each panelist was converted to a “converted score” based on the following criteria, and the total value of the converted scores of four panelists was calculated for each taste quality.

### (Converted Score)

Converted score “3”: a sensory evaluation score of +1.5 or more;

Converted score “2”: a sensory evaluation score of +1.0 or more and less than +1.5;

Converted score “1”: a sensory evaluation score of +0.5 or more and less than +1.0;

Converted score “0”: a sensory evaluation score of higher than −0.5 and less than +0.5;

Converted score “−1”: a sensory evaluation score of higher than −1.0 and −0.5 or less;

Converted score “−2”: a sensory evaluation score of higher than −1.5 and −1.0 or less; and

Converted score “−3”: a sensory evaluation score of −1.5 or less.

Incidentally, regarding the “intensity of sweetness” and the “intensity of flavor”, a larger total value of converted scores is preferable, and regarding the “intensity of odd taste” and the “intensity of saltiness”, a smaller total value of converted scores is preferable.

### Results

The results of the calculated total value of converted scores of each taste quality are shown in Table 3.

TABLE 3

| Taste quality | Sample 1 | 1-1 | 1-2 | 1-3 |
|---|---|---|---|---|
| Intensity of sweetness | 0 | 2 | 6 | 6 |
| Intensity of flavor | 0 | 1 | 2 | 3 |
| Intensity of odd taste | 0 | −1 | −4 | −6 |
| Intensity of saltiness | 0 | 1 | 0 | 0 |

### [Example 2] Evaluation of Taste Quality Improvement Effect by Sodium, Potassium, and Calcium in Green Tea Beverage

### Experiment Method

In the same way as in Example 1, natural sugars {sucrose (manufactured by Pacific Sugar Mfg. Co., Ltd.) and glucose (manufactured by Showa Sangyo Co., Ltd.)}, rebaudioside D (RebD) (purity: 95% or more), sodium gluconate, potassium chloride, and calcium chloride were dissolved in a green tea extract liquid (sodium content: 6 (mg/100 ml), catechin content: 300 (ppm), and energy: 0 (kcal/100 ml)) in the ratios shown in Table 4 below to prepare beverage samples. In addition, the solution not containing any of sodium gluconate, potassium chloride, and calcium chloride was added was used as sample 2. Incidentally, the Brix in Table 4 was calculated from the concentrations of the natural sugars, the sodium content was calculated from the addition amount of sodium gluconate and the sodium content derived from tea leaves, the potassium content was calculated from the addition amount of potassium chloride and the potassium content derived from tea leaves, and the calcium content was calculated from the addition amount of calcium chloride and the calcium content derived from tea leaves, and the energy (kcal/100 ml) was calculated by taking those derived from RebD and sodium, potassium, and calcium-derived components as 0 (kcal/100 ml). As shown in Table 4, the addition amount of Na in sample 2-1 was 20 mg/100 ml, the total addition amount of Na and K in sample 2-2 was 20 mg/100 ml, and the total addition amount of Na and Ca in sample 2-3 was 20 mg/100 ml.

TABLE 4

| Content | Sample 2 | 2-1 | 2-2 | 2-3 |
|---|---|---|---|---|
| Sucrose (w/v %) | 1.0 | 1.0 | 1.0 | 1.0 |
| Glucose (w/v %) | 3.5 | 3.5 | 3.5 | 3.5 |
| Brix | 4.5 | 4.5 | 4.5 | 4.5 |
| (derived from sucrose + | | | | |
| glucose) | | | | |
| RebD (ppm) | 208 | 208 | 208 | 208 |
| Sodium gluconate (g/L) | 0 | 1.90 | 0.95 | 0.95 |
| Sodium content (mg/100 ml) | 6 | 26 | 16 | 16 |
| Potassium chloride (g/L) | 0 | 0 | 0.2 | 0 |
| Potassium content (mg/100 ml) | 10.7 | 10.7 | 20.7 | 10.7 |
| Calcium chloride (g/L) | 0 | 0 | 0 | 0.28 |
| Calcium content (mg/100 ml) | 0.2 | 0.2 | 0.2 | 10.2 |
| Energy (Kcal/100 ml) | 18 | 18 | 18 | 18 |

The taste quality improvement effect by sodium, potassium and calcium was verified by sensory comparison of taste qualities of these beverage samples. The taste qualities as sensory evaluation items were “intensity of sweetness”, “intensity of flavor (aroma)”, “intensity of odd taste”, and “intensity of saltiness”, and the verification was carried out by those (four persons) who received sensory training as panelists. Specifically, evaluation was performed as in Example 1, the “sensory evaluation score” calculated by each panelist was converted to a “converted score”, and the total value of the converted scores of four panelists was calculated for each taste quality.

### Results

The results of the calculated total value of converted scores of each taste quality are shown in Table 5.

TABLE 5

| Taste quality | Sample 2 | 2-1 | 2-2 | 2-3 |
|---|---|---|---|---|
| Intensity of sweetness | 0 | 4 | 5 | 5 |
| Intensity of flavor | 0 | 1 | 3 | 2 |
| Intensity of odd taste | 0 | 0 | −1 | −4 |
| Intensity of saltiness | 0 | 0 | 0 | 1 |

### [Example 3] Evaluation of Taste Quality Improvement Effect by Difference in Concentration of Potassium and/or Calcium in Oolong Tea

### Experiment Method

As in Example 1, natural sugars {sucrose (manufactured by Pacific Sugar Mfg. Co., Ltd.) and glucose (manufactured by Showa Sangyo Co., Ltd.)}, rebaudioside D (RebD) (purity: 95% or more), sodium gluconate, potassium chloride, and calcium chloride were dissolved in an oolong tea extract liquid (polyphenol content: 400 (ppm), sodium content: 10 mg/100 ml, potassium content: 0.2 mg/100 ml, calcium content: 11.3 mg/100 ml, and energy: 0 (kcal/100 ml)) in the ratios shown in Table 6 below to prepare beverage samples. In addition, the solution not containing any of sodium gluconate, potassium chloride, and calcium chloride was used as sample 3. Incidentally, the Brix in Table 6 was calculated from the concentrations of the natural sugars, the sodium content was calculated from the addition amount of sodium gluconate and the sodium content derived from tea leaves, the potassium content was calculated from the addition amount of potassium chloride and the potassium content derived from tea leaves, and the calcium content was calculated from the addition amount of calcium chloride and the calcium content derived from tea leaves, and the energy (kcal/100 ml) was calculated by taking those derived from RebD and sodium, potassium, and calcium-derived components as 0 (kcal/100 ml).

TABLE 6

| Content | Sample 3 | 3-1 | 3-2 | 3-3 | 34 | 3-5 | 3-6 | 3-7 | 3-8 |
|---|---|---|---|---|---|---|---|---|---|
| Sucrose (w/v %) | 1.0 | 1.0 | 1.0 | 1.0 | 1.0 | 1.0 | 1.0 | 1.0 | 1.0 |
| Glucose (w/v %) | 3.5 | 3.5 | 3.5 | 3.5 | 3.5 | 3.5 | 3.5 | 3.5 | 3.5 |
| Brix | 4.5 | 4.5 | 4.5 | 4.5 | 4.5 | 4.5 | 4.5 | 4.5 | 4.5 |
| (derived from sucrose + | | | | | | | | | |
| glucose) | | | | | | | | | |
| RebD (ppm) | 208 | 208 | 208 | 208 | 208 | 208 | 208 | 208 | 208 |
| Sodium gluconate (g/L) | 0 | 0.95 | 0.95 | 0.95 | 0.95 | 0.95 | 0.95 | 0.95 | 0.95 |
| Sodium content (mg/100 ml) | 10 | 20 | 20 | 20 | 20 | 20 | 20 | 20 | 20 |
| Potassium chloride (g/L) | 0 | 0.2 | 0.4 | 0.6 | 0.8 | 0 | 0 | 0 | 0 |
| Potassium content (mg/100 ml) | 0.2 | 10.2 | 20.2 | 30.2 | 40.2 | 0.2 | 0.2 | 0.2 | 0.2 |
| Calcium chloride (g/L) | 0 | 0 | 0 | 0 | 0 | 0.28 | 0.56 | 0.84 | 1.12 |
| Calcium content (mg/100 ml) | 11.3 | 11.3 | 11.3 | 11.3 | 11.3 | 21.3 | 31.3 | 41.3 | 51.3 |
| Energy (Kcal/100 ml) | 18 | 18 | 18 | 18 | 18 | 18 | 18 | 18 | 18 |

The taste quality improvement effect by differences in concentration of potassium and/or calcium was verified by sensory comparison of taste qualities of these beverage samples. The taste qualities as sensory evaluation items were “intensity of sweetness”, “intensity of flavor (aroma)”, “intensity of odd taste (such as bitter taste and astringent taste)”, and “intensity of saltiness”, and the verification was carried out by panelists (four persons) who received sensory training. Specifically, evaluation was performed as in Example 1, the “sensory evaluation score” calculated by each panelist was converted to a “converted score”, and the total value of the converted scores of four panelists was calculated for each taste quality.

Precipitation occurred in samples 3-7 and 3-8.

TABLE 7

| Taste quality | Sample 3 | 3-1 | 3-2 | 3-3 | 3-4 | 3-5 | 3-6 |
|---|---|---|---|---|---|---|---|
| Intensity of sweetness | 0 | 2 | 2 | 5 | 2 | 6 | 7 |
| Intensity of flavor | 0 | 3 | 3 | 3 | 1 | 4 | 7 |
| Intensity of odd taste | 0 | −2 | −6 | −6 | −4 | −3 | −8 |
| Intensity of saltiness | 0 | 0 | 0 | 0 | 0 | 0 | 0 |

### [Example 4] Evaluation of Taste Quality Improvement Effect by Difference in Concentration of Potassium and/or Calcium in Green Tea

### Experiment Method

As in Example 1, natural sugars {sucrose (manufactured by Pacific Sugar Mfg. Co., Ltd.) and glucose (manufactured by Showa Sangyo Co., Ltd.)}, rebaudioside D (RebD) (purity: 95% or more), sodium gluconate, potassium chloride, and calcium chloride were dissolved in an oolong tea extract liquid (catechin content: 300 (ppm), sodium content: 6 mg/100 ml, potassium content: 10.7 mg/100 ml, calcium content: 0.2 mg/100 ml, and energy: 0 (kcal/100 ml)) in the ratios shown in Table 8 below to prepare beverage samples. In addition, the solution not containing any of sodium gluconate, potassium chloride, and calcium chloride was used as sample 4. Incidentally, the Brix in Table 8 was calculated from the concentrations of the natural sugars, the sodium content was calculated from the addition amount of sodium gluconate and the sodium content derived from tea leaves, the potassium content was calculated from the addition amount of potassium chloride and the potassium content derived from tea leaves, and the calcium content was calculated from the addition amount of calcium chloride and the calcium content derived from tea leaves, and the energy (kcal/100 ml) was calculated by taking those derived from RebD and sodium, potassium, and calcium-derived components as 0 (kcal/100 ml).

TABLE 8

| Content | Sample 4 | 4-1 | 4-2 | 4-3 | 4-4 | 4-5 | 4-6 | 4-7 | 4-8 |
|---|---|---|---|---|---|---|---|---|---|
| Sucrose (w/v %) | 1.0 | 1.0 | 1.0 | 1.0 | 1.0 | 1.0 | 1.0 | 1.0 | 1.0 |
| Glucose (w/v %) | 3.5 | 3.5 | 3.5 | 3.5 | 3.5 | 3.5 | 3.5 | 3.5 | 3.5 |
| Brix | 4.5 | 4.5 | 4.5 | 4.5 | 4.5 | 4.5 | 4.5 | 4.5 | 4.5 |
| (derived from sucrose + | | | | | | | | | |
| glucose) | | | | | | | | | |
| RebD (ppm) | 208 | 208 | 208 | 208 | 208 | 208 | 208 | 208 | 208 |
| Sodium gluconate (g/L) | 0 | 0.95 | 0.95 | 0.95 | 0.95 | 0.95 | 0.95 | 0.95 | 0.95 |
| Sodium content (mg/100 ml) | 6 | 16 | 16 | 16 | 16 | 16 | 16 | 16 | 16 |
| Potassium chloride (g/L) | 0 | 0.2 | 0.4 | 0.6 | 0.8 | 0 | 0 | 0 | 0 |
| Potassium content (mg/100 ml) | 10.7 | 20.7 | 30.7 | 40.7 | 50.7 | 10.7 | 10.7 | 10.7 | 10.7 |
| Calcium chloride (g/L) | 0 | 0 | 0 | 0 | 0 | 0.28 | 0.56 | 0.84 | 1.12 |
| Calcium content (mg/100 ml) | 0.2 | 0.2 | 0.2 | 0.2 | 0.2 | 10.2 | 20.2 | 30.2 | 40.2 |
| Energy (Kcal/100 ml) | 18 | 18 | 18 | 18 | 18 | 18 | 18 | 18 | 18 |

The taste quality improvement effect by differences in concentration of potassium and/or calcium was verified by sensory comparison of taste qualities of these beverage samples. The taste qualities as sensory evaluation items were “intensity of sweetness”, “intensity of flavor (aroma)”, “intensity of odd taste (such as bitter taste and astringent taste)”, and “intensity of saltiness”, and the verification was carried out by panelists (four persons) who received sensory training. Specifically, evaluation was performed as in Example 1, the “sensory evaluation score” calculated by each panelist was converted to a “converted score”, and the total value of the converted scores of four panelists was calculated for each taste quality.

Precipitation occurred in samples 4-7 and 4-8.

TABLE 9

| Taste quality | Sample 4 | 4-1 | 4-2 | 4-3 | 4-4 | 4-5 | 4-6 |
|---|---|---|---|---|---|---|---|
| Intensity of sweetness | 0 | 2 | 4 | 5 | 5 | 7 | 8 |
| Intensity of flavor | 0 | 1 | 2 | 1 | 1 | 2 | 3 |
| Intensity of odd taste | 0 | 0 | 0 | 2 | 4 | −1 | −7 |
| Intensity of saltiness | 0 | 0 | 0 | 0 | 0 | 0 | 0 |

### [Example 5] Evaluation of Taste Quality Improvement Effect by Various High-Intensity Sweeteners and Sodium, Potassium, and/or Calcium in Oolong Tea

### Experiment Method

As in Example 1, natural sugars {sucrose (manufactured by Pacific Sugar Mfg. Co., Ltd.) and glucose (manufactured by Showa Sangyo Co., Ltd.)}, a high-intensity sweetener {mogroside V (MogV) (purity: 95% or more) or rebaudioside M (RebM) (purity: 99% or more)}, sodium gluconate, potassium chloride, and calcium chloride were dissolved in an oolong tea extract liquid (sodium content: 10 (mg/100 ml), potassium content: 0.2 mg/100 ml, calcium content: 11.3 mg/100 ml, polyphenol content: 400 (ppm), and energy: 0 (kcal/100 ml)) in the ratios shown in Table 10 below to prepare beverage samples. In addition, the solutions not containing any of sodium gluconate, potassium chloride, and calcium chloride were used as sample 5 (containing MogV) and sample 5A (containing RebM), respectively. Incidentally, the Brix in Table 10 was calculated from the concentrations of the natural sugars, the sodium content was calculated from the addition amount of sodium gluconate and the sodium content derived from tea leaves, the potassium content was calculated from the addition amount of potassium chloride and the potassium content derived from tea leaves, the calcium content was calculated from the addition amount of calcium chloride and the calcium content derived from tea leaves, and the energy (kcal/100 ml) was calculated by taking those derived from MogV, RebM, sodium, potassium, and calcium as 0 (kcal/100 ml). As shown in Table 10, the addition amount of Na in sample 5-3 was 20 mg/100 ml, the total addition amount of Na and K in samples 5-1 and 5-4 was 20 mg/100 ml, and the total addition amount of Na and Ca in samples 5-2 and 5-5 was 20 mg/100 ml.

TABLE 10

| Content | Sample 5 | 5-1 | 5-2 | Sample 5A | 5-3 | 5-4 | 5-5 |
|---|---|---|---|---|---|---|---|
| Sucrose (w/v %) | 1.0 | 1.0 | 1.0 | 1.0 | 1.0 | 1.0 | 1.0 |
| Glucose (w/v %) | 3.5 | 3.5 | 3.5 | 3.5 | 3.5 | 3.5 | 3.5 |
| Brix | 4.5 | 4.5 | 4.5 | 4.5 | 4.5 | 4.5 | 4.5 |
| (derived from sucrose + | | | | | | | |
| glucose) | | | | | | | |
| MogV (ppm) | 208 | 208 | 208 | 0 | 0 | 0 | 0 |
| RebM (ppm) | 0 | 0 | 0 | 208 | 208 | 208 | 208 |
| Sodium gluconate (g/L) | 0 | 0.95 | 0.95 | 0 | 1.90 | 0.95 | 0.95 |
| As sodium content (mg/100 ml) | 10 | 20 | 20 | 10 | 30 | 20 | 20 |
| Potassium chloride (g/L) | 0 | 0.2 | 0 | 0 | 0 | 0.2 | 0 |
| As potassium content (mg/100 ml) | 0.2 | 10.2 | 0.2 | 0.2 | 0.2 | 10.2 | 0.2 |
| Calcium chloride (g/L) | 0 | 0 | 0.28 | 0 | 0 | 0 | 0.28 |
| As calcium content (mg/100 ml) | 11.3 | 11.3 | 21.3 | 11.3 | 11.3 | 11.3 | 21.3 |
| Energy (Kcal/100 ml) | 18 | 18 | 18 | 18 | 18 | 18 | 18 |

The taste quality improvement effect by sodium, potassium, and calcium was verified by sensory comparison of taste qualities of these beverage samples. The taste qualities as sensory evaluation items were “intensity of sweetness”, “intensity of flavor (aroma)”, “intensity of odd taste (such as bitter taste and astringent taste)”, “intensity of saltiness”, and “carbonation feeling”, and the verification was carried out by panelists (four persons) who received sensory training. Specifically, evaluation was performed as in Example 1, the “sensory evaluation score” calculated by each panelist was converted to a “converted score”, and the total value of the converted scores of four panelists was calculated for each taste quality. In samples 5 to 5-2, the score of sample 5 was used as reference (0 point), and in samples 5A to 5-5, the score of sample 5A was used as reference (0 point).

### Results

The results of the calculated total value of converted scores of each taste quality are shown in Table 11.

TABLE 11

| Taste quality | Sample 5 | 5-1 | 5-2 | Sample 5A | 5-3 | 5-4 | 5-5 |
|---|---|---|---|---|---|---|---|
| Intensity of sweetness | 0 | 6 | 4 | 0 | 4 | 7 | 8 |
| Intensity of flavor | 0 | 3 | 3 | 0 | 2 | 3 | 1 |
| Intensity of odd taste | 0 | 0 | −2 | 0 | −2 | −1 | −1 |
| Intensity of saltiness | 0 | 0 | 0 | 0 | 0 | 3 | 1 |

### [Example 6] Evaluation of Taste Quality Improvement Effect by Various High-Intensity Sweeteners and Sodium, Potassium, and/or Calcium in Green Tea

### Experiment Method

As in Example 1, natural sugars {sucrose (manufactured by Pacific Sugar Mfg. Co., Ltd.) and glucose (manufactured by Showa Sangyo Co., Ltd.)}, a high-intensity sweetener {mogroside V (MogV) (purity: 95% or more) or rebaudioside M (RebM) (purity: 99% or more)}, sodium gluconate, potassium chloride, and calcium chloride were dissolved in a green tea extract liquid (sodium content: 6 mg/100 ml, potassium content: 10.7 mg/100 ml, calcium content: 0.2 mg/100 ml, catechin content: 300 (ppm), and energy: 0 (kcal/100 ml)) in the ratios shown in Table 12 below to prepare beverage samples. In addition, the solutions not containing any of sodium gluconate, potassium chloride, and calcium chloride were used as sample 6 (containing MogV) and sample 6A (containing RebM), respectively. Incidentally, the Brix in Table 12 was calculated from the concentrations of the natural sugars, the sodium content was calculated from the addition amount of sodium gluconate and the sodium content derived from tea leaves, the potassium content was calculated from the addition amount of potassium chloride and the potassium content derived from tea leaves, the calcium content was calculated from the addition amount of calcium chloride and the calcium content derived from tea leaves, and the energy (kcal/100 ml) was calculated by taking those derived from MogV, RebM, sodium, potassium, and calcium as 0 (kcal/100 ml). As shown in Table 12, the addition amount of Na in sample 6-3 was 20 mg/100 ml, the total addition amount of Na and K in samples 6-1 and 6-4 was 20 mg/100 ml, and the total addition amount of Na and Ca in samples 6-2 and 6-5 was 20 mg/100 ml.

TABLE 12

| Content | Sample 6 | 6-1 | 6-2 | Sample 6A | 6-3 | 6-4 | 6-5 |
|---|---|---|---|---|---|---|---|
| Sucrose (w/v %) | 1.0 | 1.0 | 1.0 | 1.0 | 1.0 | 1.0 | 1.0 |
| Glucose (w/v %) | 3.5 | 3.5 | 3.5 | 3.5 | 3.5 | 3.5 | 3.5 |
| Brix | 4.5 | 4.5 | 4.5 | 4.5 | 4.5 | 4.5 | 4.5 |
| (derived from sucrose + | | | | | | | |
| glucose) | | | | | | | |
| MogV (ppm) | 208 | 208 | 208 | 0 | 0 | 0 | 0 |
| RebM (ppm) | 0 | 0 | 0 | 208 | 208 | 208 | 208 |
| Sodium gluconate (g/L) | 0 | 0.95 | 0.95 | 0 | 1.90 | 0.95 | 0.95 |
| Sodium content (mg/100 ml) | 6 | 16 | 16 | 6 | 26 | 16 | 16 |
| Potassium chloride (g/L) | 0 | 0.2 | 0 | 0 | 0 | 0.2 | 0 |
| Potassium content (mg/100 ml) | 10.7 | 20.7 | 10.7 | 10.7 | 10.7 | 20.7 | 10.7 |
| Calcium chloride (g/L) | 0 | 0 | 0.28 | 0 | 0 | 0 | 0.28 |
| Calcium content (mg/100 ml) | 0.2 | 0.2 | 10.2 | 0.2 | 0.2 | 0.2 | 10.2 |
| Energy (Kcal/100 ml) | 18 | 18 | 18 | 18 | 18 | 18 | 18 |

The taste quality improvement effect by sodium, potassium, and calcium was verified by sensory comparison of taste qualities of these beverage samples. The taste qualities as sensory evaluation items were “intensity of sweetness”, “intensity of flavor (aroma)”, “intensity of odd taste (such as bitter taste and astringent taste)”, “intensity of saltiness”, and “carbonation feeling”, and the verification was carried out by panelists (four persons) who received sensory training. Specifically, evaluation was performed as in Example 1, the “sensory evaluation score” calculated by each panelist was converted to a “converted score”, and the total value of the converted scores of four panelists was calculated for each taste quality. In samples 6 to 6-2, the score of sample 6 was used as reference (0 point), and in samples 6A to 6-5, the score of sample 6A was used as reference (0 point).

### Results

The results of the calculated total value of converted scores of each taste quality are shown in Table 13.

TABLE 13

| Taste quality | Sample 6 | 6-1 | 6-2 | Sample 6A | 6-3 | 6-4 | 6-5 |
|---|---|---|---|---|---|---|---|
| Intensity of sweetness | 0 | 5 | 3 | 0 | 3 | 2 | 2 |
| Intensity of flavor | 0 | 5 | 3 | 0 | 4 | 4 | 4 |
| Intensity of odd taste | 0 | 0 | −2 | 0 | −2 | 0 | −3 |
| Intensity of saltiness | 0 | 0 | 0 | 0 | 0 | 0 | 0 |

### INDUSTRIAL APPLICABILITY

The method of the present invention provides a method for increasing the sweetness of a tea beverage or sweet composition, which is not a simple sweetness that is obtained by increasing the amounts of a natural sugar and a high-intensity sweetener used, and providing good taste.

1. A tea beverage comprising:
(a) a natural sugar in an amount corresponding to a sweetness intensity X1;
(b) a high-intensity sweetener in an amount corresponding to a sweetness intensity X2;
(c) less than 50 mg/100 ml of sodium; and
(d) 0.1 to 52 mg/100 ml of potassium and/or 0.1 to 52 mg/100 ml of calcium,
wherein the high-intensity sweetener comprises at least one high-intensity sweetener b1 selected from the group consisting of rebaudioside M, rebaudioside D, rebaudioside N, rebaudioside O, rebaudioside E, a Luo han guo extract, mogroside V, and thaumatin; and
0.1<(X1+X2)≤20 is satisfied.

2. The tea beverage according to claim 1, wherein a sodium content is 7 mg/100 ml or more and less than 40 mg/100 ml.

3. The tea beverage according to claim 1, comprising 0.1 to 32 mg/100 ml of potassium and/or 0.1 to 32 mg/100 ml of calcium.

4. The tea beverage according to claim 1, wherein energy is 50 Kcal/100 ml or less.

5. The tea beverage according to claim 1, wherein X1 is 0.1 to 5.9.

6. The tea beverage according to claim 1, comprising 200 to 600 ppm of polyphenol.

7. The tea beverage according to claim 6, comprising 200 to 600 ppm of catechin.

8. The tea beverage according to claim 1, wherein the natural sugar is at least one selected from the group consisting of glucose, sucrose, fructose, maltose, oligosaccharide, high-fructose corn syrup, lactose, psicose, allose, tagatose, and a combination thereof.

9. The tea beverage according to claim 1, wherein the high-intensity sweetener b1 is at least one selected from the group consisting of rebaudioside M, rebaudioside D, a Luo han guo extract, mogroside V, and a combination thereof.

10. The tea beverage according to claim 1, wherein the sodium is at least one selected from the group consisting of sodium chloride, sodium hydroxide, sodium malate, sodium sulfate, sodium citrate, sodium phosphate, sodium carbonate, sodium disulfide, sodium bicarbonate, sodium alginate, sodium argininate, sodium glucoheptanoate, sodium gluconate, sodium glutamate, sodium tartrate, sodium aspartate, sodium lactate, sodium caseinate, sodium ascorbate, and a mixture thereof.

11. The tea beverage according to claim 1, wherein the potassium is at least one selected from the group consisting of potassium alginate, potassium chloride, potassium citrate, potassium gluconate, potassium L-glutamate, potassium bromate, potassium hydrogen DL-tartrate, potassium hydrogen L-tartrate, potassium nitrate, potassium hydroxide, potassium sorbate, potassium carbonate, potassium lactate, potassium norbixin, potassium pyrosulfite, tetrapotassium pyrophosphate, potassium ferrocyanide, potassium polyphosphate, potassium metaphosphate, potassium aluminum sulfate, potassium sulfate, tripotassium phosphate, dipotassium hydrogen phosphate, potassium dihydrogen phosphate, and a mixture thereof.

12. The tea beverage according to claim 1, wherein the calcium is at least one selected from the group consisting of calcium L-ascorbate, calcium alginate, calcium disodium ethylenediaminetetraacetate, calcium chloride, carboxymethylcellulose calcium, calcium citrate, calcium glycerophosphate, calcium gluconate, calcium Di-L-glutamate, calcium silicate, calcium acetate, calcium oxide, calcium hydroxide, calcium stearate, calcium stearoyl lactate, calcium sorbate, calcium carbonate, calcium lactate, calcium pantothenate, calcium dihydrogen pyrophosphate, calcium ferrocyanide, calcium propionate, calcium 5′-ribonucleotide, calcium sulfate, tricalcium phosphate, calcium monohydrogen phosphate, calcium dihydrogen phosphate, and mixtures thereof.

13. The tea beverage according to claim 1, wherein the tea beverage comprises 17 mg/100 ml or more and less than 40 mg/100 ml of sodium, comprises 10 to 21 mg/100 ml of potassium and/or 10 to 22 mg/100 ml of calcium, and energy is 50 Kcal/100 ml or less, and X1+X2 is 6 or more.

14. The tea beverage according to claim 1, which is packed in a container.

15. A method for producing a tea beverage, comprising to a raw material:
(i) adding (a) a natural sugar in an amount of a sweetness intensity X1 and (b) a high-intensity sweetener in an amount of a sweetness intensity X2;
(ii) adding (c) sodium such that a sodium content in the tea beverage is less than 50 mg/100 ml; and
(iii) adding (d) potassium such that a potassium content in the beverage is 0.1 to 52 mg/100 ml and/or calcium such that a calcium content in the beverage is 0.1 to 52 mg/100 ml,
wherein
the high-intensity sweetener comprises at least one high-intensity sweetener b1 selected from the group consisting of rebaudioside M, rebaudioside D, rebaudioside N, rebaudioside O, rebaudioside E, a Luo han guo extract, mogroside V, and thaumatin; and
0.1<(X1+X2)≤20 is satisfied.

16-21. (canceled)

22. The method according to claim 15, wherein the natural sugar is at least one selected from the group consisting of glucose, sucrose, fructose, maltose, oligosaccharide, high-fructose corn syrup, lactose, psicose, allose, tagatose, and a combination thereof.

23. (canceled)

24. The method according to claim 15, wherein the sodium is at least one selected from the group consisting of sodium chloride, sodium hydroxide, sodium malate, sodium sulfate, sodium citrate, sodium phosphate, sodium carbonate, sodium disulfide, sodium bicarbonate, sodium alginate, sodium argininate, sodium glucoheptanoate, sodium gluconate, sodium glutamate, sodium tartrate, sodium aspartate, sodium lactate, sodium caseinate, sodium ascorbate, and a mixture thereof.

25. The method according to claim 15, wherein the potassium is at least one selected from the group consisting of potassium alginate, potassium chloride, potassium citrate, potassium gluconate, potassium L-glutamate, potassium bromate, potassium hydrogen DL-tartrate, potassium hydrogen L-tartrate, potassium nitrate, potassium hydroxide, potassium sorbate, potassium carbonate, potassium lactate, potassium norbixin, potassium pyrosulfite, tetrapotassium pyrophosphate, potassium ferrocyanide, potassium polyphosphate, potassium metaphosphate, potassium aluminum sulfate, potassium sulfate, tripotassium phosphate, dipotassium hydrogen phosphate, potassium dihydrogen phosphate, and a mixture thereof.

26. The method according to claim 15, wherein the calcium is at least one selected from the group consisting of calcium L-ascorbate, calcium alginate, calcium disodium ethylenediaminetetraacetate, calcium chloride, carboxymethylcellulose calcium, calcium citrate, calcium glycerophosphate, calcium gluconate, calcium Di-L-glutamate, calcium silicate, calcium acetate, calcium oxide, calcium hydroxide, calcium stearate, calcium stearoyl lactate, calcium sorbate, calcium carbonate, calcium lactate, calcium pantothenate, calcium dihydrogen pyrophosphate, calcium ferrocyanide, calcium propionate, calcium 5′-ribonucleotide, calcium sulfate, tricalcium phosphate, calcium monohydrogen phosphate, calcium dihydrogen phosphate, and a mixture thereof.

27-28. (canceled)

29. A concentrate for providing the tea beverage according to claim 1, comprising:
(a) a natural sugar in an amount corresponding to a sweetness intensity X4;
(b) a high-intensity sweetener in an amount corresponding to a sweetness intensity X5;
(c) less than 500 mg/100 ml of sodium; and
(d) 1 to 520 mg/100 ml of potassium and/or 1 to 520 mg/100 ml of calcium,
wherein (X4+X5)≤200 is satisfied.

30. (canceled)
